(19) United States
(12) Patent Application Publication
(10) Pub. No.: US 2024/0405814 A1
(43) Pub. Date: Dec. 5, 2024

(54) METHOD AND DEVICE FOR UPLINK PRECODING IN WIRELESS COMMUNICATION SYSTEM

(71) Applicant: Samsung Electronics Co., Ltd., Suwon-si, Gyeonggi-do (KR)

(72) Inventors: Youngrok JANG, Suwon-si (KR); Junyung YI, Suwon-si (KR); Ameha Tsegaye ABEBE, Suwon-si (KR); Seongmok LIM, Suwon-si (KR); Hyoungju JI, Suwon-si (KR); Kyungjun CHOI, Suwon-si (KR)

(21) Appl. No.: 18/690,113

(22) PCT Filed: Sep. 30, 2022
(86) PCT No.: PCT/KR2022/014725

§ 371 Date: Mar. 7, 2024

(30) Foreign Application Priority Data
Oct. 1, 2021 (KR) 10-2021-0130717

(51) Int. Cl. H04B 7/0456; H04W 72/0446; H04W 72/20

(52) U.S. Cl. CPC H04B 7/0456; H04W 72/0446; H04W 72/20

(57) ABSTRACT

Provided are a method for applying precoding to an uplink data channel and a device for same. Specifically, the method performed by a terminal in a wireless communication system comprises the steps of: receiving configuration information about repeated transmission of an uplink data channel; confirming a plurality of precoders for the repeated transmission of the uplink data channel; and repeatedly transmitting the uplink data channel to a base station on the basis of the configuration information and the plurality of precoders, wherein a first precoder among the plurality of precoders may be applied to a first uplink data channel, and a second precoder may be applied to an uplink data channel determined on the basis of at least one of the times of transmission of the repeated transmissions of the uplink data channel or a period associated with the application of the second precoder.

### TECHNICAL FIELD

The disclosure relates to an uplink precoding method and device in a wireless communication system.

### BACKGROUND ART

5th generation (5G) mobile communication technologies define broad frequency bands such that high transmission rates and new services are possible, and can be implemented not only in “Sub 6 GHz” bands such as 3.5 GHZ, but also in “Above 6 GHz” bands referred to as mm Wave including 28 GHz and 39 GHz. In addition, it has been considered to implement 6th generation (6G) mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra-reliable low latency communications (URLLC), and massive machine-type communications (mMTC), there has been ongoing standardization regarding beamforming and massive multi-input multi-output (MIMO) for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR UE power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures. i.e., 2-step random access channel (RACH) for NR. There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

Disclosed embodiments are intended to provide a device and method that can effectively provide services in a wireless communication system.

Specifically, the disclosure provides a method for determining precoders for repeated transmission of an uplink channel of a terminal and, based on the determined precoder, repeatedly transmitting the uplink channel, and also provides a device capable of performing the same.

Additionally, the disclosure provides a method for performing simultaneous channel estimation and a device capable of performing the same.

### Solution to Problem

According to an embodiment of the disclosure, a method performed by a terminal in a wireless communication system may include receiving configuration information for repetitive transmission of an uplink data channel from a base station; identifying a plurality of precoders for the repetitive transmission of the uplink data channel; and repeatedly transmitting the uplink data channel to the base station based on the configuration information and the plurality of precoders, wherein among the plurality of precoders, a first precoder may be applied to a first uplink data channel, and a second precoder may be applied to an uplink data channel determined based on at least one of a transmitting timing of the uplink data channel or a period associated with applying the second precoder.

According to an embodiment of the disclosure, a method performed by a base station in a wireless communication system may include transmitting configuration information for repetitive transmission of an uplink data channel to a terminal; transmitting information about a plurality of precoders for the repetitive transmission of the uplink data channel to the terminal; and repeatedly receiving the uplink data channel from the terminal based on the configuration information and the plurality of precoders, wherein among the plurality of precoders, a first precoder may be applied to a first uplink data channel, and a second precoder may be applied to an uplink data channel determined based on at least one of a transmitting timing of the uplink data channel or a period associated with applying the second precoder.

According to an embodiment of the disclosure, a terminal in a wireless communication system may include a transceiver; and a controller configured to receive configuration information for repetitive transmission of an uplink data channel from a base station, to identify a plurality of precoders for the repetitive transmission of the uplink data channel, and to repeatedly transmit the uplink data channel to the base station based on the configuration information and the plurality of precoders, wherein among the plurality of precoders, a first precoder may be applied to a first uplink data channel, and a second precoder may be applied to an uplink data channel determined based on at least one of a transmitting timing of the uplink data channel or a period associated with applying the second precoder.

According to an embodiment of the disclosure, a base station in a wireless communication system may include a transceiver; and a controller configured to transmit configuration information for repetitive transmission of an uplink data channel to a terminal, to transmit information about a plurality of precoders for the repetitive transmission of the uplink data channel to the terminal, and to repeatedly receive the uplink data channel from the terminal based on the configuration information and the plurality of precoders, wherein among the plurality of precoders, a first precoder may be applied to a first uplink data channel, and a second precoder may be applied to an uplink data channel determined based on at least one of a transmitting timing of the uplink data channel or a period associated with applying the second precoder.

The technical problems to be solved in the disclosure are not limited to the above-mentioned technical problems, and a person skilled in the art to which the disclosure pertains will clearly understand, from the following description, other technical problems not mentioned herein.

### Advantageous Effects of Invention

According to the disclosed embodiments, a device and method that can effectively provide services in a wireless communication system can be provided.

Specifically, according to an embodiment of the disclosure, it is possible to perform repeated transmission of an uplink data channel based on a plurality of precoders.

Additionally, according to an embodiment of the disclosure, it is possible to perform simultaneously channel estimation associated with the uplink channel.

The effects obtainable in the disclosure are not limited to the above effects, and other effects not mentioned are clearly understood from the description below by those skilled in the art.

### BRIEF DESCRIPTION OF DRAWINGS

FIG. 1 illustrates a basic structure of a time-frequency domain which is a radio resource area where data or control channels are transmitted in a wireless communication system.

FIG. 2 illustrates an example of a slot structure used in a wireless communication system.

FIG. 3 illustrates an example of the configuration of a bandwidth part (BWP) in a wireless communication system.

FIG. 4 illustrates an example of a control resource set where a downlink control channel is transmitted in a wireless communication system.

FIG. 5 illustrates a structure of a downlink control channel in a wireless communication system.

FIG. 6 illustrates an example of a method for configuring uplink and downlink resources in a wireless communication system.

FIG. 7 illustrates an example of a method for configuring uplink and downlink resources in an XDD system according to an embodiment of the disclosure.

FIG. 8 illustrates an example of a method for configuring uplink and downlink resources in a full duplex communication system according to an embodiment of the disclosure.

FIG. 9 is a diagram illustrating the structure of a transmitting end and the structure of a receiving end for a duplex scheme according to an embodiment of the disclosure.

FIG. 10 is a diagram illustrating an example of uplink and downlink resource configuration and self-interference in an XDD system according to an embodiment of the disclosure.

FIG. 11 illustrates a method for determining an available slot in a wireless communication system according to an embodiment of the disclosure.

FIG. 12 is a flowchart illustrating the operation of a terminal for transmission of PUSCH repetition type A in a wireless communication system according to an embodiment of the disclosure.

FIG. 13 is a flowchart illustrating the operation of a base station for transmission of PUSCH repetition type A in a wireless communication system according to an embodiment of the disclosure.

FIG. 14 illustrates an example of PUSCH repetition type B according to an embodiment of the disclosure.

FIG. 15 illustrates a method for determining a C-TDW for performing simultaneous channel estimation when transmitting a PUSCH in a wireless communication system according to an embodiment of the disclosure.

FIG. 16 illustrates an operation flowchart of a terminal according to an embodiment of the disclosure.

FIG. 17 is a block diagram illustrating the structure of a terminal according to an embodiment of the disclosure.

FIG. 18 is a block diagram illustrating the structure of a base station according to an embodiment of the disclosure.

### MODE FOR THE INVENTION

Hereinafter, embodiments of the disclosure will be described in detail with reference to the accompanying drawings.

In describing embodiments of the disclosure, descriptions of technical contents well-known in the art and not directly related to the disclosure will be omitted. This is to more clearly convey the subject matter of the disclosure without obscuring it by omitting unnecessary description.

For the same reason, some elements are exaggerated, omitted, or schematically illustrated in the accompanying drawings. In addition, the depicted size of each element does not completely reflect the actual size. In the drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided to inform those skilled in the art of the scope of the disclosure, and the disclosure is defined only by the scope of the appended claims. Throughout the description herein, the same or like reference numerals designate the same or like elements. Further, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the entire description herein.

In the following description, a base station is an entity that allocates resources to terminals, and may be at least one of a gNode B, an eNode B, a Node B, a base station (BS), a wireless access unit, a BS controller, and a node on a network. A terminal may include a UE, a mobile station (MS), a cellular phone, a smartphone, a computer, or a multimedia system capable of performing communication functions. A downlink (DL) refers to a radio link via which a base station transmits a signal to a terminal, and an uplink (UL) refers to a radio link via which a terminal transmits a signal to a base station.

Further, in the following description, LTE, LTE-A or 5G systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the 5G covers the existing LTE, LTE-A, or other similar services. In addition, based on determinations by those skilled in the art, the embodiments of the disclosure may also be applied to other communication systems through some modifications without significantly departing from the scope of the disclosure.

It will be understood that each block of the flowchart illustrations, and combinations of blocks in the flowchart illustrations, may be implemented by computer program instructions. These computer program instructions may be provided to a processor of a general purpose computer, special purpose computer, or other programmable data processing apparatus to produce a machine, such that the instructions, which are executed via the processor of the computer or other programmable data processing apparatus, generate means for implementing the functions specified in the flowchart block(s). These computer program instructions may also be stored in a computer usable or computer-readable memory that may direct a computer or other programmable data processing apparatus to function in a particular manner, such that the instructions stored in the computer usable or computer-readable memory produce an article of manufacture including instruction means that implement the function specified in the flowchart block(s). The computer program instructions may also be loaded onto a computer or other programmable data processing apparatus to cause a series of operational steps to be performed on the computer or other programmable apparatus to produce a computer implemented process such that the instructions that are executed on the computer or other programmable apparatus provide steps for implementing the functions specified in the flowchart block(s).

In addition, each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the term “unit” refers to a software element or a hardware element, such as a field programmable gate array (FPGA) or an application specific integrated circuit (ASIC), which performs a predetermined function. However, the term “unit” does not always have a meaning limited to software or hardware. A “unit” may be constructed either to be stored in an addressable storage medium or to execute one or more processors. Therefore, a “unit” includes, for example, software elements, object-oriented software elements, class elements or task elements, processes, functions, properties, procedures, subroutines, segments of a program code, drivers, firmware, micro-codes, circuits, data, database, data structures, tables, arrays, and variables. The functions provided by elements and units may be combined into those of a smaller number of elements and units or separated into those of a larger number of elements and units. In addition, the elements and units may be implemented to operate one or more central processing units (CPUs) within a device or a secure multimedia card. Also, in embodiments, a “unit” may include one or more processors.

Wireless communication systems have expanded beyond the original role of providing a voice-oriented service and have evolved into wideband wireless communication systems that provide a high-speed and high-quality packet data service according to, for example, communication standards such as high-speed packet access (HSPA), long-term evolution (LTE or evolved universal terrestrial radio access (E-UTRA)), and LTE-Advanced (LTE-A) of 3GPP, high-rate packet data (HRPD) and a ultra-mobile broadband (UMB) of 3GPP2, and 802.16e of IEEE. In addition, 5G or NR communication standards are being established for a 5G wireless communication system.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink indicates a radio link through which a user equipment (UE) or a mobile station (MS) transmits data or control signals to a base station (BS or eNode B), and the downlink indicates a radio link through which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a communication system subsequent to LTE, must freely reflect various requirements of users, service providers, and the like, services satisfying various requirements must be supported. The services considered in the 5G communication system include enhanced Mobile Broadband (eMBB) communication, massive Machine Type Communication (mMTC), Ultra-Reliability Low-Latency Communication (URLLC), and the like.

The eMBB aims at providing a data rate higher than that supported by existing LTE, LTE-A, or LTE-Pro. For example, in the 5G communication system, the eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced Multi-Input Multi-Output (MIMO) transmission technique are required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, the mMTC is being considered to support application services such as the Internet of things (IoT) in the 5G communication system. The mMTC has requirements, such as support of connection of a large number of UEs in a cell, enhancement coverage of UEs, improved battery time, a reduction in the cost of a UE, and the like, in order to effectively provide the IoT. Since the IoT provides communication functions while being provided to various sensors and various devices, it must support a large number of UEs (e.g., 1,000,000 UEs/km²) in a cell. In addition, the UEs supporting the mMTC may require wider coverage than those of other services provided by the 5G communication system because the UEs are likely to be located in a shadow area, such as a basement of a building, which is not covered by the cell due to the nature of the service. The UE supporting the mMTC must be configured to be inexpensive, and may require a very long battery life-time such as 10 to 15 years because it is difficult to frequently replace the battery of the UE.

Lastly, the URLLC, which is a cellular-based mission-critical wireless communication service, may be used for remote control for robots or machines, industrial automation, unmanned aerial vehicles, remote health care, emergency alert, and the like. Thus, the URLLC must provide communication with ultra-low latency and ultra-high reliability. For example, a service supporting the URLLC must satisfy an air interface latency of less than 0.5 ms, and also requires a packet error rate of 10⁻⁵ or less. Therefore, for the services supporting the URLLC, a 5G system must provide a transmit time interval (TTI) shorter than those of other services, and also may require a design for assigning a large number of resources in a frequency band in order to secure reliability of a communication link.

Three services in 5G, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

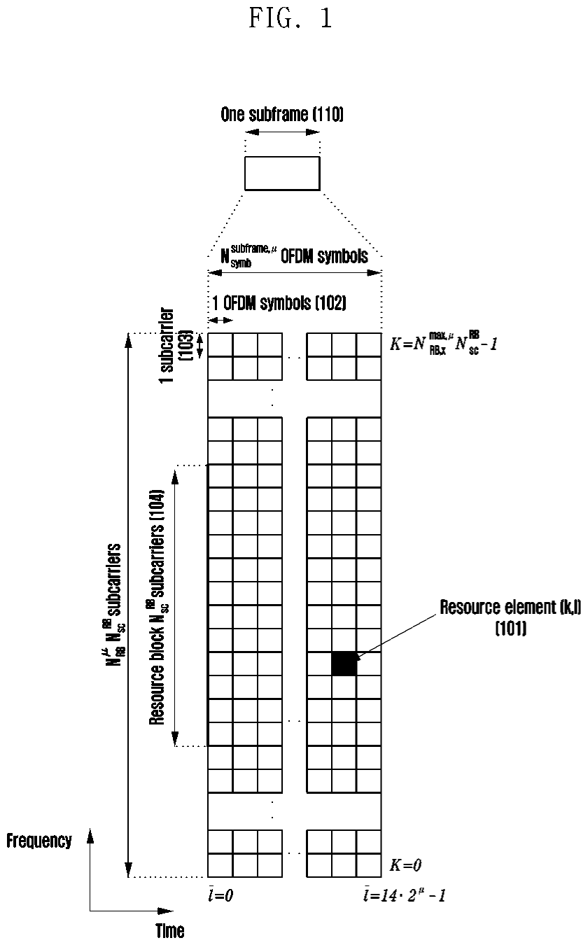

FIG. 1 illustrates a basic structure of a time-frequency domain which is a radio resource area where data or control channels are transmitted in a wireless communication system.

With reference to FIG. 1, the horizontal axis represents a time domain, and the vertical axis represents a frequency domain. A basic unit of resources in the time-frequency domain is a resource element (RE) 101, which may be defined as one orthogonal frequency division multiplexing (OFDM) symbol 102 in the time domain and one subcarrier 103 in the frequency domain. In the frequency domain, N_{SC}^{RB} (for example, 12) consecutive REs may configure one resource block (RB) 104.

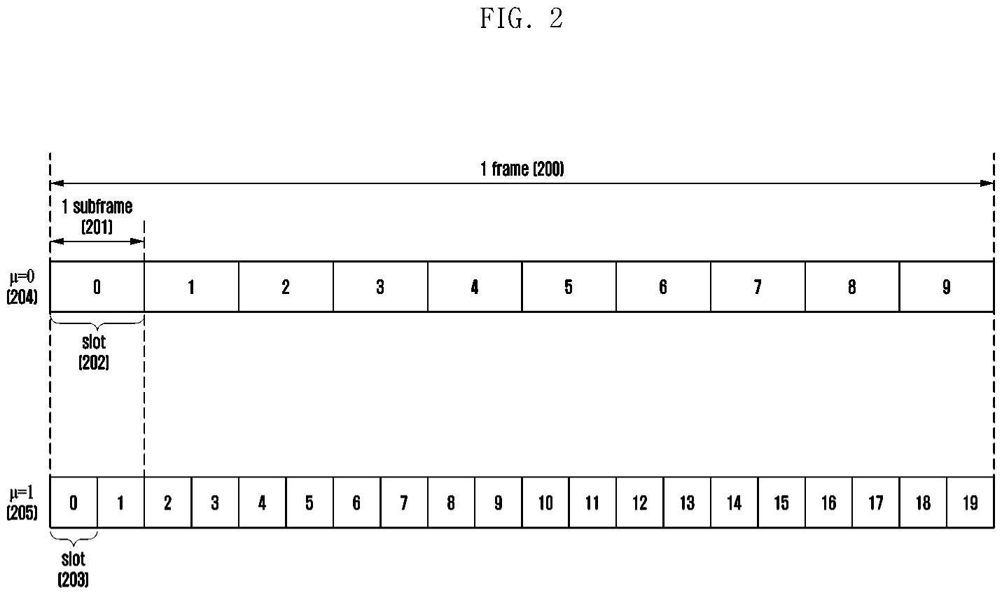

FIG. 2 illustrates an example of a slot structure used in a wireless communication system.

With reference to FIG. 2, an example of structures of a frame 200, a subframe 201, and a slot 202 is illustrated. One frame 200 may be defined as 10 ms. One subframe 201 may be defined as 1 ms, and thus the one frame 200 may be composed of ten subframes 201. One slot 202 or 203 may be defined as fourteen OFDM symbols (i.e., the number of symbols for one slot (N_{symb}^{slot}) is 14). One subframe 201 may be composed of one or multiple slots 202 and 203. The number of slots 202 and 203 per one subframe 201 may differ according to configuration value μ 204 or 205 for a subcarrier spacing. In the example of FIG. 2, subcarrier spacing configuration values μ=0 (204) and μ=1 (205) are illustrated. In the case of μ=0 (204), one subframe 201 may be composed of one slot 202. In the case of μ=1 (205), one subframe 201 may be composed of two slots 203. That is, depending on the subcarrier spacing configuration value μ, the number of slots per subframe (Nₛₗₒₜ^{subframe,μ}) may vary, and the number of slots per frame (Nₛₗₒₜ^{frame,μ}) may vary accordingly. The numbers Nₛₗₒₜ^{subframe,μ} and Nₛₗₒₜ^{frame,μ} according to each subcarrier spacing configuration μ may be defined as in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

Next, configuration of a bandwidth part (BWP) in a 5G communication system will be described in detail with reference to the drawings.

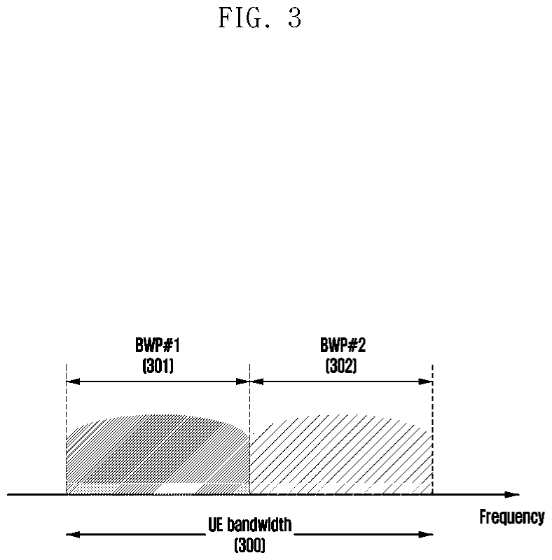

FIG. 3 illustrates an example of the configuration of BWP in a wireless communication system.

With reference to FIG. 3, in an example shown, a UE bandwidth 300 is configured as two BWPs, that is, BWP #1 301 and BWP #2 302. A base station may configure one or multiple BWPs for a UE, and may configure information as shown in Table 2 below for each BWP.

TABLE 2

| | |
|---|---|
| BWP ::= | SEQUENCE { |
| bwp-Id | BWP-Id, |

(bandwidth part identifier)

| | |
|---|---|
| locationAndBandwidth | INTEGER (1..65536), |

(bandwidth part location)

| | |
|---|---|
| subcarrierSpacing | ENUMERATED {n0, n1, n2, n3, n4, n5}, |

(subcarrier spacing)

| | |
|---|---|
| cyclicPrefix | ENUMERATED { extended } |

(cyclic prefix)
}

The configuration of BWP is not limited to the above example, and various parameters related to BWP may be configured for the UE in addition to the above configuration information. The configuration information may be transmitted by the base station to the UE via higher layer signaling, for example, radio resource control (RRC) signaling. At least one of configured one or multiple BWPs may be activated. Whether to activate the configured BWP may be dynamically transmitted via downlink control information (DCI) or semi-statically transmitted via RRC signaling from the base station to the UE.

According an embodiment, the UE before RRC connection may be configured with an initial BWP for initial access from the base station through a master information block (MIB). Specifically, the UE may receive configuration information about a search apace and a control resource set (CORESET) in which the PDCCH for reception of system information (which may correspond to remaining system information (RMSI) or system information block 1 (SIB 1)) required for initial access may be transmitted through the MIB in an initial access step. The CORESET and search space, which are configured through the MIB, may be regarded as identity (ID) 0, respectively. The base station may notify the UE of configuration information, such as frequency allocation information, time allocation information, and numerology for the CORESET #0, through the MIB. In addition, the base station may notify the UE of configuration information regarding the monitoring periodicity and occasion for the CORESET #0, that is, configuration information regarding the search space #0, through the MIB. The UE may regard the frequency domain configured with the CORESET #0, obtained from the MIB, as an initial BWP for initial access. Here, the ID of the initial BWP may be regarded as zero.

The configuration of the BWP supported in the 5G wireless communication system may be used for various purposes.

According to an embodiment, in the case where a bandwidth supported by the UE is less than a system bandwidth, the configuration for the BWP may be used. For example, the base station may configure, for the UE, a frequency location (configuration information 2) of the BWP to enable the UE to transmit or receive data at a specific frequency location within the system bandwidth.

In addition, according to an embodiment, the base station may configure multiple BWPs in the UE for the purpose of supporting different numerologies. For example, in order to support both data transmission/reception to/from a certain UE by using a subcarrier spacing of 15 kHz and a subcarrier spacing of 30 kHz, the base station may configure two BWPs with the subcarrier spacing of 15 kHz and the subcarrier spacing of 30 kHz, respectively. Different BWPs may be frequency division multiplexed, and when the base station attempts to transmit or receive data at a specific subcarrier spacing, the BWP configured with the corresponding subcarrier spacing may be activated.

In addition, according to an embodiment, the base station may configure, for the UE, the BWPs having bandwidths of different sizes for the purpose of reducing power consumption of the UE. For example, when the UE supports a very large bandwidth (e.g., a bandwidth of 100 MHz) and always transmits or receives data at that bandwidth, there may arise very high power consumption. In particular, when there is no traffic, monitoring on an unnecessary downlink control channel in a large bandwidth of 100 MHz may be very inefficient in terms of power consumption. Therefore, in order to reduce power consumption of the UE, the base station may configure, for the UE, a BWP of a relatively small bandwidth (e.g., a BWP of 20 MHz). In a situation without traffic, the UE may perform a monitoring operation on a BWP of 20 MHz, and when there is data to be transmitted or received, the UE may transmit or receive data in a BWP of 100 MHz in response to an indication of the base station.

In a method of configuring the BWP, the UEs before the RRC connection may receive configuration information about the initial BWP through the MIB in the initial access step. Specifically, the UE may be configured with a CORESET for a downlink control channel in which DCI for scheduling a SIB may be transmitted from a MIB of a physical broadcast channel (PBCH). The bandwidth of the CORESET configured through the MIB may be regarded as the initial BWP. Through the configured initial BWP, the UE may receive a physical downlink shared channel (PDSCH) in which the SIB is transmitted. The initial BWP may be used for other system information (OSI), paging, and random access as well as the reception of the SIB.

In the case where one or more BWPs are configured for the UE, the base station may indicate the UE to switch the BWP by using a BWP indicator field in DCI. For example, in FIG. 3, when the currently activated BWP of the UE is BWP #1 301, the base station may indicate BWP #2 302 to the UE by using the BWP indicator in DCI, and the UE may perform a BWP switch to the BWP #2 302 indicated by the BWP indicator in the received DCI.

As described above, since the DCI-based BWP switch may be indicated by DCI for scheduling PDSCH or PUSCH, the UE should be able to smoothly receive or transmit the PDSCH or PUSCH, which is scheduled by the DCI, without difficulty in the switched BWP when receiving a request for the BWP switch. For this purpose, the standard stipulates requirements for a delay time (TBWP) required when switching the BWP, as defined in Table 3, for example.

TABLE 3

| | |
|---|---|
| NR Slot length | BWP switch delay T_{BWP} (slots) |

| μ | (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 17 |

^{Note 1}:
Depends on UE capability.
Note 2:
If the BWP switch involves changing of SCS, the BWP switch delay is determined by the larger one between the SCS before BWP switch and the SCS after BWP switch.

The requirements for the BWP switch delay time may support type 1 or type 2 depending on UE capability. The UE may report a supportable BWP delay time type to the base station.

When the UE receives the DCI including the BWP switch indicator in slot n according to the requirements for the BWP switch delay time, the UE may complete a switch to a new BWP indicated by the BWP switch indicator at a time not later than slot n+T_{BWP}, and may perform transmission and reception for a data channel scheduled by the DCI in the switched new BWP. When the base station intends to schedule the data channel to the new BWP, the base station may determine a time domain resource allocation for the data channel by considering the BWP switch delay time (T_{BWP}) of the UE. That is, when the base station schedules the data channel to the new BWP, the base station may schedule the data channel after the BWP switch delay time in a method for determining the time domain resource allocation for the data channel. Thus, the UE may not expect that the DCI indicating the BWP switch will indicate a slot offset (K0 or K2) value less than the T_{BWP}.

If the UE receives the DCI (e.g., DCI format 1_1 or 0_1) indicating the BWP switch, the UE may not perform any transmission or reception during a time interval from the third symbol of the slot in which the PDCCH including the DCI is received to the start point of the slot indicated by the slot offset (K0 or K2) value indicated by the time domain resource allocation indicator field in the DCI. For example, if the UE has received the DCI indicating the BWP switch in slot n and the slot offset value indicated by the DCI is K, the UE may not perform any transmission or reception from the third symbol of the slot n to the symbol prior to slot n+K (i.e., the last symbol of slot n+K−1).

Hereinafter, a synchronization signal (SS)/PBCH block in the 5G wireless communication system will be described.

The SS/PBCH block may refer to a physical layer channel block composed of a primary SS (PSS), a secondary SS (SSS), and a PBCH. Details are as follows.
PSS: This is a signal serving as a reference for downlink time/frequency synchronization and provides some information of a cell ID.
SSS: This is a signal serving as a reference for downlink time/frequency synchronization and provides the remaining cell ID information that is not provided by the PSS. In addition, this may serve as a reference signal for demodulation of the PBCH.
PBCH: This provides essential system information required for transmission or reception of a data channel and a control channel of the UE. The essential system information may include search space related control information indicating radio resource mapping information of a control channel, scheduling control information for a separate data channel for transmission of system information, and the like.
SS/PBCH block: This consist of a combination of the PSS, the SSS, and the PBCH. One or multiple SS/PBCH blocks may be transmitted within 5 ms, and each of the transmitted SS/PBCH blocks may be distinguished by indices.

The UE may detect the PSS and the SSS in the initial access step and may decode the PBCH. The UE may acquire the MIB from the PBCH and may be configured with CORESET #0 (which may correspond to the CORESET having the CORESET index of 0) therefrom. The UE may monitor the CORESET #0 on the assumption that a demodulation reference signal (DMRS) transmitted in the CORESET #0 and the selected SS/PBCH block is quasi-co-located (QCLed). The UE may receive system information with downlink control information transmitted in the CORESET #0. The UE may acquire, from the received system information, configuration information related to a random access channel (RACH) required for initial access. The UE may transmit a physical RACH (PRACH) to the base station by considering the selected SS/PBCH index, and the base station having received the PRACH may acquire information about the SS/PBCH block index selected by the UE. The base station may know which block is selected among the SS/PBCH blocks by the UE, and may know that the CORESET #0 associated therewith is monitored.

Next, downlink control information (DCI) in the 5G wireless communication system will be described in detail.

In the 5G system, scheduling information about uplink data (or physical uplink shared channel (PUSCH)) or downlink data (or physical downlink shared channel (PDSCH)) may be transmitted from the base station to the UE through the DCI. The UE may monitor a fallback DCI format and a non-fallback DCI format with regard to the PUSCH or the PDSCH. The fallback DCI format may include a fixed field predefined between the base station and the UE, and the non-fallback DCI format may include a configurable field.

The DCI may be transmitted through a physical downlink control channel (PDCCH) after a channel coding and modulation process. A cyclic redundancy check (CRC) may be attached to a DCI message payload, and the CRC may be scrambled by a radio network temporary identifier (RNTI) corresponding to the identity of the UE. Different RNTIs may be used according to the purpose of the DCI message, for example, a UE-specific data transmission, a power adjustment command, or a random access response. That is, the RNTI is not explicitly transmitted, but is included in a CRC calculation process and then transmitted. Upon receiving the DCI message transmitted through the PDCCH, the UE may check the CRC by using an assigned RNTI. If a CRC check result is correct, the UE can know that the corresponding message has been transmitted to the UE.

For example, the DCI for scheduling the PDSCH for system information (SI) may be scrambled by an SI-RNTI. The DCI for scheduling the PDSCH for a random access response (RAR) message may be scrambled by an RA-RNTI. The DCI for scheduling the PDSCH for a paging message may be scrambled by a P-RNTI. The DCI for notifying a slot format indicator (SFI) may be scrambled by an SFI-RNTI. The DCI for notifying a transmit power control (TPC) may be scrambled by a TPC-RNTI. The DCI for scheduling the UE-specific PDSCH or PUSCH may be scrambled by a cell RNTI (C-RNTI), a modulation coding scheme C-RNTI (MCS-C-RNTI), or a configured scheduling RNTI (CS-RNTI).

The DCI format 0_0 may be used as a fallback DCI for scheduling the PUSCH. In this case, the CRC may be scrambled by the C-RNTI. The DCI format 0_0 in which the CRC is scrambled by the C-RNTI may include, for example, information in Table 4.

```
TABLE 4
Identifier for DCI formats (DCI format identifier) - 1 bit
The value of this bit field is always set to 0, indicating an UL DCI format
Frequency domain resource assignment - ┌log₂(N_{RB}^{UL,BWP}(N_{RB}^{UL,BWP}+1)/2)┐ bits where
N_{RB}^{UL,BWP} is defined in subclause 7.3.1.0
For PUSCH hopping with resource allocation type 1:
- N_{UL}_{_{—}}ₕₒₚ MSB bits are used to indicate the frequency offset according to Subcla
use 6.3 of [6, TS 38.214], where N_{UL}_{_{—}}ₕₒₚ = 1 if the higher layer parameter frequencyHo
ppingOffsetLists contains two offset values and N_{UL}_{_{—}}ₕₒₚ = 2 if the higher layer paramet
er frequencyHoppingOffsetLists contains four offset values
-  ┌log₂(N_{RB}^{UL,BWP}(N_{RB}^{UL,BWP}+1)/2)┐ - N_{UL}_{_{—}}ₕₒₚ bits provides the frequency domain resource
  allocation according to Subclause 6.1.2.2.2 of [6, TS 38.214]
For non-PUSCH hopping with resource allocation type 1:
-  ┌log₂(N_{RB}^{UL,BWP}(N_{RB}^{UL,BWP}+1)/2)┐ bits provides the frequency domain resource allocat
ion according to Subclause 6.1.2.2.2 of [6, TS 38.214]
Time domain resource assignment- 4 bits as defined in Subclause 6.1.2.1 of [6, TS
38.214]
Frequency hopping flag - 1 bit according to Table 7.3.1.1.1-3, as defined in Subclau
se 6.3 of [6, TS 38.214]
Modulation and coding scheme - 5 bits as defined in Subclause 6.1.4.1 of [6, TS 38.
214]
New data indicator - 1 bit
Redundancy version - 2 bits as defined in Table 7.3.1.1.1-2
HARQ process number - 4 bits
TPC command for scheduled PUSCH - 2 bits as defined in Subclause 7.1.1 of [5, T
S 38.213]
Padding bits, if required.
UL/SUL indicator (uplink/ Supplementary Uplink indicator) - 1 bit for UEs configu
red with supplementaryUplink in ServingCellConfig in the cell as defined in Table
7.3.1.1.1-1 and the number of bits for DCI format 1_0 before padding is larger than
the number of bits for DCI format 0_0 before padding; 0 bit otherwise. The UL/SU
L indicator, if present, locates in the last bit position of DCI format 0_0, after the pa
dding bit(s).
If the UL/SUL indicator is present in DCI format 0_0 and the higher layer parameter
  pusch-Config is not configured on both UL and SUL the UE ignores the UL/SUL in
dicator field in DCI format 0_0, and the corresponding PUSCH scheduled by the D
CI format 0_0 is for the UL or SUL for which high layer parameter pucch-Config is
configured;
If the UL/SUL indicator is not present in DCI format 0_0 and pucch-Config is confi
gured, the corresponding PUSCH scheduled by the DCI format 0_0 is for the UL or
SUL for which high layer parameter pucch-Config is configured.
- If the UL/SUL indicator is not present in DCI format 0_0 and pucch-Config i
s not configured, the corresponding PUSCH scheduled by the DCI format 0_0 is for
the uplink on which the latest PRACH is transmitted.
```

The DCI format 0_1 may be used as a non-fallback DCI for scheduling the PUSCH. In this case, the CRC may be scrambled by the C-RNTI. The DCI format 0_1 in which the CRC is scrambled by the C-RNTI may include, for example, information in Table 5.

```
TABLE 5
Identifier for DCI formats (DCI format identifier) - 1 bit
The value of this bit field is always set to 0, indicating an UL DCI format
Carrier indicator - 0 or 3 bits, as defined in Subclause 10.1 of [5, TS38.213].
UL/SUL indicator (uplink/Supplementary uplink indicator) - 0 bit for UEs not
configured with supplementaryUplink in ServingCellConfig in the cell or UEs
configured with supplementaryUplink in ServingCellConfig in the cell but only
PUCCH carrier in the cell is configured for PUSCH transmission; otherwise,
1 bit as defined in Table 7.3.1.1.1-1.
Bandwidth part indicator - 0, 1 or 2 bits as determined by the number of UL BWPs
n_{BWP,RRC} configured by higher layers, excluding the initial UL bandwidth part. The bit
width for this field is determined as ┌log₂ (n_{BWP})┐ bits, where
    n_{BWP} = n_{BWP,RRC} + 1 if n_{BWP,RRC} ≤3, in which case the bandwidth part indicator is
equivalent to the ascending order of the higher layer parameter BWP-Id;
otherwise n_{BWP} = n_{BWP,RRC}, in which case the bandwidth part indicator is defined in
Table 7.3.1.1.2-1;
If a UE does not support active BWP change via DCI, the UE ignores this bit field.
Frequency domain resource assignment - number of bits determined by the
following, where N_{RB}^{UL,BWP} is the size of the active UL bandwidth part:
    N_{RBG} bits if only resource allocation type 0 is configured, where N_{RBG} is
defined in Subclause 6.1.2.2.1 of [6, TS 38.214],
    ┌log₂ (N_{RB}^{UL,BWP} (N_{RB}^{UL,BWP} + 1)/2)┐ bits if only resource allocation type 1 is
configured, or max (┌log₂(N_{RB}^{UL,BWP}(N_{RB}^{UL,BWP} + 1)/2)┐, N_{RBG}) + 1 bits if both resource
allocation type 0 and 1 are configured.
If both resource allocation type 0 and 1 are configured, the MSB bit is used to
indicate resource allocation type 0 or resource allocation type 1, where the bit value
of 0 indicates resource allocation type 0 and the bit value of 1 indicates resource allocation
type 1.
For resource allocation type 0, the N_{RBG} LSBs provide the resource allocation as
defined in Subclause 6.1.2.2.1 of [6, TS 38.214].
For resource allocation type 1, the ┌log₂(N_{RB}^{UL,BWP}(N_{RB}^{UL,BWP} + 1)/2)┐ LSBs provide the
resource allocation as follows:
For PUSCH hopping with resource allocation type 1:
    N_{UL}_hop MSB bits are used to indicate the frequency offset according to
Subclause 6.3 of [6, TS 38.214], where N_{UL}_hop = 1 if the higher layer parameter frequency-
HoppingOffsetLists contains two offset values and N_{UL}_hop = 2 if the higher layer
parameter frequencyHoppingOffsetLists contains four offset values
    ┌log₂(N_{RB}^{UL,BWP} (N_{RB}^{UL,BWP} + 1)/2)┐ - N_{UL}_hop bits provides the frequency domain
resource allocation according to Subclause 6.1.2.2.2 of [6, TS 38.214]
For non-PUSCH hopping with resource allocation type 1:
    ┌log₂(N_{RB}^{UL,BWP} (N_{RB}^{UL,BWP} + 1)/2)┐ bits provides the frequency domain resource
allocation according to Subclause 6.1.2.2.2 of [6, TS 38.214]
If “Bandwidth part indicator” field indicates a bandwidth part other than the active
bandwidth part and if both resource allocation type 0 and 1 are configured for the
indicated bandwidth part, the UE assumes resource allocation type 0 for the indicated
bandwidth part if the bitwidth of the “Frequency domain resource assignment” field of
the active bandwidth part is smaller than the bitwidth of the “Frequency domain
resource assignment” field of the indicated bandwidth part.
Time domain resource assignment - 0, 1, 2, 3, or 4 bits as defined in Subclause 6.1.
2.1 of [6, TS38.214]. The bitwidth for this field is determined as ┌log₂ (I)┐ bits, where
I is the number of entries in the higher layer parameter pusch-TimeDomainAllocation-
List if the higher layer parameter is configured; otherwise I is the number of entries
in the default table.
Frequency hopping flag - 0 or 1 bit:
0 bit if only resource allocation type 0 is configured or if the higher layer parameter
frequencyHopping is not configured;
1 bit according to Table 7.3.1.1.1-3 otherwise, only applicable to resource allocation
type 1, as defined in Subclause 6.3 of [6, TS 38.214].
Modulation and coding scheme - 5 bits as defined in Subclause 6.1.4.1 of [6, TS 38.
214]
New data indicator - 1 bit
Redundancy version - 2 bits as defined in Table 7.3.1.1.1-2
HARQ process number - 4 bits
1^{st} downlink assignment index - 1 or 2 bits:
1 bit for semi-static HARQ-ACK codebook;
2 bits for dynamic HARQ-ACK codebook.
2^{nd} downlink assignment index - 0 or 2 bits:
2 bits for dynamic HARQ-ACK codebook with two HARQ-ACK sub-codebooks;
0 bit otherwise.
TPC command for scheduled PUSCH - 2 bits as defined in Subclause 7.1.1 of [5,
TS38.213]
SRS resource indicator (Sounding Reference Signal; SRS resource indicator) -
$⌈ {log}_{2} ( {\sum }_{k = 1}^{min \{ {L}_{max} , {N}_{SRS} \}} ( \begin{matrix}{N}_{SRS} \\ k\end{matrix} ) ) ⌉ or ⌈ {log}_{2} ( {N}_{SRS} ) ⌉ bits , where {N}_{SRS} is the number of configured$
SRS resources in the SRS resource set associated with the higher layer parameter usage
of value ‘codeBook’ or ‘nonCodeBook’,
    $⌈ {log}_{2} ( {\sum }_{k = 1}^{min \{ {L}_{max} , {N}_{SRS} \}} ( \begin{matrix}{N}_{SRS} \\ k\end{matrix} ) ) ⌉ bits according to Tables 7.3 \text{.1} \text{.1} \text{.2} ‐ 28 / 29 / 30 / 31 if the$
higher layer parameter txConfig = nonCodebook, where N_{SRS} is the number of
configured SRS resources in the SRS resource set associated with the higher layer
parameter usage of value ‘nonCodeBook’ and
if UE supports operation with maxMIMO-Layers and the higher layer parameter max
MIMO-Layers of PUSCH-ServingCellConfig of the serving cell is configured, Lₘₐₓ
is given by that parameter
otherwise, Lₘₐₓ is given by the maximum number of layers for PUSCH supported by
the UE for the serving cell for non-codebook based operation.
    ┌log₂ (N_{SRS})┐ bits according to Tables 7.3.1.1.2-32 if the higher layer parameter
txConfig = codebook, where N_{SRS} is the number of configured SRS resources in the
SRS resource set associated with the higher layer parameter usage of value ‘codeBook’.
Precoding information and number of layers - number of bits determined by the
following:
0 bits if the higher layer parameter txConfig = nonCodeBook;
0 bits for 1 antenna port and if the higher layer parameter txConfig = codebook;
4, 5, or 6 bits according to Table 7.3.1.1.2-2 for 4 antenna ports, if txConfig =
codebook, and according to whether transform precoder is enabled or disabled, and
the values of higher layer parameters maxRank, and codebookSubset;
2, 4, or 5 bits according to Table 7.3.1.1.2-3 for 4 antenna ports, if txConfig =
codebook, and according to whether transform precoder is enabled or disabled, and
the values of higher layer parameters maxRank, and codebookSubset;
2 or 4 bits according to Table7.3.1.1.2-4 for 2 antenna ports, if txConfig = codebook,
and according to whether transform precoder is enabled or disabled, and the values
of higher layer parameters maxRank and codebookSubset;
1 or 3 bits according to Table7.3.1.1.2-5 for 2 antenna ports, if txConfig = codebook,
and according to whether transform precoder is enabled or disabled, and the values
of higher layer parameters maxRank and codebookSubset.
Antenna ports - number of bits determined by the following
2 bits as defined by Tables 7.3.1.1.2-6, if transform precoder is enabled, dmrs-Type=
1, and maxLength=1;
4 bits as defined by Tables 7.3.1.1.2-7, if transform precoder is enabled, dmrs-Type=
1, and maxLength=2;
3 bits as defined by Tables 7.3.1.1.2-8/9/10/11, if transform precoder is disabled,
dmrs-Type=1, and maxLength=1, and the value of rank is determined according to the
SRS resource indicator field if the higher layer parameter txConfig = nonCodebook
and according to the Precoding information and number of layers field if the higher
layer parameter txConfig = codebook;
4 bits as defined by Tables 7.3.1.1.2-12/13/14/15, if transform precoder is disabled,
dmrs-Type=1, and maxLength=2, and the value of rank is determined according to the
SRS resource indicator field if the higher layer parameter txConfig = nonCodebook
and according to the Precoding information and number of layers field if the higher
layer parameter txConfig = codebook;
4 bits as defined by Tables 7.3.1.1.2-16/17/18/19, if transform precoder is disabled,
dmrs-Type=2, and maxLength=1, and the value of rank is determined according to the
SRS resource indicator field if the higher layer parameter txConfig = nonCodebook
and according to the Precoding information and number of layers field if the higher
layer parameter txConfig = codebook;
5 bits as defined by Tables 7.3.1.1.2-20/21/22/23, if transform precoder is disabled,
dmrs-Type=2, and maxLength=2, and the value of rank is determined according to the
SRS resource indicator field if the higher layer parameter txConfig = nonCodebook
and according to the Precoding information and number of layers field if the higher
layer parameter txConfig = codebook.
where the number of CDM groups without data of values 1, 2, and 3 in Tables 7.3.1.
1.2-6 to 7.3.1.1.2-23 refers to CDM groups {0}, {0, 1}, and {0, 1, 2} respectively.
If a UE is configured with both dmrs-UplinkForPUSCH-MappingTypeA and dmrs-
UplinkForPUSCH-MappingTypeB, the bitwidth of this field equals max {x_{A}, x_{B}}, where
x_{A} is the “Antenna ports” bitwidth derived according to dmrs-UplinkForPUSCH-
MappingTypeA and x_{B} is the “Antenna ports” bitwidth derived according to dmrs-
UplinkForPUSCH-MappingTypeB. A number of |x_{A} − x_{B}| zeros are padded in the MSB of
this field, if the mapping type of the PUSCH corresponds to the smaller value of x_{A}
and x_{B}.
SRS request - 2 bits as defined by Table 7.3.1.1.2-24 for UEs not configured with
supplementaryUplink in ServingCellConfig in the cell; 3 bits for UEs configured with
supplementaryUplink in ServingCellConfig in the cell where the first bit is the non-
SUL/SUL indicator as defined in Table 7.3.1.1.1-1 and the second and third bits are
defined by Table 7.3.1.1.2-24. This bit field may also indicate the associated CSI-RS
according to Subclause 6.1.1.2 of [6, TS 38.214].
CSI request (Channel State Information; CSI request) - 0, 1, 2, 3, 4, 5, or 6 bits
determined by higher layer parameter reportTriggerSize.
CBG transmission information (CBGTI)
(Code Block Group; CBG transmission information) - 0 bit if higher layer
parameter codeBlockGroupTransmission for PDSCH is not configured, otherwise,
2, 4, 6, or 8 bits determined by higher layer parameter maxCodeBlockGroupsPerTransport-
Block for PUSCH.
PTRS-DMRS association (Phase Tracking Reference Signal-
Demodulation Reference Signal association) - number of bits determined as follows
0 bit if PTRS-UplinkConfig is not configured and transform precoder is disabled, or
if transform precoder is enabled, or if maxRank=1;
2 bits otherwise, where Table 7.3.1.1.2-25 and 7.3.1.1.2-26 are used to indicate the
association between PTRS port(s) and DMRS port(s) for transmission of one PT-RS
port and two PT-RS ports respectively, and the DMRS ports are indicated by the
Antenna ports field.
If “Bandwidth part indicator” field indicates a bandwidth part other than the active
bandwidth part and the “PTRS-DMRS association” field is present for the indicated
bandwidth part but not present for the active bandwidth part, the UE assumes the
“PTRS-DMRS association” field is not present for the indicated bandwidth part.
beta_offset indicator - 0 if the higher layer parameter betaOffsets = semiStatic;
otherwise 2 bits as defined by Table 9.3-3 in [5, TS 38.213].
DMRS sequence initialization - 0 bit if transform precoder is enabled; 1 bit if
transform precoder is disabled.
    UL-SCH indicator - 1 bit. A value of “1” indicates UL-SCH shall be transmitted
on the PUSCH and a value of “0” indicates UL-SCH shall not be transmitted on
the PUSCH. Except for DCI format 0_1 with CRC scrambled by SP-CSI-RNTI, a UE
is not expected to receive a DCI format 0_1 with UL-SCH indicator of “0” and
CSI request of all zero(s).
```

The DCI format 1_0 may be used as a fallback DCI for scheduling the PDSCH. In this case, the CRC may be scrambled by the C-RNTI. The DCI format 1_0 in which the CRC is scrambled by the C-RNTI may include, for example, information in Table 6.

```
TABLE 6
Identifier for DCI formats (DCI format identifier) - 1 bits
The value of this bit field is always set to 1, indicating a DL DCI format
Frequency domain resource assignment - ┌log₂(N_{RB}^{DL,BWP}(N_{RB}^{DL,BWP}+1)/2)┐ bits where
N_{RB}^{DL,BWP} is given by subclause 7.3.1.0
If the CRC of the DCI format 1_0 is scrambled by C-RNTI and the “Frequency dom
ain resource assignment” field are of all ones, the DCI format 1_0 is for random acc
ess procedure initiated by a PDCCH order, with all remaining fields set as follows:
Random Access Preamble index - 6 bits according to ra-PreambleIndex in Subclaus
e 5.1.2 of [8, TS38.321]
UL/SUL indicator (uplink/ Supplementary UL indicator) - 1 bit. If the value of the “
Random Access Preamble index” is not all zeros and if the UE is configured with su
pplementaryUplink in ServingCellConfig in the cell, this field indicates which UL ca
rrier in the cell to transmit the PRACH according to Table 7.3.1.1.1-1; otherwise, thi
s field is reserved
SS/PBCH index (
Synchronization Signal; SS/ Physical Broadcast Channel; PBCH index)- 6 bits. If th
e value of the “Random Access Preamble index” is not all zeros, this field indicates t
he SS/PBCH that shall be used to determine the RACH occasion for the PRACH tra
nsmission; otherwise, this field is reserved.
PRACH Mask index (Physical Random Access Channel; PRACH mask index)- 4 bi
ts. If the value of the “Random Access Preamble index” is not all zeros, this field ind
icates the RACH occasion associated with the SS/PBCH indicated by “SS/PBCH ind
ex” for the PRACH transmission, according to Subclause 5.1.1 of [8, TS38.321]; oth
erwise, this field is reserved
Reserved bits - 10 bits
Otherwise, all remaining fields are set as follows:
Time domain resource assignment - 4 bits as defined in Subclause 5.1.2.1 of [6, TS
38.214]
VRB-to-PRB mapping (virtual resource block-to- physical resource block mapping)
- 1 bit according to Table 7.3.1.2.2-5
Modulation and coding scheme - 5 bits as defined in Subclause 5.1.3 of [6, TS 38.21
4]
New data indicator - 1 bit
Redundancy version - 2 bits as defined in Table 7.3.1.1.1-2
HARQ process number - 4 bits
Downlink assignment index - 2 bits as defined in Subclause 9.1.3 of [5, TS 38.213],
  as counter DAI
TPC command for scheduled PUCCH - 2 bits as defined in Subclause 7.2.1 of [5, T
S 38.213]
PUCCH resource indicator - 3 bits as defined in Subclause 9.2.3 of [5, TS 38.213]
- PDSCH-to-HARQ_feedback timing indicator - 3 bits as defined in Subclause
  9.2.3 of [5, TS38.213]
```

The DCI format 1_1 may be used as a non-fallback DC for scheduling the PDSCH. In this case, the CRC may be scrambled by the C-RNTI. The DCI format 1_1 in which the CRC is scrambled by the C-RNTI may include, for example, information in Table 7.

```
TABLE 7
Identifier for DCI formats (DCI format identifier) - 1 bits
The value of this bit field is always set to 1, indicating a DL DCI format
Carrier indicator - 0 or 3 bits as defined in Subclause 10.1 of [5, TS 38.213].
Bandwidth part indicator - 0, 1 or 2 bits as determined by the number of DL BWPs
n_{BWP,RRC} configured by higher layers, excluding the initial DL bandwidth part. The bit
width for this field is determined as ┌log₂(n_{BWP})┐ bits, where
- n_{BWP} = n_{BWP,RRC} +1 if n_{BWP,RRC} ≤3, in which case the bandwidth part indicator is equ
ivalent to the ascending order of the higher layer parameter BWP-Id;
otherwise n_{BWP} = n_{BWP,RRC}, in which case the bandwidth part indicator is defined in Table
  7.3.1.1.2-1;
If a UE does not support active BWP change via DCI, the UE ignores this bit field.
Frequency domain resource assignment - number of bits determined by the followin
g, where N_{RB}^{DL,BWP} is the size of the active DL bandwidth part:
- N_{RBG} bits if only resource allocation type 0 is configured, where N_{RBG} is defin
ed in Subclause 5.1.2.2.1 of [6, TS38.214],
-  ┌log₂(N_{RB}^{DL,BWP}(N_{RB}^{DL,BWP}+1)/2)┐ bits if only resource allocation type 1 is configured,
  or
- max (┌log ₂(N_{RB}^{DL, BWP} (N_{RB}^{DL, BWP} + 1) / 2)┐ , N_{RBG} )_{+ 1} bits if both resource allocation type
0 and 1 are configured.
If both resource allocation type 0 and 1 are configured, the MSB bit is used to indica
te resource allocation type 0 or resource allocation type 1, where the bit value of 0 in
dicates resource allocation type 0 and the bit value of 1 indicates resource allocation
type 1.
For resource allocation type 0, the N_{RBG} LSBs provide the resource allocation as defi
ned in Subclause 5.1.2.2.1 of [6, TS 38.214].
For resource allocation type 1, the ┌log₂(N_{RB}^{DL,BWP}(N_{RB}^{DL,BWP}+1)/2)┐ LSBs provide the resou
rce allocation as defined in Subclause 5.1.2.2.2 of [6, TS 38.214]
If “Bandwidth part indicator” field indicates a bandwidth part other than the active b
andwidth part and if both resource allocation type 0 and 1 are configured for the indi
cated bandwidth part, the UE assumes resource allocation type 0 for the indicated ba
ndwidth part if the bitwidth of the “Frequency domain resource assignment” field of
the active bandwidth part is smaller than the bitwidth of the “Frequency domain reso
urce assignment” field of the indicated bandwidth part.
Time domain resource assignment - 0, 1, 2, 3, or 4 bits as defined in Subclause 5.1.
2.1 of [6, TS 38.214]. The bitwidth for this field is determined as ┌log₂(I)┐ bits, where
I is the number of entries in the higher layer parameter pdsch-TimeDomainAllocatio
nList if the higher layer parameter is configured; otherwise I is the number of entries
  in the default table.
VRB-to-PRB mapping (virtual resource block-to-physical resource block mapping)
- 0 or 1 bit:
0 bit if only resource allocation type 0 is configured or if interleaved VRB-to-PRB m
apping is not configured by high layers;
1 bit according to Table 7.3.1.2.2-5 otherwise, only applicable to resource allocation
type 1, as defined in Subclause 7.3.1.6 of [4, TS 38.211].
PRB bundling size indicator - 0 bit if the higher layer parameter prb-BundlingType i
s not configured or is set to ‘static’, or 1 bit if the higher layer parameter prb-Bundlin
gType is set to ‘dynamic’ according to Subclause 5.1.2.3 of [6, TS 38.214].
Rate matching indicator - 0, 1, or 2 bits according to higher layer parameters rateMa
tchPatternGroup1 and rateMatchPatternGroup2, where the MSB is used to indicate
  rateMatchPatternGroup1 and the LSB is used to indicate rateMatchPatternGroup2
when there are two groups.
ZP CSI-RS trigger (zero power CSI-RS trigger) - 0, 1, or 2 bits as defined in Subcla
use 5.1.4.2 of [6, TS 38.214]. The bitwidth for this field is determined as ┌log₂(n_{ZP} + 1)┐
bits, where n_{ZP} is the number of aperiodic ZP CSI-RS resource sets configured by hi
gher layer.
For transport block 1:
Modulation and coding scheme - 5 bits as defined in Subclause 5.1.3.1 of [6, TS 38.
214]
New data indicator - 1 bit
Redundancy version - 2 bits as defined in Table 7.3.1.1.1-2
For transport block 2 (only present if maxNrofCodeWordsScheduledByDCI equals 2)
:
Modulation and coding scheme - 5 bits as defined in Subclause 5.1.3.1 of [6, TS 38.
214]
New data indicator - 1 bit
Redundancy version - 2 bits as defined in Table 7.3.1.1.1-2
If “Bandwidth part indicator” field indicates a bandwidth part other than the active b
andwidth part and the value of maxNrofCodeWordsScheduledByDCI for the indicate
d bandwidth part equals 2 and the value of maxNrofCodeWordsScheduledByDCI for
the active bandwidth part equals 1, the UE assumes zeros are padded when interpreti
ng the “Modulation and coding scheme”, “New data indicator”, and “Redundancy ve
rsion” fields of transport block 2 according to Subclause 12 of [5, TS38.213], and th
e UE ignores the “Modulation and coding scheme”, “New data indicator”, and “Redu
ndancy version” fields of transport block 2 for the indicated bandwidth part.
HARQ process number - 4 bits
Downlink assignment index- number of bits as defined in the following
4 bits if more than one serving cell are configured in the DL and the higher layer par
ameter pdsch-HARQ-ACK-Codebook=dynamic, where the 2 MSB bits are the count
er DAI and the 2 LSB bits are the total DAI;
2 bits if only one serving cell is configured in the DL and the higher layer parameter
pdsch-HARQ-ACK-Codebook=dynamic, where the 2 bits are the counter DAI;
0 bits otherwise.
TPC command for scheduled PUCCH - 2 bits as defined in Subclause 7.2.1 of [5, T
S 38.213]
PUCCH resource indicator - 3 bits as defined in Subclause 9.2.3 of [5, TS 38.213]
PDSCH-to-HARQ_feedback timing indicator - 0, 1, 2, or 3 bits as defined in Subcla
use 9.2.3 of [5, TS 38.213]. The bitwidth for this field is determined as ┌log₂(I)┐ bits, w
here I is the number of entries in the higher layer parameter dl-DataToUL-ACK.
Antenna port(s)- 4, 5, or 6 bits as defined by Tables 7.3.1.2.2-1/2/3/4, where the num
ber of CDM groups without data of values 1, 2, and 3 refers to CDM groups {0}, {0,
1}, and {0, 1,2} respectively. The antenna ports {p_{0,...,}pᵥ₋₁} shall be determined accord
ing to the ordering of DMRS port(s) given by Tables 7.3.1.2.2-1/2/3/4.
If a UE is configured with both dmrs-DownlinkForPDSCH-MappingTypeA and dmr
s-DownlinkForPDSCH-MappingTypeB, the bitwidth of this field equals max{x_{A},x_{B}},
where x_{A} is the “Antenna ports” bitwidth derived according to dmrs-DownlinkForPD
SCH-MappingTypeA and x_{B} is the “Antenna ports” bitwidth derived according to dm
rs-DownlinkForPDSCH-MappingTypeB. A number of |x_{A}−x_{B}| zeros are padded in th
e MSB of this field, if the mapping type of the PDSCH corresponds to the smaller va
lue of x_{A} and x_{B}.
Transmission configuration indication - 0 bit if higher layer parameter tci-PresentIn
DCI is not enabled; otherwise 3 bits as defined in Subclause 5.1.5 of [6, TS38.214].
If “Bandwidth part indicator” field indicates a bandwidth part other than the active b
andwidth part,
if the higher layer parameter tci-PresentInDCI is not enabled for the CORESET used
  for the PDCCH carrying the DCI format 1_1,
the UE assumes tci-PresentInDCI is not enabled for all CORESETs in the indicated
bandwidth part;
otherwise,
the UE assumes tci-PresentInDCI is enabled for all CORESETs in the indicated ban
dwidth part.
SRS request- 2 bits as defined by Table 7.3.1.1.2-24 for UEs not configured with su
pplementaryUplink in ServingCellConfig in the cell; 3 bits for UEs configured with s
upplementaryUplink in ServingCellConfig in the cell where the first bit is the non-S
UL/SUL indicator as defined in Table 7.3.1.1.1-1 and the second and third bits are d
efined by Table 7.3.1.1.2-24. This bit field may also indicate the associated CSI-RS
according to Subclause 6.1.1.2 of [6, TS 38.214].
CBG transmission information (CBGTI) (code block group transmission information
) - 0 bit if higher layer parameter codeBlockGroupTransmission for PDSCH is not c
onfigured, otherwise, 2, 4, 6, or 8 bits as defined in Subclause 5.1.7 of [6, TS38.214
], determined by the higher layer parameters maxCodeBlockGroupsPerTransportBlo
ck and maxNrofCodeWordsScheduledByDCI for the PDSCH.
CBG flushing out information (CBGFI) - 1 bit if higher layer parameter codeBlockG
roupFlushIndicator is configured as “TRUE”, 0 bit otherwise.
- DMRS sequence initialization - 1 bit.
```

Hereinafter, a time domain resource allocation method for data channels in the 5G wireless communication system will be described.

The base station may configure, for the UE, a table about time domain resource allocation information for a downlink data channel (PDSCH: physical downlink shared channel) and an uplink data channel (PUSCH: physical uplink shared channel) through higher layer signaling (e.g., RRC signaling). For the PDSCH, a table consisting of up to maxNrofDL-Allocations=16 entries can be configured, and for the PUSCH, a table consisting of up to maxNrofUL-Allocations=16 entries can be configured. The time domain resource allocation information may include, for example, PDCCH-to-PDSCH slot timing (which corresponds to the time interval in slot units between the time when the PDCCH is received and the time when the PDSCH scheduled by the received PDCCH is transmitted, and is denoted as K0), PDCCH-to-PUSCH slot timing (which corresponds to the time interval in slot units between the time when the PDCCH is received and the time when the PUSCH scheduled by the received PDCCH is transmitted, and is denoted as K2), information about the location and length of a start symbol where the PDSCH or PUSCH is scheduled within a slot, mapping type of the PDSCH or PUSCH, and the like. For example, information such as Table 8 and Table 9 below may be notified from the base station to the UE.

TABLE 8
PDSCH-TimeDomainResourceAllocationList information element

| | |
|---|---|
| PDSCH-TimeDomainResourceAllocationList ::= | SEQUENCE |

(SIZE(1..maxNrofDL-Allocations)) OF PDSCH-TimeDomainResourceAllocation
PDSCH-TimeDomainResourceAllocation ::= SEQUENCE {

| | | |
|---|---|---|
| k0 | INTEGER(0..32) | OPTIONAL, |

-- Need S
(PDCCH-to-PDSCH timing, slot unit)

| | |
|---|---|
| mappingType | ENUMERATED {typeA, typeB}, |

(PDSCH mapping type)

| | |
|---|---|
| startSymbolAndLength | INTEGER (0..127) |

(starting symbol and length of PDSCH)
}

TABLE 9
PUSCH-TimeDomainResourceAllocation information element

| | |
|---|---|
| PUSCH-TimeDomainResourceAllocationList ::= | SEQUENCE |

(SIZE(1..maxNrofUL-Allocations)) OF PUSCH-TimeDomainResourceAllocation
PUSCH-TimeDomainResourceAllocation ::= SEQUENCE {

| | | |
|---|---|---|
| k2 | INTEGER(0..32) | OPTIONAL, -- Need S |

(PDCCH-to-PUSCH timing, slot unit)

| | |
|---|---|
| mappingType | ENUMERATED {typeA, typeB}, |

(PUSCH mapping type)

| | |
|---|---|
| startSymbolAndLength | INTEGER (0..127) |

(starting symbol and length of PUSCH)
}

The base station may notify one of the entries in the table about time domain resource allocation information to the UE through L1 signaling (e.g., DCI) (e.g., it may be indicated in the ‘time domain resource allocation’ field in DCI). The UE may acquire the time domain resource allocation information for the PDSCH or PUSCH based on the DCI received from the base station.

Hereinafter, a frequency domain resource allocation method for data channels in the 5G wireless communication system will be described.

In the 5G wireless communication system, two types, that is, resource allocation type 0 and resource allocation type 1 are supported as a method for indicating frequency domain resource allocation information for a downlink data channel (PDSCH: physical downlink shared channel) and an uplink data channel (PUSCH: physical uplink shared channel).

### Resource Allocation Type 0

RB allocation information may be notified from the base station to the UE in the form of a bitmap for a resource block group (RBG). In this case, the RBG may be composed of a set of consecutive virtual RBs (VRBs), and the size of the RBG, P, may be determined based on a value configured via higher layer parameter (rbg-Size) and a value of a bandwidth part size defined in Table 10 below.

TABLE 10

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

The total number (N_{RBG}) of RBGs of a bandwidth part i having a size of N_{BWP,i}^{size} can be defined as follows.
N_{RBG}=┌(N_{BWP,i}^{size}+(N_{BWP,i}^{start}mod P))/P┐, where
the size of the first RBG is RBG₀^{size}=P−N_{BWP,i}^{start} mod P,
the size of the last RBG is RBGₗₐₛₜ^{size}=(N_{BWP,i}^{start}+N_{BWP,i}^{size}) mod P if (N_{BWP,i}^{start}+N_{BWP,i}^{size}) mod P>0 and P otherwise,
the size of all other RBGs is P.
Each bit of a bitmap having a N_{RBG} bit size may correspond to each RBG. RBGs may be indexed in order of increasing frequency, starting from the lowest frequency position of the bandwidth part. For N_{RBG} RBGs in the bandwidth part, RBG #0 to RBG #(N_{RBG}−1) may be mapped from the MSB to LSB of the RBG bitmap. If a specific bit value in the bitmap is 1, the UE may determine that the RBG corresponding to the bit value has been allocated. If a specific bit value in the bitmap is 0, the UE may determine that the RBG corresponding to the bit value has not been allocated.

### Resource Allocation Type 1

RB allocation information may be notified from the base station to the UE as information on the start position and length of sequentially allocated VRBs. In this case, interleaving or non-interleaving may be additionally applied to the sequentially allocated VRBs. The resource allocation field of the resource allocation type 1 may be composed of a resource indicator value (RIV), and the RIV may be composed of the start point (RBₛₜₐᵣₜ) of the VRB and the length (L_{RBS}) of the sequentially allocated RB. Specifically, the RIV within a bandwidth part having a size of N_{BWP}^{size} size can be defined as follows.

▪ if (L_{RBs} − 1) ≤ └N_{BWP}^{size}/2┘ then
RIV = N_{BWP}^{size}(L_{RBs} − 1) + RBₛₜₐᵣₜ
else
RIV = N_{BWP}^{size}(N_{BWP}^{size} − L_{RBs} + 1) + (N_{BWP}^{size} − 1 − RBₛₜₐᵣₜ)
where L_{RBs} ≥ 1 and shall not exceed N_{BWP}^{size} − RBₛₜₐᵣₜ.

The base station may configure the resource allocation type for the UE through higher layer signaling (e.g., the higher layer parameter resourceAllocation may be configured as one of resourceAllocationType0, resourceAllocationType1, or dynamicSwitch). If the UE is configured with both resource allocation types 0 and 1 (or equally, the higher layer parameter resourceAllocation is configured as dynamicSwitch), the base station may indicate whether a bit corresponding to the most significant bit (MSB) of the field indicating resource allocation in the DCI format indicating scheduling is resource allocation type 0 or resource allocation type 1. In addition, based on the indicated resource allocation type, the resource allocation information may be indicated through the remaining bits excluding the bit corresponding to the MSB, and based on this, the UE may interpret the resource allocation field information of the DCI field. If the UE is configured with one of resource allocation type 0 or resource allocation type 1 (or equally, the higher layer parameter resourceAllocation is configured as one of resourceAllocationType0 or resourceAllocationType1), the resource allocation information may be indicated based on the resource allocation type in which the field indicating resource allocation in the DCI format indicating scheduling is configured, and the UE may interpret the resource allocation field information of the DCI field based on this.

Hereinafter, a modulation and coding scheme (MCS) used in the 5G wireless communication system will be described in detail.

In 5G, multiple MCS index tables are defined for PDSCH and PUSCH scheduling. Which MCS table the UE assumes among the plurality of MCS tables may be configured or indicated through higher layer signaling or L1 signaling from the base station to the UE or through an RNTI value that the UE assumes when decoding the PDCCH.

MCS index table 1 for PDSCH and CP-OFDM-based PUSCH (or PUSCH without transform precoding) may be as shown in Table 11 below.

TABLE 11
MCS index table 1 for PDSCH

| MCS Index | Modulation Order | Target code Rate | Spectral |
|---|---|---|---|
| I_{MCS} | Qₘ | R × [1024] | efficiency |
| 0 | 2 | 120 | 0.2344 |
| 1 | 2 | 157 | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 438 | 2.5664 |
| 18 | 6 | 466 | 2.7305 |
| 19 | 6 | 517 | 3.0293 |
| 20 | 6 | 567 | 3.3223 |
| 21 | 6 | 616 | 3.6094 |
| 22 | 6 | 666 | 3.9023 |
| 23 | 6 | 719 | 4.2129 |
| 24 | 6 | 772 | 4.5234 |
| 25 | 6 | 822 | 4.8164 |
| 26 | 6 | 873 | 5.1152 |
| 27 | 6 | 910 | 5.3320 |
| 28 | 6 | 948 | 5.5547 |

| | | |
|---|---|---|
| 29 | 2 | reserved |
| 30 | 4 | reserved |
| 31 | 6 | reserved |

MCS index table 2 for PDSCH and CP-OFDM-based PUSCH (or PUSCH without transform precoding) may be as shown in Table 12 below.

TABLE 12
MCS index table 2 for PDSCH

| MCS Index | Modulation Order | Target code Rate | Spectral |
|---|---|---|---|
| I_{MCS} | Qₘ | R × [1024] | efficiency |
| 0 | 2 | 120 | 0.2344 |
| 1 | 2 | 193 | 0.3770 |
| 2 | 2 | 308 | 0.6016 |
| 3 | 2 | 449 | 0.8770 |
| 4 | 2 | 602 | 1.1758 |
| 5 | 4 | 378 | 1.4766 |
| 6 | 4 | 434 | 1.6953 |
| 7 | 4 | 490 | 1.9141 |
| 8 | 4 | 553 | 2.1602 |
| 9 | 4 | 616 | 2.4063 |
| 10 | 4 | 658 | 2.5703 |
| 11 | 6 | 466 | 2.7305 |
| 12 | 6 | 517 | 3.0293 |
| 13 | 6 | 567 | 3.3223 |
| 14 | 6 | 616 | 3.6094 |
| 15 | 6 | 666 | 3.9023 |
| 16 | 6 | 719 | 4.2129 |
| 17 | 6 | 772 | 4.5234 |
| 18 | 6 | 822 | 4.8164 |
| 19 | 6 | 873 | 5.1152 |
| 20 | 8 | 682.5 | 5.3320 |
| 21 | 8 | 711 | 5.5547 |
| 22 | 8 | 754 | 5.8906 |
| 23 | 8 | 797 | 6.2266 |
| 24 | 8 | 841 | 6.5703 |
| 25 | 8 | 885 | 6.9141 |
| 26 | 8 | 916.5 | 7.1602 |
| 27 | 8 | 948 | 7.4063 |

| | | |
|---|---|---|
| 28 | 2 | reserved |
| 29 | 4 | reserved |
| 30 | 6 | reserved |
| 31 | 8 | reserved |

MCS index table 3 for PDSCH and CP-OFDM-based PUSCH (or PUSCH without transform precoding) may be as shown in Table 13 below.

TABLE 13
MCS index table 3 for PDSCH

| MCS Index | Modulation Order | Target code Rate | Spectral |
|---|---|---|---|
| I_{MCS} | Qₘ | R × [1024] | efficiency |
| 0 | 2 | 30 | 0.0586 |
| 1 | 2 | 40 | 0.0781 |
| 2 | 2 | 50 | 0.0977 |
| 3 | 2 | 64 | 0.1250 |
| 4 | 2 | 78 | 0.1523 |
| 5 | 2 | 99 | 0.1934 |
| 6 | 2 | 120 | 0.2344 |
| 7 | 2 | 157 | 0.3066 |
| 8 | 2 | 193 | 0.3770 |
| 9 | 2 | 251 | 0.4902 |
| 10 | 2 | 308 | 0.6016 |
| 11 | 2 | 379 | 0.7402 |
| 12 | 2 | 449 | 0.8770 |
| 13 | 2 | 526 | 1.0273 |
| 14 | 2 | 602 | 1.1758 |
| 15 | 4 | 340 | 1.3281 |
| 16 | 4 | 378 | 1.4766 |
| 17 | 4 | 434 | 1.6953 |
| 18 | 4 | 490 | 1.9141 |
| 19 | 4 | 553 | 2.1602 |
| 20 | 4 | 616 | 2.4063 |
| 21 | 6 | 438 | 2.5664 |
| 22 | 6 | 466 | 2.7305 |
| 23 | 6 | 517 | 3.0293 |
| 24 | 6 | 567 | 3.3223 |
| 25 | 6 | 616 | 3.6094 |
| 26 | 6 | 666 | 3.9023 |
| 27 | 6 | 719 | 4.2129 |
| 28 | 6 | 772 | 4.5234 |

| | | |
|---|---|---|
| 29 | 2 | reserved |
| 30 | 4 | reserved |
| 31 | 6 | reserved |

MCS index table 1 for DFT-s-OFDM-based PUSCH (or PUSCH with transform precoding) may be as shown in Table 14 below.

TABLE 14
MCS index table for PUSCH with
transform precoding and 64QAM

| MCS Index | Modulation Order | Target code Rate | Spectral |
|---|---|---|---|
| I_{MCS} | Qₘ | R × 1024 | efficiency |
| 0 | q | 240/q | 0.2344 |
| 1 | q | 314/q | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 466 | 2.7305 |
| 18 | 6 | 517 | 3.0293 |
| 19 | 6 | 567 | 3.3223 |
| 20 | 6 | 616 | 3.6094 |
| 21 | 6 | 666 | 3.9023 |
| 22 | 6 | 719 | 4.2129 |
| 23 | 6 | 772 | 4.5234 |
| 24 | 6 | 822 | 4.8164 |
| 25 | 6 | 873 | 5.1152 |
| 26 | 6 | 910 | 5.3320 |
| 27 | 6 | 948 | 5.5547 |

| | | |
|---|---|---|
| 28 | q | reserved |
| 29 | 2 | reserved |
| 30 | 4 | reserved |
| 31 | 6 | reserved |

MCS index table 2 for DFT-s-OFDM-based PUSCH (or PUSCH with transform precoding) may be as shown in Table 15 below.

TABLE 15
MCS index table 2 for PUSCH with
transform precoding and 64QAM

| MCS Index | Modulation Order | Target code Rate | Spectral |
|---|---|---|---|
| I_{MCS} | Qₘ | R × 1024 | efficiency |
| 0 | q | 60/q | 0.0586 |
| 1 | q | 80/q | 0.0781 |
| 2 | q | 100/q | 0.0977 |
| 3 | q | 128/q | 0.1250 |
| 4 | q | 156/q | 0.1523 |
| 5 | q | 198/q | 0.1934 |
| 6 | 2 | 120 | 0.2344 |
| 7 | 2 | 157 | 0.3066 |
| 8 | 2 | 193 | 0.3770 |
| 9 | 2 | 251 | 0.4902 |
| 10 | 2 | 308 | 0.6016 |
| 11 | 2 | 379 | 0.7402 |
| 12 | 2 | 449 | 0.8770 |
| 13 | 2 | 526 | 1.0273 |
| 14 | 2 | 602 | 1.1758 |
| 15 | 2 | 679 | 1.3262 |
| 16 | 4 | 378 | 1.4766 |
| 17 | 4 | 434 | 1.6953 |
| 18 | 4 | 490 | 1.9141 |
| 19 | 4 | 553 | 2.1602 |
| 20 | 4 | 616 | 2.4063 |
| 21 | 4 | 658 | 2.5703 |
| 22 | 4 | 699 | 2.7305 |
| 23 | 4 | 772 | 3.0156 |
| 24 | 6 | 567 | 3.3223 |
| 25 | 6 | 616 | 3.6094 |
| 26 | 6 | 666 | 3.9023 |
| 27 | 6 | 772 | 4.5234 |

| | | |
|---|---|---|
| 28 | q | reserved |
| 29 | 2 | reserved |
| 30 | 4 | reserved |
| 31 | 6 | reserved |

MCS index table for PUSCH to which transform precoding (or discrete Fourier transform (DFT) precoding) and 64 QAM are applied may be as shown in Table 16 below.

TABLE 16

| MCS Index | Modulation Order | Target code Rate | Spectral |
|---|---|---|---|
| I_{MCS} | Qₘ | R × 1024 | efficiency |
| 0 | q | 240/q | 0.2344 |
| 1 | q | 314/q | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 466 | 2.7305 |
| 18 | 6 | 517 | 3.0293 |
| 19 | 6 | 567 | 3.3223 |
| 20 | 6 | 616 | 3.6094 |
| 21 | 6 | 666 | 3.9023 |
| 22 | 6 | 719 | 4.2129 |
| 23 | 6 | 772 | 4.5234 |
| 24 | 6 | 822 | 4.8164 |
| 25 | 6 | 873 | 5.1152 |
| 26 | 6 | 910 | 5.3320 |
| 27 | 6 | 948 | 5.5547 |

| | | |
|---|---|---|
| 28 | q | reserved |
| 29 | 2 | reserved |
| 30 | 4 | reserved |
| 31 | 6 | reserved |

MCS index table for PUSCH to which transform precoding (or DFT precoding) and 64 QAM are applied may be as shown in Table 17 below.

TABLE 17

| MCS Index | Modulation Order | Target code | Spectral |
|---|---|---|---|
| I_{MCS} | Qₘ | Rate R × 1024 | efficiency |
| 0 | q | 60/q | 0.0586 |
| 1 | q | 80/q | 0.0781 |
| 2 | q | 100/q | 0.0977 |
| 3 | q | 128/q | 0.1250 |
| 4 | q | 156/q | 0.1523 |
| 5 | q | 198/q | 0.1934 |
| 6 | 2 | 120 | 0.2344 |
| 7 | 2 | 157 | 0.3066 |
| 8 | 2 | 193 | 0.3770 |
| 9 | 2 | 251 | 0.4902 |
| 10 | 2 | 308 | 0.6016 |
| 11 | 2 | 379 | 0.7402 |
| 12 | 2 | 449 | 0.8770 |
| 13 | 2 | 526 | 1.0273 |
| 14 | 2 | 602 | 1.1758 |
| 15 | 2 | 679 | 1.3262 |
| 16 | 4 | 378 | 1.4766 |
| 17 | 4 | 434 | 1.6953 |
| 18 | 4 | 490 | 1.9141 |
| 19 | 4 | 553 | 2.1602 |
| 20 | 4 | 616 | 2.4063 |
| 21 | 4 | 658 | 2.5703 |
| 22 | 4 | 699 | 2.7305 |
| 23 | 4 | 772 | 3.0156 |
| 24 | 6 | 567 | 3.3223 |
| 25 | 6 | 616 | 3.6094 |
| 26 | 6 | 666 | 3.9023 |
| 27 | 6 | 772 | 4.5234 |

| | | |
|---|---|---|
| 28 | q | reserved |
| 29 | 2 | reserved |
| 30 | 4 | reserved |
| 31 | 6 | reserved |

Hereinafter, a downlink control channel in the 5G wireless communication system will be described in detail with reference to the drawings.

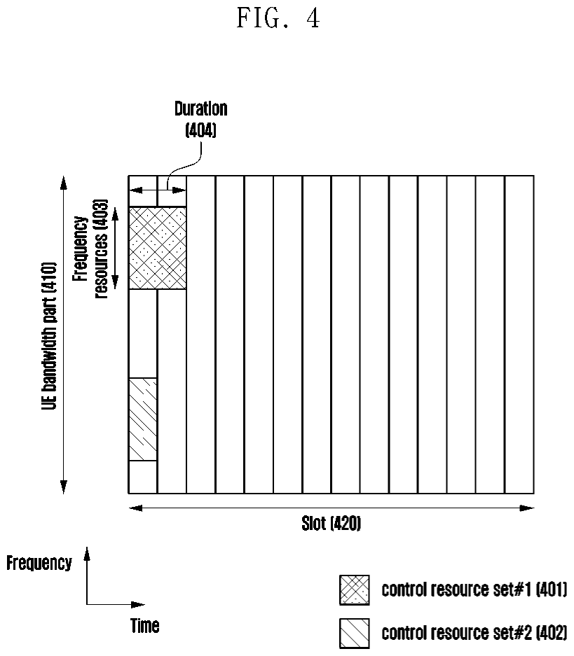

FIG. 4 is a diagram illustrating an example of a control resource set (CORESET) where a downlink control channel is transmitted in the 5G wireless communication system.

With reference to FIG. 4, a UE BWP 410 may be configured in the frequency domain and two CORESETs (CORESET #1 401 and CORESET #2 402) may be configured within one slot 420 in the time domain. The CORESETs 401 and 402 may be configured in specific frequency resources 403 within the entire UE BWP 410 in the frequency domain. In the time domain, the CORESETs 401 and 402 may be configured with one or a plurality of OFDM symbols, which may be defined as a CORESET duration 404. In an example shown in FIG. 4, the CORESET #1 401 is configured with the CORESET duration of two symbols, and the CORESET #2 402 is configured with the CORESET duration of one symbol.

The above-described CORESETs in 5G may be configured for the UE by the base station via higher layer signaling (e.g., SI, MIB, RRC signaling). Configuring the CORESETs for the UE refers to providing information such as CORESET identities, frequency locations of CORESETs, symbol lengths of CORESETs, and the like. For example, information in Table 18 may be included.

TABLE 18

| | |
|---|---|
| ControlResourceSet ::= | SEQUENCE { |

Corresponds to L1 parameter ‘CORESET-ID’

| | |
|---|---|
| controlResourceSetId | ControlResourceSetId, |

(control resource set Identity)

| | |
|---|---|
| frequencyDomainResources | BIT STRING (SIZE (45)), |

(frequency axis resource allocation information)

| | |
|---|---|
| duration | INTEGER (1..maxCo |

ReSetDuration),
(time axis resource allocation information)

| | |
|---|---|
| cce-REG-MappingType | CHOICE { |

(CCE-to-REG mapping type)

| | |
|---|---|
| interleaved | SEQUENCE { |
| reg-BundleSize | ENUMERATED {n2, |

n3, n6},
(REG bundle size)

| | |
|---|---|
| precoderGranularity | ENUMERATED {sameAsR |

EG-bundle, allContiguousRBs},

| | |
|---|---|
| interleaverSize | ENUMERATED {n2, |

n3, n6}
(interleaver size)

| | |
|---|---|
| shiftIndex | INTEGER(0..maxNro |

fPhysicalResourceBlocks-1)
OPTIONAL
interleaver shift)
},

| | |
|---|---|
| nonInterleaved | NULL |

},

| | |
|---|---|
| tci-StatesPDCCH | SEQUENCE(SIZE (1 |
| ..maxNrofTCI-StatesPDCCH)) OF TCI-StateId | OPTIO |

NAL,
(QCL configuration information)

| | |
|---|---|
| tci-PresentInDCI | ENUMERATED {enabled} |

OPTIONAL, -- Need S
}

In Table 18, tci-StatesPDCCH (simply referred to as transmission configuration indication (TCI) state) configuration information may include information about one or multiple synchronization signal/physical broadcast channel (SS/PBCH) block indices or channel state information reference signal (CSI-RS) indices having a QCL relationship with a DMRS transmitted in the corresponding CORESET.

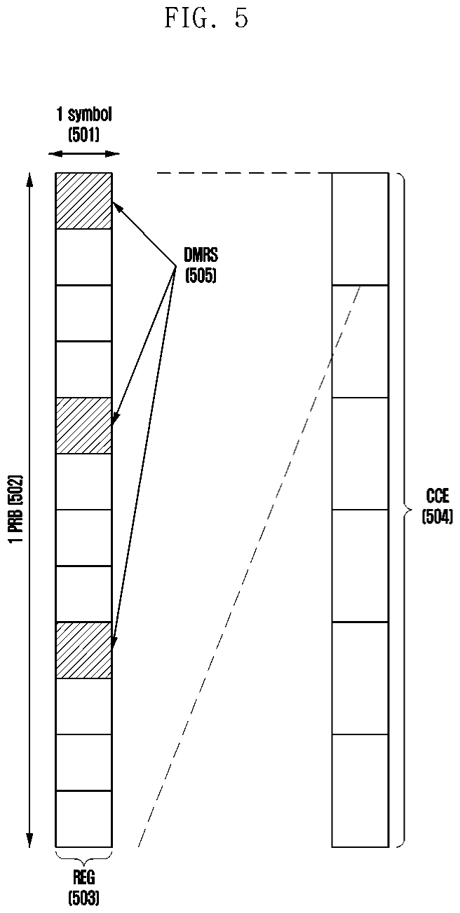

FIG. 5 is a diagram illustrating the structure of a downlink control channel in a wireless communication system. That is, FIG. 5 shows an example of the basic unit of time and frequency resources that constitute the downlink control channel used in the 5G wireless communication system.

With reference to FIG. 5, the basic unit of time and frequency resources constituting a control channel may be referred to as a resource element group (REG) 503, which may be defined as one OFDM symbol 501 in the time domain and one physical resource block (PRB) 502, i.e., 12 subcarriers, in the frequency domain. The base station may concatenate REGs 503 to construct a downlink control channel allocation unit.

As shown in FIG. 5, when a basic unit for allocating a downlink control channel in the 5G wireless communication system is a control channel element (CCE) 504, one CCE 504 may be composed of a plurality of REGs 503. In the example shown in FIG. 5, the REG 503 may include 12 REs, and if one CCE 504 consist of six REGs 503, one CCE 504 may include 72 REs. When the downlink CORESET is configured, it may be composed of a plurality of CCEs 504, and a specific downlink control channel may be mapped to one or more CCEs 504 depending on an aggregation level (AL) in the CORESET and then transmitted. The CCEs 504 within the CORESET are distinguished by numbers. Here, the numbers of the CCEs 504 may be assigned according to a logical mapping scheme.

The basic unit of the downlink control channel shown in FIG. 5, that is, the REG 503, may include REs to which DCI is mapped and a region to which a DMRS 505 which is a reference signal for decoding the DCI is mapped. As shown in FIG. 5, three DMRSs 505 may be transmitted in one REG 503. The number of CCEs required for transmission of the PDCCH may be 1, 2, 4, 8, or 16 depending on the AL, and different numbers of CCEs may be used to implement link adaptation of the downlink control channel. For example, in case of AL=L, one downlink control channel may be transmitted through L CCEs. The UE needs to detect a signal in a state of not knowing information about the downlink control channel, and a search space representing a set of CCEs is defined for blind decoding. The search space is a set of downlink control channel candidates composed of CCEs that the UE has to attempt to decode at a given AL. Since there are various ALs that make one bundle of 1, 2, 4, 8, or 16 CCEs, the UE may have a plurality of search spaces. A search space set may be defined as a set of search spaces at all configured ALs.

The search spaces may be classified into a common search space and a UE-specific search space. A certain group of UEs or all the UEs may examine the common search space of the PDCCH so as to receive cell common control information such as dynamic scheduling for system information or a paging message. For example, PDSCH scheduling allocation information for transmission of SIB including cell operator information and the like may be received by examining the common search space of the PDCCH. In case of the common search space, since a certain group of UEs or all the UEs need to receive the PDCCH, the common search space may be defined as a set of prearranged CCEs. Scheduling allocation information about the UE-specific PDSCH or PUSCH may be received by examining the UE-specific search space of the PDCCH. The UE-specific search space may be UE-specifically defined as a function of the UE identity and various system parameters.

In the 5G wireless communication system, parameters for the search space of the PDCCH may be configured for the UE by the base station via higher layer signaling (e.g., SIB, MIB, RRC signaling, etc.). For example, the base station may configure, for the UE, the number of PDCCH candidates at each aggregation level L, a monitoring periodicity for a search space, a monitoring occasion in symbol units within a slot for a search space, a search space type (a common search space or a UE-specific search space), a combination of RNTI and DCI format to be monitored in the corresponding search space, a control resource set index to monitor a search space, and the like. For example, parameters for the search space of the PDCCH may include information in FIG. 19.

TABLE 19

| | |
|---|---|
| SearchSpace ::= | SEQUENCE { |

Identity of the search space. SearchSpaceId = 0 identifies the SearchSpace configure
d via PBCH (MIB) or ServingCellConfigCommon.

| | |
|---|---|
| searchSpaceId | SearchSpaceId, |

(search space identity)

| | |
|---|---|
| controlResourceSetId | ControlResourceSetId, |

(control resource set identity)

| | |
|---|---|
| monitoringSlotPeriodicityAndOffset | CHOICE { |

(monitoring slot level periodicity)

| | |
|---|---|
| sl1 | NULL, |
| sl2 | INTEGER (0.. |

1),

| | |
|---|---|
| sl4 | INTEGER (0.. |

3),

| | |
|---|---|
| sl5 | INTEGER (0..4), |
| sl8 | INTEGER (0.. |

7),

| | |
|---|---|
| sl10 | INTEGER (0..9), |
| sl16 | INTEGER (0..15), |
| sl20 | INTEGER (0..19) |
| } | |
| | OPTIONAL, |
| duration(monitoring duration) | INTEGER (2..2559) |
| monitoringSymbolsWithinSlot | BIT STRING (SIZE ( |

14))
OPTIONAL,
(monitoring symbol in a slot)

| | |
|---|---|
| nrofCandidates | SEQUENCE { |

(number of PDCCH candidates per aggregation level)

| | |
|---|---|
| aggregationLevel1 | ENUMERATED {n0, n1, n2, |

n3, n4, n5, n6, n8},

| | |
|---|---|
| aggregationLevel2 | ENUMERATED {n0, n1, n2, |

n3, n4, n5, n6, n8},

| | |
|---|---|
| aggregationLevel4 | ENUMERATED {n0, n1, n2, |

n3, n4, n5, n6, n8},

| | |
|---|---|
| aggregationLevel8 | ENUMERATED {n0, n1, n2, |

n3, n4, n5, n6, n8},

| | |
|---|---|
| aggregationLevel16 | ENUMERATED {n0, n1, n2, |

n3, n4, n5, n6, n8}
},

| | |
|---|---|
| searchSpaceType | CHOICE { |

(search space type)
Configures this search space as common search space (CSS) and DCI formats to mo
nitor.

| | |
|---|---|
| common | SEQUENCE { |

(common search space)
}

| | |
|---|---|
| ue-Specific | SEQUENCE { |

(ue specific search space)
Indicates whether the UE monitors in this USS for DCI formats 0-0 and 1-0 or for fo
rmats 0-1 and 1-1.

| | |
|---|---|
| formats | ENUMERATE |

D {formats0-0-And-1-0, formats0-1-And-1-1},
...
}

The base station may configure one or more search space sets for the UE according to configuration information. According to an embodiment, the base station may configure search space set 1 and search space set 2 for the UE. Also, the base station may configure the search space set 1 so that DCI format A scrambled by an X-RNTI is monitored in the common search space, and may configure the search space set 2 so that DCI format B scrambled by a Y-RNTI is monitored in the UE-specific search space.

According to the configuration information, one or more search space sets may exist in the common search space or the UE-specific search space. For example, search space set #1 and search space set #2 may be configured as the common search space, and search space set #3 and search space set #4 may be configured as the UE-specific search space.

In the common search space, the following combinations of the DCI format and the RNTI may be monitored. However, the disclosure is not limited to the following example.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

In the UE-specific search space, the following combinations of the DCI format and the RNTI may be monitored. However, the disclosure is not limited to the following example.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

The specified RNTIs may follow the definitions and usages described below.
Cell RNTI (C-RNTI): For UE-specific PDSCH scheduling
Modulation Coding Scheme C-RNTI (MCS-C-RNTI): For UE-specific PDSCH scheduling
Temporary Cell RNTI (TC-RNTI): For UE-specific PDSCH scheduling
Configured Scheduling RNTI (CS-RNTI): For semi-statically configured UE-specific PDSCH scheduling
Random Access RNTI (RA-RNTI): For PDSCH scheduling in random access step
Paging RNTI (P-RNTI): For scheduling of PDSCH in which paging is transmitted
System Information RNTI (SI-RNTI): For scheduling of PDSCH in which system information is transmitted
Interruption RNTI (INT-RNTI): For notifying whether to puncture PDSCH.
Transmit Power Control for PUSCH RNTI (TPC-PUSCH-RNTI): For indication of power control command for PUSCH
Transmit Power Control for PUCCH RNTI (TPC-PUCCH-RNTI): For indication of power control command for PUCCH
Transmit Power Control for SRS RNTI (TPC-SRS-RNTI): For indication of power control command for SRS

The above-described specified DCI formats may follow the definition in Table 20.

TABLE 20

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and |
| | OFDM symbol(s) where UE may assume no |
| | transmission is intended for the UE |
| 2_2 | Transmission of TPC commands for PUCCH |
| | and PUSCH |
| 2_3 | Transmission of a group of TPC commands |
| | for SRS transmissions by one or more UEs |

In the 5G wireless communication system, the search space of the aggregation level L in the CORESET p and the search space set s may be expressed by Equation 1 below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i \qquad Equation 1$$

L: Aggregation level
n_{Cl}: Carrier index
N_{CCE,p}: Total number of CCEs existing in the CORESET p
n_{sf}^{μ}: Slot index
M_{s,max}^{(L)}: Number of PDCCH candidates of aggregation level L
m_{s,nCl}=0, . . . , M_{s,max}^{(L)}−1: PDCCH candidate group index of aggregation level L
i=0, . . . , L−1
Y_{p,n}_{_{s,f}}_{^{μ}}=(Aₚ·Y_{p,n}_{_{s,f}}_{^{μ}}₋₁) mod D, Yₚ₋₁=n_{RNTI}≠0, Aₚ=39827 for p mod 3=0, Aₚ=39829 for p mod 3=1, Aₚ=39839 for p mod 3=2, and D=65537.
n_{RNTI}: UE identifier

In the case of the common search space, the value of Y_{p,n}_{_{s,f}}_{^{μ}} may correspond to zero.

In the case of the UE-specific search space, the value of Y_{p,n}_{_{s,f}}_{^{μ}} may correspond to a value that varies depending on the UE's identity (C-RNTI or ID configured for the UE by the base station) and time index.

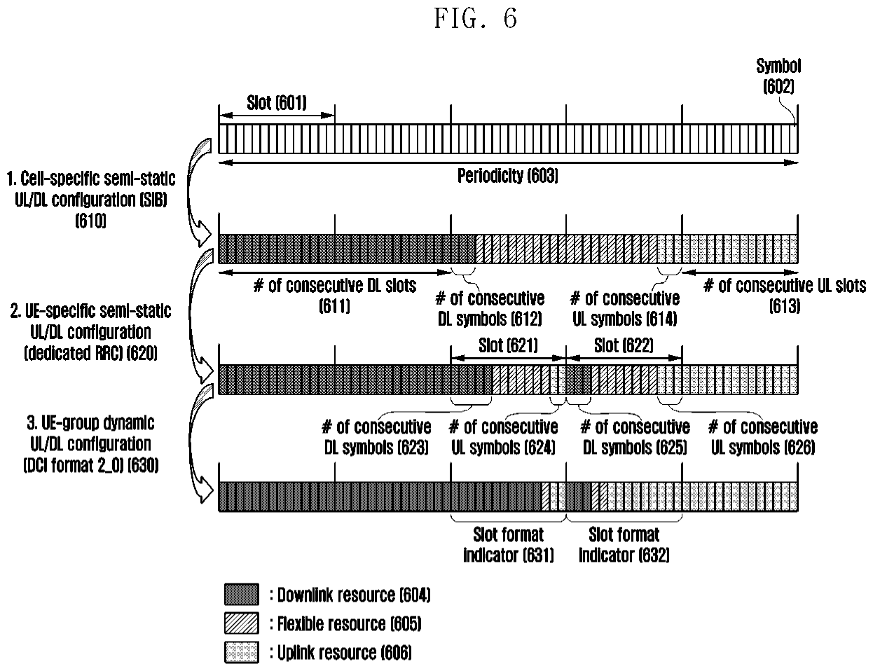

FIG. 6 is a diagram illustrating an example of uplink-downlink configuration considered in a wireless communication system according to an embodiment of the disclosure.

With reference to FIG. 6, a slot 601 may include fourteen symbols 602. In the 5G communication system, uplink-downlink configuration of symbol/slot may be configured in three steps. First, the uplink-downlink of symbol/slot may be configured semi-statically with cell-specific configuration information 610 through system information in a symbol unit. Specifically, the cell-specific uplink-downlink configuration information through system information may include uplink-downlink pattern information and reference subcarrier information. The uplink-downlink pattern information may indicate a pattern periodicity 603, the number 611 of consecutive downlink slots from the start point of each pattern, the number 612 of symbols in the next slot, the number 613 of consecutive uplink slots from the end of the pattern, and the number 614 of symbols in the next slot. In this case, slots and symbols not indicated for uplink or downlink may be determined as flexible slots/symbols.

Second, using user-specific configuration information through dedicated higher layer signaling, flexible slots or slots 621 and 622 containing flexible symbols may be indicated with the number 623 and 625 of consecutive downlink symbols from the start symbol of each slot and the number 624 and 626 of consecutive uplink symbols from the end of each slot or indicated with the entire slot downlink or the entire slot uplink.

Finally, in order to dynamically change the downlink signal transmission and uplink signal transmission intervals, each of symbols indicated as flexible symbols in each slot (i.e., symbols not indicated as downlink or uplink) may be indicated whether it is a downlink symbol, an uplink symbol, or a flexible symbol, through a slot format indicator (SFI) 631 and 632 included in the downlink control channel. The SFI may select one index from a table in which the uplink-downlink configuration of 14 symbols in one slot is predetermined, as shown in Table 21 below.

TABLE 21

| | Symbol number in a slot | | | | | | | | | | | | | |
|---|---|---|---|---|---|---|---|---|---|---|---|---|---|---|
| Format | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D |
| 1 | U | U | U | U | U | U | U | U | U | U | U | U | U | U |
| 2 | F | F | F | F | F | F | F | F | F | F | F | F | F | F |
| 3 | D | D | D | D | D | D | D | D | D | D | D | D | D | F |
| 4 | D | D | D | D | D | D | D | D | D | D | D | D | F | F |
| 5 | D | D | D | D | D | D | D | D | D | D | D | F | F | F |
| 6 | D | D | D | D | D | D | D | D | D | D | F | F | F | F |
| 7 | D | D | D | D | D | D | D | D | D | F | F | F | F | F |
| 8 | F | F | F | F | F | F | F | F | F | F | F | F | F | U |
| 9 | F | F | F | F | F | F | F | F | F | F | F | F | U | U |
| 10 | F | U | U | U | U | U | U | U | U | U | U | U | U | U |
| 11 | F | F | U | U | U | U | U | U | U | U | U | U | U | U |
| 12 | F | F | F | U | U | U | U | U | U | U | U | U | U | U |
| 13 | F | F | F | F | U | U | U | U | U | U | U | U | U | U |
| 14 | F | F | F | F | F | U | U | U | U | U | U | U | U | U |
| 15 | F | F | F | F | F | F | U | U | U | U | U | U | U | U |
| 16 | D | F | F | F | F | F | F | F | F | F | F | F | F | F |
| 17 | D | D | F | F | F | F | F | F | F | F | F | F | F | F |
| 18 | D | D | D | F | F | F | F | F | F | F | F | F | F | F |
| 19 | D | F | F | F | F | F | F | F | F | F | F | F | F | U |
| 20 | D | D | F | F | F | F | F | F | F | F | F | F | F | U |
| 21 | D | D | D | F | F | F | F | F | F | F | F | F | F | U |
| 22 | D | F | F | F | F | F | F | F | F | F | F | F | U | U |
| 23 | D | D | F | F | F | F | F | F | F | F | F | F | U | U |
| 24 | D | D | D | F | F | F | F | F | F | F | F | F | U | U |
| 25 | D | F | F | F | F | F | F | F | F | F | F | U | U | U |
| 26 | D | D | F | F | F | F | F | F | F | F | F | U | U | U |
| 27 | D | D | D | F | F | F | F | F | F | F | F | U | U | U |
| 28 | D | D | D | D | D | D | D | D | D | D | D | D | F | U |
| 29 | D | D | D | D | D | D | D | D | D | D | D | F | F | U |
| 30 | D | D | D | D | D | D | D | D | D | D | F | F | F | U |
| 31 | D | D | D | D | D | D | D | D | D | D | D | F | U | U |
| 32 | D | D | D | D | D | D | D | D | D | D | F | F | U | U |
| 33 | D | D | D | D | D | D | D | D | D | F | F | F | U | U |
| 34 | D | F | U | U | U | U | U | U | U | U | U | U | U | U |
| 35 | D | D | F | U | U | U | U | U | U | U | U | U | U | U |
| 36 | D | D | D | F | U | U | U | U | U | U | U | U | U | U |
| 37 | D | F | F | U | U | U | U | U | U | U | U | U | U | U |
| 38 | D | D | F | F | U | U | U | U | U | U | U | U | U | U |
| 39 | D | D | D | F | F | U | U | U | U | U | U | U | U | U |
| 40 | D | F | F | F | U | U | U | U | U | U | U | U | U | U |
| 41 | D | D | F | F | F | U | U | U | U | U | U | U | U | U |
| 42 | D | D | D | F | F | F | U | U | U | U | U | U | U | U |
| 43 | D | D | D | D | D | D | D | D | D | F | F | F | F | U |
| 44 | D | D | D | D | D | D | F | F | F | F | F | F | U | U |
| 45 | D | D | D | D | D | D | F | F | U | U | U | U | U | U |
| 46 | D | D | D | D | D | F | U | D | D | D | D | D | F | U |
| 47 | D | D | F | U | U | U | U | D | D | F | U | U | U | U |
| 48 | D | F | U | U | U | U | U | D | F | U | U | U | U | U |
| 49 | D | D | D | D | F | F | U | D | D | D | D | F | F | U |
| 50 | D | D | F | F | U | U | U | D | D | F | F | U | U | U |
| 51 | D | F | F | U | U | U | U | D | F | F | U | U | U | U |
| 52 | D | F | F | F | F | F | U | D | F | F | F | F | F | U |
| 53 | D | D | F | F | F | F | U | D | D | F | F | F | F | U |
| 54 | F | F | F | F | F | F | F | D | D | D | D | D | D | D |
| 55 | D | D | F | F | F | U | U | U | D | D | D | D | D | D |

| | |
|---|---|
| 56-254 | Reserved |
| 255 | UE determines the slot format for the slot |
| | based on tdd-UL-DL-ConfigurationCommon, |
| | or tdd-UL-DL-ConfigurationDedicated |
| | and, if any, on detected DCI formats |

### XDD Related

The 5G mobile communication service has introduced additional coverage expansion technology compared to the LTE communication service, but the actual coverage of 5G mobile communication service may generally utilize a TDD system suitable for services with a high proportion of downlink traffic. In addition, as the center frequency becomes high to increase the frequency band, the coverage of base station and UE decreases, and thus coverage enhancement is a key requirement for 5G mobile communication services. Particularly, in order to support services in which the transmission power of the UE is overall lower than that of the base station and the proportion of downlink traffic is high, and because the ratio of downlink in the time domain is higher than that of uplink, the coverage enhancement of uplink channels is a key requirement for 5G mobile communication services. As a method for physically enhancing the coverage of the uplink channel between the base station and the UE, there may be a method for increasing the time resource of the uplink channel, lowering the center frequency, or increasing the transmit power of the UE. However, changing the frequency may have limitations because the frequency band per network operator is determined. In addition, increasing the maximum transmit power of the UE may be limited because the maximum value is fixed to reduce interference, that is, because the maximum transmit power of the UE is regulated.

Therefore, in order to enhance the coverage of base station and UE, uplink and downlink resources may be divided even in the frequency domain like in the FDD system rather than the ratio is divided in the time domain according to the proportions of uplink and downlink traffic in the TDD system. In an embodiment, a system that can flexibly divide uplink resources and downlink resources in the time domain and frequency domain may be referred to as an XDD system, a flexible TDD system, a hybrid TDD system, a TDD-FDD system, a hybrid TDD-FDD system, etc., and in this disclosure it will be referred to as the XDD system for convenience of explanation. According to an embodiment, ‘X’ in XDD may mean time or frequency.

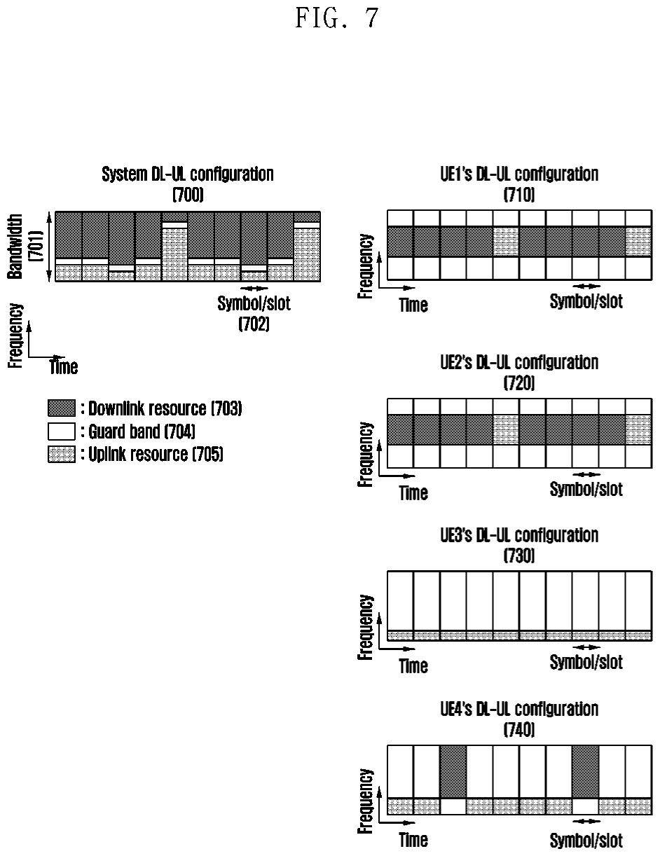

FIG. 7 is a diagram illustrating the uplink-downlink resource configuration of the XDD system in which uplink and downlink resources are flexibly divided in the time domain and frequency domain, according to an embodiment of the disclosure.

With reference to FIG. 7, in the uplink-downlink configuration 700 of the overall XDD system, from the base station's perspective, resources may be flexibly allocated to each symbol or slot 702 according to the proportion of uplink and downlink traffic for the entire frequency band 701. In this case, a guard band 704 may be allocated between the frequency bands of a downlink resource 703 and an uplink resource 705. The guard band 704 may be allocated for reducing interference in an uplink channel or signal reception caused by out-of-band emission that occurs when the base station transmits a downlink channel or signal in the downlink resource 703. For example, UE1 710 and UE2 720, which have more downlink traffic than uplink traffic, may be allocate the resource ratio of downlink and uplink to 4:1 in the time domain by the configuration of the base station. Also, UE3 730, which operates at the cell edge and thus has insufficient uplink coverage, may be allocated only uplink resources in a specific time interval by the configuration of the base station. Additionally, UE4 740, which operates at the cell edge and thus has insufficient uplink coverage, but has a relatively large amount of downlink and uplink traffic, may be allocated a lot of uplink resources in the time domain for uplink coverage and be allocated a lot of downlink resources in the frequency band. As in the above-described example, there is an advantage that more downlink resources can be allocated in the time domain to UEs that operate relatively at the cell center and have a lot of downlink traffic, and more uplink resources can be allocated in the time domain to UEs that operate relatively at the cell edge and have insufficient uplink coverage.

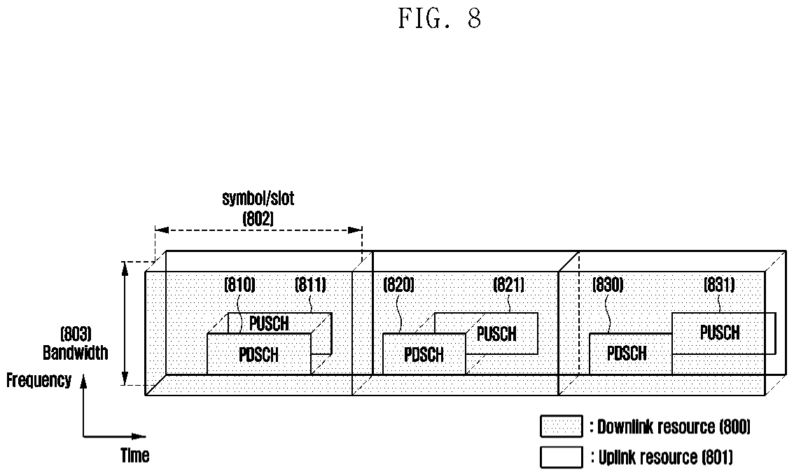

FIG. 8 shows an example of the uplink-downlink resource configuration of a full duplex communication system in which uplink and downlink resources are flexibly divided in the time domain and frequency domain, according to an embodiment of the disclosure.

With reference to FIG. 8, all or part of downlink resources 800 and uplink resources 801 may be configured to overlap in the time and frequency domains. In the example of FIG. 8, all of the downlink resources 800 and the uplink resources 801 are configured to overlap in time resources corresponding to a symbol or slot 802 and in frequency resources corresponding to a bandwidth 803. Downlink transmissions 810, 820, and 830 from the base station to the UE may be performed in an area configured as the downlink resources 800, and uplink transmissions 811, 821, and 831 from the UE to the base station may be performed in an area configured as the uplink resources 801. At this time, since the downlink resources 800 and the uplink resources 801 overlap in time and frequency, downlink/uplink transmission and reception of the base station or UE may occur simultaneously in the same time and frequency resources.

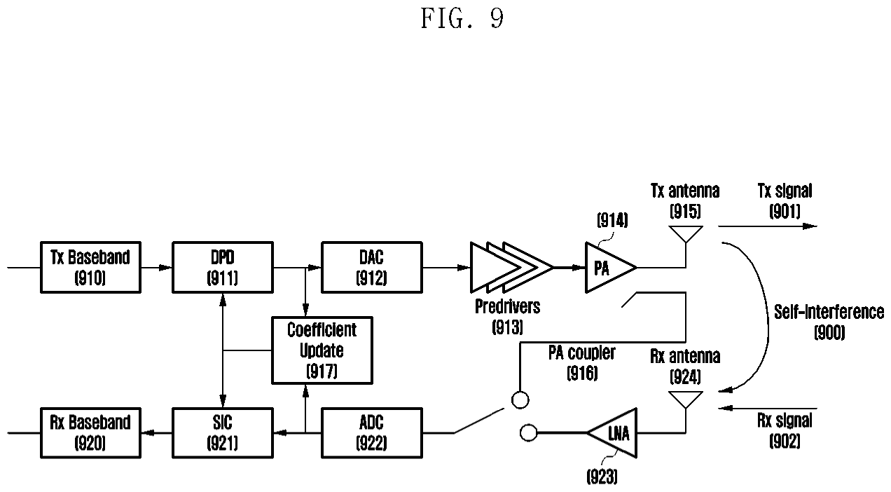

FIG. 9 is a diagram illustrating a transmission and reception structure for a duplex scheme according to an embodiment of the disclosure. The transmission and reception structure shown in FIG. 9 can be considered for a base station device or a UE device.

According to the transmission and reception structure shown in FIG. 9, a transmitting end may be composed of blocks such as a transmission (Tx) baseband 910, a digital pre-distortion (DPD) 911, a digital-to-analog converter (DAC) 912, a pre-driver 913, a power amplifier (PA) 914, and a Tx antenna 915. Each block can perform the following roles.
Tx baseband 910: Digital processing for transmission signal
DPD 911: Pre-distortion of digital transmission signal
DAC 912: Conversion of digital signal into analog signal
Pre-driver 913: Gradual power amplification of analog transmission signal
PA 914: Power amplification of analog transmission signal
Tx antenna 915: Antenna for signal transmission

According to the transmission and reception structure shown in FIG. 9, a receiving end may be composed of blocks such as a reception (Rx) antenna 924, a low noise amplifier (LNA) 923, an analog-to-digital converter (ADC) 922, a successive interference cancellator (SIC) 921, and an Rx baseband 920. Each block can perform the following roles.
Rx antenna 924: Antenna for signal reception
LNA 923: Power amplification of analog reception signal with noise amplification minimized
ADC 922: Conversion of analog signal into digital signal
SIC 921: Interference cancellation for digital signal
Rx baseband 920: Digital processing for received signal

According to the transmission and reception structure shown in FIG. 9, a power amplifier (PA) coupler 916 and a coefficient update block 917 may exist for additional signal processing between the transmitting end and the receiving end. Each block can perform the following roles.

PA coupler 916: A block for the purpose of observing, at the receiving end, the waveform of the analog transmission signal that has passed through the PA

Coefficient update block 917: It updates various constants necessary for digital domain signal processing of the transmitting end and the receiving end. The constants calculated here may be used for setting various parameters in the DPD 911 block of the transmitting end and the SIC 921 block of the receiving end.

The transmission and reception structure shown in FIG. 9 may be used to effectively control interference between transmission and reception signals when transmission and reception operations are performed simultaneously in the base station or UE device. For example, when transmission and reception occur simultaneously in a certain device, a transmitted signal 901 from the Tx antenna 915 of the transmitting end may be received through the Rx antenna 924 of the receiving end. In this case, the transmitted signal 901 received at the receiving end may cause interference 900 to a received signal 902 that the receiving end originally intends to receive. This interference between the transmitted signal 901 and the received signal 902 received at the receiving end is called self-interference 900. For example, in the case where the base station device performs downlink transmission and uplink reception at the same time, the downlink signal transmitted by the base station may be received by the receiving end of the base station, and thus interference may occur at the receiving end of the base station between the transmitted downlink signal and the uplink signal that the base station originally intends to receive. Also, in the case where the UE device performs downlink reception and uplink transmission simultaneously, the uplink signal transmitted by the UE may be received by the receiving end of the UE, and thus interference may occur at the receiving end of the UE between the transmitted uplink signal and the downlink signal that the UE originally intends to receive. As such, interference between links in different directions, that is, downlink signals and uplink signals, occurring in the base station or UE device is also referred to as cross-link interference.

In an embodiment of the disclosure, self-interference between a transmitted signal (or downlink signal) and a received signal (or uplink signal) may occur in a system where transmission and reception can be performed simultaneously. For example, self-interference may occur in the XDD system described above.

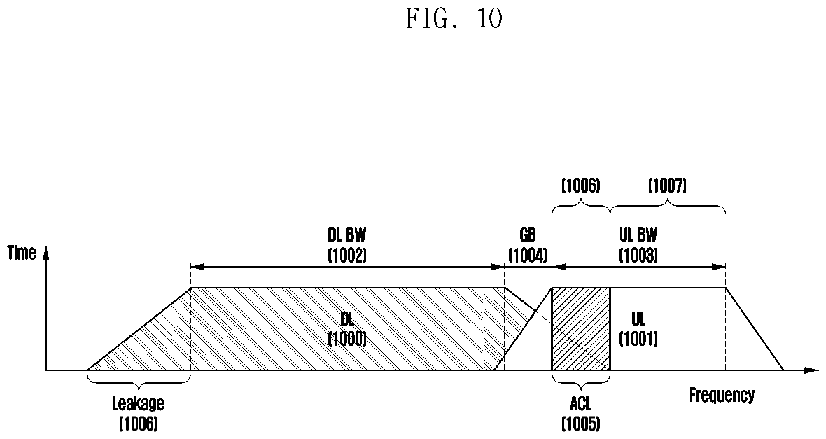

FIG. 10 shows an example of downlink and uplink resource configuration and self-interference in an XDD system according to an embodiment of the disclosure.

With reference to FIG. 10, in the case of XDD, a downlink resource 1000 and an uplink resource 1001 may be distinguished in the frequency domain, and a guard band (GB) 1004 may exist therebetween. Actual downlink transmission may be performed within a downlink bandwidth 1002, and actual uplink transmission may be performed within an uplink bandwidth 1003. At this time, leakage 1006 may occur outside an uplink or downlink transmission band. In a region where the downlink resource 1000 and the uplink resource 1001 are adjacent, interference due to such leakage (this may be referred to as adjacent carrier leakage (ACL) 1005) may occur.

FIG. 10 shows an example in which the ACL 1005 occurs from the downlink 1000 to the uplink 1001. The closer the downlink bandwidth 1002 and the uplink bandwidth 1003 are, the greater the effect of signal interference caused by the ACL 1005 may be, and thus performance may be degraded. For example, as shown in FIG. 10, a partial resource area 1006 within the uplink band 1003 adjacent to the downlink band 1002 may be significantly affected by interference due to the ACL 1005. Another partial resource area 1007 within the uplink band 1003, which is relatively far from the downlink band 1002, may be less affected by interference due to the ACL 1005. That is, within the uplink band 1003, there may be the resource area 1006 relatively much affected by interference and the resource area 1007 relatively less affected by interference.

For the purpose of reducing performance degradation caused by the ACL 1005, the guard band 1004 may be inserted between the downlink bandwidth 1002 and the uplink bandwidth 1003. As the size of the guard band 1004 increases, the effect of interference due to the ACL 1005 between the downlink bandwidth 1002 and the uplink bandwidth 1003 may be advantageously reduced. However, because resources available for transmission and reception decrease as the size of the guard band 1004 increases, resource efficiency may be disadvantageously lowered. Conversely, as the size of the guard band 1004 becomes smaller, the amount of resources that can be utilized for transmission and reception increases and thus resource efficiency may be advantageously high. However, the interference effect due to the ACL 1005 between the downlink bandwidth 1002 and the uplink bandwidth 1003 may be increased disadvantageously. Accordingly, it may be important to determine the appropriate size of the guard band 1004 by considering tradeoffs.
[PUSCH: Related to Transmission Scheme]

Hereinafter, a scheduling scheme of PUSCH transmission will be described. The PUSCH transmission may be dynamically scheduled by UL grant in DCI or operated by configured grant Type 1 or Type 2. Indication of dynamic scheduling for PUSCH transmission are possible in DCI format 0_0 or 0_1.

Configured grant Type 1 PUSCH transmission may be configured semi-statically by receiving configuredGrantConfig including rrc-ConfiguredUplinkGrant of Table 22 through higher signaling without receiving UL grant in DCI. Configured grant Type 2 PUSCH transmission may be scheduled semi-persistently by UL grant in DCI after receiving configuredGrantConfig that does not include rrc-ConfiguredUplinkGrant of Table 22 through higher signaling. When PUSCH transmission operates by a configured grant, parameters applied to PUSCH transmission are applied through configuredGrantConfig, which is higher signaling of Table 22, except for dataScramblingIdentityPUSCH, txConfig, codebookSubset, maxRank, scaling of UCI-OnPUSCH, provided by higher signaling pusch-Config of Table 23. If the UE is provided with transformPrecoder in configuredGrantConfig, which is higher signaling of Table 22, the UE applies tp-pi2BPSK in pusch-Config of Table 23 to PUSCH transmission operated by configured grant.

TABLE 22

| | |
|---|---|
| ConfiguredGrantConfig ::= | SEQUENCE { |
| frequencyHopping | ENUMERATED {intraSlot, interSlot} |

OPTIONAL, -- Need S,

| | |
|---|---|
| cg-DMRS-Configuration | DMRS-UplinkConfig, |
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| uci-OnPUSCH | SetupRelease { CG-UCI-OnPUSCH } |

OPTIONAL, -- Need M

| | |
|---|---|
| resourceAllocation | ENUMERATED { resourceAllocationType0, |

resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTIONAL, -- Need S

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, s3-0000} |

OPTIONAL, -- Need R

| | |
|---|---|
| periodicity | ENUMERATED { |

sym2, sym7, sym1x14, sym2x14, sym4x14, sym5x14, sym8x14, sym10x14,
sym16x14, sym20x14,
sym32x14, sym40x14, sym64x14, sym80x14, sym128x14, sym160x14, sym256x14,
sym320x14, sym512x14,
sym640x14, sym 1024x14, sym 1280x14, sym2560x14, sym5120x14,
sym6, sym1x12, sym2x12, sym4x12, sym5x12, sym8x12, sym10x12, sym16x12,
sym20x12, sym32x12,
sym40x12, sym64x12, sym80x12, sym128x12, sym 160x12, sym256x12,
sym320x12, sym512x12, sym640x12,
sym1280x12, sym2560x12
},

| | |
|---|---|
| configuredGrantTimer | INTEGER (1..64) |

OPTIONAL, -- Need R

| rrc-ConfiguredUplinkGrant | SEQUENCE { | |
|---|---|---|
| timeDomainOffset | INTEGER (0..5119), | |
| timeDomainAllocation | INTEGER (0..15), | |
| frequencyDomainAllocation | BIT STRING (SIZE(18)), | |
| antennaPort | INTEGER (0..31), | |
| dmrs-SeqInitialization | INTEGER (0..1) | OPTIONAL, |

-- Need R

| precodingAndNumberOfLayers | INTEGER (0..63), | |
|---|---|---|
| srs-ResourceIndicator | INTEGER (0..15) | OPTIONAL, |

-- Need R

| | |
|---|---|
| mcsAndTBS | INTEGER (0..31), |
| frequencyHoppingOffset | INTEGER (1.. maxNrofPhysicalResourceBlocks- |
| 1) | OPTIONAL, -- Need R |
| pathlossReferenceIndex | INTEGER (0..maxNrofPUSCH- |

PathlossReferenceRSs-1),

| | |
|---|---|
| ... | OPTIONAL, -- |
| } | |

Need R
...
}

Next, a PUSCH transmission method is described. A DMRS antenna port for PUSCH transmission is the same as an antenna port for SRS transmission. The PUSCH transmission may follow a codebook-based transmission method or a non-codebook-based transmission method depending on whether the value of txConfig in higher signaling pusch-Config of Table 23 is ‘codebook’ or ‘nonCodebook’.

As described above, the PUSCH transmission may be scheduled dynamically through DCI format 0_0 or 0_1, and may be configured semi-statically by configured grant. If the UE receives indication of scheduling for the PUSCH transmission through DCI format 0_0, the UE performs beam configuration for PUSCH transmission by using pucch-spatialRelationInfoID corresponding to a UE-specific PUCCH resource corresponding to the minimum ID within an activated uplink BWP in a serving cell, and in this case, the PUSCH transmission is based on a single antenna port. The UE does not expect scheduling for the PUSCH transmission through DCI format 0_0 within a BWP in which a PUCCH resource including pucch-spatialRelationInfo is not configured. If the UE is not configured with txConfig in pusch-Config of Table 23, the UE does not expect scheduling through DCI format 0_1.

TABLE 23

| | |
|---|---|
| PUSCH-Config ::= | SEQUENCE { |
| dataScramblingIdentityPUSCH | INTEGER (0..1023) |

OPTIONAL, -- Need S

| | |
|---|---|
| txConfig | ENUMERATED {codebook, nonCodebook} |

OPTIONAL, -- Need S

| | |
|---|---|
| dmrs-UplinkForPUSCH-MappingTypeA | SetupRelease { DMRS-UplinkConfig } |

OPTIONAL, -- Need M

| | |
|---|---|
| dmrs-UplinkForPUSCH-MappingTypeB | SetupRelease { DMRS-UplinkConfig } |

OPTIONAL, -- Need M

| | |
|---|---|
| pusch-PowerControl | PUSCH-PowerControl |

OPTIONAL, -- Need M

| | |
|---|---|
| frequencyHopping | ENUMERATED {intraSlot, interSlot} |

OPTIONAL, -- Need S

| | |
|---|---|
| frequencyHoppingOffsetLists | SEQUENCE (SIZE (1..4)) OF INTEGER (1.. |

maxNrofPhysicalResourceBlocks-1)
OPTIONAL, -- Need M

| | |
|---|---|
| resourceAllocation | ENUMERATED { resourceAllocationType0, |

resourceAllocationType1, dynamicSwitch},

| | |
|---|---|
| pusch-TimeDomainAllocationList | SetupRelease { PUSCH- |
| TimeDomainResourceAllocationList } | OPTIONAL, -- Need M |
| pusch-AggregationFactor | ENUMERATED { n2, n4, n8 } |

OPTIONAL, -- Need S

| | |
|---|---|
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| transformPrecoder | ENUMERATED {enabled, disabled} |

OPTIONAL, -- Need S

| | |
|---|---|
| codebookSubset | ENUMERATED {fullyAndPartialAndNonCoherent, |

partialAndNonCoherent, nonCoherent}
OPTIONAL, -- Cond codebookBased

| | | |
|---|---|---|
| maxRank | INTEGER (1..4) | OPTIONAL, |

-- Cond codebookBased

| | | |
|---|---|---|
| rbg-Size | ENUMERATED { config2} | OPTIONAL, |

-- Need S

| | |
|---|---|
| uci-OnPUSCH | SetupRelease { UCI-OnPUSCH} |

OPTIONAL, -- Need M

| | | |
|---|---|---|
| tp-pi2BPSK | ENUMERATED {enabled} | OPTIONAL, |

-- Need S
...
}

Next, codebook-based PUSCH transmission is described. The codebook-based PUSCH transmission may be scheduled dynamically through DCI format 0_0 or 0_1 and may operate semi-statically by configured grant. If the codebook-based PUSCH is scheduled dynamically by DCI format 0_1 or configured semi-statically by configured grant, the UE determines a precoder for PUSCH transmission based on an SRS resource indicator (SRI), a transmission precoding matrix indicator (TPMI), and a transmission rank (the number of PUSCH transmission layers).

In this case, the SRI may be given through a field, SRS resource indicator, in DCI or configured through higher signaling, srs-ResourceIndicator. In the codebook-based PUSCH transmission, the UE is configured with at least one SRS resource and may be configured with up to two. When the UE is provided with the SRI through DCI, the SRS resource indicated by the SRI refers to an SRS resource corresponding to the SRI among SRS resources transmitted before PDCCH containing the SRI. Also, the TPMI and the transmission rank may be given through a field, precoding information and number of layers, in DCI or configured through higher signaling, precodingAndNumberOfLayers. The TPMI is used to indicate the precoder applied to the PUSCH transmission. If the UE is configured with one SRS resource, the TPMI is used to indicate the precoder to be applied in one configured SRS resource. If the UE is configured with multiple SRS resources, the TPMI is used to indicate the precoder to be applied in the SRS resource indicated through the SRI.

The precoder to be used for the PUSCH transmission is selected from an uplink codebook having the number of antenna ports equal to the value of nrofSRS-Ports in SRS-Config, which is higher signaling. In the codebook-based PUSCH transmission, the UE determines a codebook subset based on the TPMI and higher signaling, codebookSubset in pusch-Config. The codebookSubset in pusch-Config may be configured as one of ‘fully AndPartialAndNonCoherent’, ‘partialAndNonCoherent’, or ‘nonCoherent’ based on the UE capability reported by the UE to the base station. If the UE reports ‘partialAndNonCoherent’ as the UE capability, the UE does not expect the value of codebookSubset, which is higher signaling, to be configured as ‘fully AndPartialAndNonCoherent’. Also, if the UE reports ‘nonCoherent’ as the UE capability, the UE does not expect the value of codebookSubset, which is higher signaling, to be configured as ‘fully AndPartialAndNonCoherent’ or ‘partialAndNonCoherent’. If higher signaling, nrofSRS-Ports in SRS-ResourceSet, indicates two SRS antenna ports, the UE does not expect the value of codebookSubset, which is higher signaling, to be configured as ‘partialAndNonCoherent’.

The UE may be configured with one SRS resource set in which the value of usage in higher signaling SRS-ResourceSet is configured as ‘codebook’, and one SRS resource within the SRS resource set may be indicated through the SRI. If multiple SRS resources are configured in the SRS resource set where the usage value in higher signaling SRS-ResourceSet is configured as ‘codebook’, the UE expects that the value of nrofSRS-Ports in higher signaling SRS-ResourceSet is configured as the same value for all SRS resources.

The UE transmits to the base station one or multiple SRS resources included in the SRS resource set in which the usage value is configured as ‘codebook’ according to higher signaling, and the base station selects one of the SRS resources transmitted by the UE and instructs the UE to perform PUSCH transmission using the transmission beam information of the selected SRS resource. In this case, in the codebook-based PUSCH transmission, the SRI is used as information to select the index of one SRS resource and is contained in DCI. Additionally, the base station includes, in the DCI, information indicating the TPMI and rank to be used by the UE for PUSCH transmission. Using the SRS resource indicated by the SRI, the UE performs PUSCH transmission by applying the precoder indicated by the TPMI and rank indicated based on the transmission beam of the SRS resource.

Next, the non-codebook-based PUSCH transmission is described. The non-codebook-based PUSCH transmission may be scheduled dynamically through DCI format 0_0 or 0_1 and may operate semi-statically by configured grant. If at least one SRS resource is configured in the SRS resource set where the value of usage in higher signaling SRS-ResourceSet is configured as ‘nonCodebook’, the UE may receive scheduling of the non-codebook-based PUSCH transmission through DCI format 0_1. For an SRS resource set in which the usage value in higher signaling SRS-ResourceSet is configured as ‘nonCodebook’, the UE may be configured with one connected non-zero power (NZP) CSI-RS resource. The UE may perform calculations on the precoder for SRS transmission through measurement of the NZP CSI-RS resource connected to the SRS resource set. If the difference between the last received symbol of the aperiodic NZP CSI-RS resource connected to the SRS resource set and the first symbol of the aperiodic SRS transmission from the UE is less than 42 symbols, the UE does not expect that information about the precoder for SRS transmission will be updated.

If the value of resourceType in SRS-ResourceSet, which is higher signaling, is configured as ‘aperiodic’, the connected NZP CSI-RS is indicated by SRS request, which is a field in DCI format 0_1 or 1_ 1. In this case, if the connected NZP CSI-RS resource is an aperiodic NZP CSI-RS resource, it indicates that the connected NZP CSI-RS exists for the case where the value of the field SRS request in DCI format 0_1 or 1_1 is not ‘00’. At this time, the corresponding DCI should not indicate cross carrier or cross BWP scheduling. Additionally, if the value of the SRS request indicates the existence of the NZP CSI-RS, the NZP CSI-RS is located in a slot where PDCCH including the SRS request field is transmitted. In this case, TCI states configured in the scheduled subcarrier are not configured as QCL-TypeD.

If a periodic or semi-persistent SRS resource set is configured, the connected NZP CSI-RS may be indicated through associatedCSI-RS in higher signaling SRS-ResourceSet. For the non-codebook-based transmission, the UE does not expect that spatialRelationInfo, higher signaling for the SRS resource, and associatedCSI-RS in higher signaling SRS-ResourceSet will be configured together.

When configured with a plurality of SRS resources, the UE may determine the precoder and transmission rank to be applied to PUSCH transmission, based on the SRI indicated by the base station. In this case, the SRI may be indicated through a field, SRS resource indicator, in DCI or configured through higher signaling, srs-ResourceIndicator. Similar to the codebook-based PUSCH transmission described above, when the UE is provided with the SRI through DCI, the SRS resource indicated by the SRI refers to an SRS resource corresponding to the SRI among SRS resources transmitted before PDCCH containing the SRI. The UE may use one or multiple SRS resources for SRS transmission, and the maximum number of SRS resources that allow simultaneous transmission in the same symbol within one SRS resource set is determined by the UE capability reported by the UE to the base station. In this case, the SRS resources simultaneously transmitted by the UE occupy the same RB. The UE configures one SRS port for each SRS resource. The SRS resource set in which the usage value in higher signaling SRS-ResourceSet is configured as ‘nonCodebook’ may be configured as only one, and the SRS resources for the non-codebook-based PUSCH transmission may be configured up to four.

The base station transmits one NZP-CSI-RS connected to the SRS resource set to the UE, and the UE calculates the precoder to be used when transmitting one or more SRS resources in the SRS resource set, based on the result measured when receiving the NZP-CSI-RS. The UE applies the calculated precoder when transmitting to the base station one or more SRS resources in the SRS resource set in which usage is configured as ‘nonCodebook’, and the base station selects one or more SRS resources among the received one or more SRS resources. Here, in the non-codebook-based PUSCH transmission, the SRI represents an index that can express a combination of one or multiple SRS resources, and the SRI is contained in DCI. Also, the number of SRS resources indicated by the SRI transmitted by the base station may be the number of transmission layers of PUSCH, and the UE transmits the PUSCH by applying the precoder, applied to SRS resource transmission, to each layer.

### PUSCH: Preparation Procedure Time

Hereinafter, a PUSCH preparation procedure time will be described. In the case where the base station schedules the UE to transmit PUSCH using DCI format 0_0 or DCI format 0_1, the UE may need the PUSCH preparation procedure time to transmit PUSCH by applying a transmission method (a transmission precoding method of SRS resource, the number of transmission layers, and a spatial domain transmission filter) indicated through DCI. Considering this, the NR has defined the PUSCH preparation procedure time. The PUSCH preparation procedure time of the UE may follow Equation 2 below.

$${T}_{proc , 2} = max ( ( {N}_{2} + {d}_{2 , 1} + {d}_{2} ) ( 2048 + 144 ) {κ2}^{- µ} {T}_{c} + {T}_{ext} + {T}_{switch} , {d}_{2 , 2} ) \qquad Equation 2$$

In T_{proc,2} above, each variable may have the following meaning.
N₂: It is the number of symbols determined depending on UE processing capability 1 or 2 based on the capability of the UE and numerology μ. If the UE processing capability 1 is reported via UE's capability report, it may have the value in Table 24. If the UE processing capability 2 is reported and it is configured through higher signaling that the UE processing capability 2 can be used, it may have the value in Table 25.

TABLE 24

| | PUSCH preparation time N₂ |
|---|---|
| μ | [symbols] |
| 0 | 10 |
| 1 | 12 |
| 2 | 23 |
| 3 | 36 |

TABLE 25

| | PUSCH preparation time N₂ |
|---|---|
| μ | [symbols] |
| 0 | 5 |
| 1 | 5.5 |
| 2 | 11 for frequency range 1 |

d_{2,1}: It is the number of symbols configured as 0 if all resource elements of the first OFDM symbol in PUSCH transmission are configured to consist of DM-RS only, otherwise, as 1.
k: 64
μ: It follows the value that makes T_{proc,2} larger from among μ_{DL} and μ_{UL}. Here, μ_{DL} refers to the numerology of downlink where PDCCH containing DCI for scheduling PUSCH is transmitted, and μ_{UL} refers to the numerology of uplink where PUSCH is transmitted.
T_{c}: It has 1/(Δfₘₐₓ·N_{f}), Δfₘₐₓ=480·103 Hz, N_{f}=4096.
d_{2,2}: It follows a BWP switching time if DCI for scheduling PUSCH indicates BWP switching. Otherwise, it has 0.
d₂: If OFDM symbols of PUSCH with a high priority index and PUCCH with a low priority index overlap in time, the d₂ value of the PUSCH with a high priority index is used. Otherwise, d₂ is 0.
Tₑₓₜ: If the UE uses a shared spectrum channel access scheme, the UE may calculate Tₑₓₜ and apply it to the PUSCH preparation procedure time. Otherwise, Tₑₓₜ is assumed to be 0.
T_{switch}: If an uplink switching interval is triggered, T_{switch} is assumed to be a switching interval time. Otherwise, it is assumed to be 0.

Considering the time domain resource mapping information of PUSCH scheduled through DCI and the effect of timing advance (TA) between uplink and downlink, the base station and the UE determine that the PUSCH preparation procedure time is not sufficient when the first symbol of the PUSCH starts earlier than the first uplink symbol where CP starts after T_{proc,2} from the last symbol of PDCCH containing the DCI that schedules the PUSCH. Otherwise, the base station and the UE determine that the PUSCH preparation procedure time is sufficient. The UE may transmit the PUSCH only when the PUSCH preparation procedure time is sufficient, and may ignore the DCI that schedules the PUSCH when the PUSCH preparation procedure time is not sufficient.

Hereinafter, PUSCH repetition will be described. If the UE is configured with higher signaling, pusch-AggregationFactor, when PUSCH transmission is scheduled with DCI format 0_1 in PDCCH containing a CRC scrambled by C-RNTI, MCS-C-RNTI, or CS-RNTI, the same symbol allocation is applied in as many consecutive slots as pusch-AggregationFactor, and the PUSCH transmission is limited to single rank transmission. For example, the UE should repeat the same TB in as many consecutive slots as pusch-AggregationFactor, and apply the same symbol allocation to each slot. Table 26 shows the redundancy version applied to PUSCH repetition per slot. If the UE is scheduled with PUSCH repetition in a plurality of slots via DCI format 0_1, and if at least one of slots in which PUSCH repetition is performed is indicated as a downlink symbol according to information of higher signaling, tdd-UL-DL-ConfigurationCommon or tdd-UL-DL-ConfigurationDedicated, the UE does not perform PUSCH transmission in a slot where the symbol is located.

TABLE 26

| rv_{id} indicated by the | rv_{id} to be applied to n^{th} transmission occasion | | | |
|---|---|---|---|---|
| DCI scheduling the | n mod | n mod | n mod | n mod |
| PUSCH | 4 = 0 | 4 = 1 | 4 = 2 | 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

### PUSCH: Related to Repetition

Hereinafter, repetition (repeated transmission) of an uplink data channel in the 5G system will be described in detail. The 5G system supports two types of repetition methods for an uplink data channel: PUSCH repetition type A and PUSCH repetition type B. The UE may be configured with either PUSCH repetition type A or B through higher layer signaling.

### PUSCH Repetition Type A

As described above, the symbol length and start symbol position of the uplink data channel are determined by the time domain resource allocation method within one slot, and the base station may notify the number of repetitions to the UE through higher layer signaling (e.g., RRC signaling) or L1 signaling (e.g., DCI).

The UE may repeatedly transmit, in consecutive slots, the uplink data channel with the same symbol length and start symbol configured based on the number of repetitions received from the base station. In this case, if at least one symbol in symbols of the uplink data channel configured for the UE or a slot configured for the UE by the base station is configured as downlink, the UE skips uplink data channel transmission, but it counts the number of repetitions of the uplink data channel. That is, the uplink data channel may not be transmitted even though it is included in the number of repetitions of the uplink data channel.

On the other hand, the UE that supports Rel-17 uplink data repetition may determine a slot capable of uplink data repetitions to be an available slot and count the number of transmissions during the uplink data channel repetition in the available slot. In the case where the uplink data channel repetition is skipped in any slot determined as the available slot, the corresponding transmission may be postponed and then repeated through a slot allowing transmission.

For determining the available slot, if at least one symbol configured with time domain resource allocation (TDRA) for PUSCH in a slot for PUSCH transmission is overlapped with a symbol (e.g., downlink) for a purpose other than uplink transmission, that slot may be determined as an unavailable slot (e.g., a slot that is not the available slot and is determined to be unavailable for PUSCH transmission). In addition, the available slot may be considered as an uplink resource for determining a transport block size (TBS) and a resource for PUSCH transmission in the PUSCH repetition and multi-slot PUSCH transmission consisting of one TB (transport block on multiple slots (TBoMS)).

### PUSCH Repetition Type B

As described above, the start symbol and length of the uplink data channel are determined by the time domain resource allocation method within one slot, and the base station may notify the number of repetitions, numberofrepetitions, to the UE through higher layer signaling (e.g., RRC signaling) or L1 signaling (e.g., DCI).

Based on the configured start symbol and length of the uplink data channel, the nominal repetition of the uplink data channel is determined as follows. The slot at which the n^{th} nominal repetition starts is given by

$${K}_{s} + ⌊ \frac{S + n \cdot L}{{N}_{symb}^{slot}} ⌋ ,$$

and the symbol starting in that slot is given by mod (S+n·L, N_{symb}^{slot}). The slot at which the n^{th} nominal repetition ends is given by

$${K}_{s} + ⌊ \frac{S + ( n + 1 ) \cdot L - 1}{{N}_{symb}^{slot}} ⌋ ,$$

and the symbol ending in that slot is given by mod (S+(n+1)·L−1, N_{symb}^{slot}). Here, n is 0, . . . , numberofprepetitions−1. Also, S represents the configured start symbol of the uplink data channel, and L represents the configured symbol length of the uplink data channel. In addition, Kₛ represents the slot where PUSCH transmission starts and represents the number of symbols per N slot slot.

For the PUSCH repetition type B, the UE may determine a specific OFDM symbol as an invalid symbol in the following cases:

1. A symbol configured for downlink by tdd-UL-DL-ConfigurationCommon or tdd-UL-DL-ConfigurationDedicated may be determined as an invalid symbol for the PUSCH repetition type B.

2. Symbols indicated by ssb-PositionsInBurst in SIB₁ or ssb-PositionsInBurst in ServingCellConfigCommon, which is higher layer signaling, for SSB reception in the unpaired spectrum (TDD spectrum) may be determined as invalid symbols for the PUSCH repetition type B.

3. Symbols indicated through pdcch-ConfigSIBI in MIB to transmit a control resource set connected to a Type0-PDCCH CSS set in the unpaired spectrum (TDD spectrum) may be determined as invalid symbols for the PUSCH repetition type B.

4. If higher layer signaling numberOfInvalidSymbolsForDL-UL-Switching is configured in the unpaired spectrum (TDD spectrum), as many symbols as numberOfInvalidSymbolsForDL-UL-Switching from symbols configured for downlink by tdd-UL-DL-ConfigurationCommon or tdd-UL-DL-ConfigurationDedicated may be determined as invalid symbols.

Additionally, the invalid symbol may be configured in a certain higher layer parameter (e.g., InvalidSymbolPattern). This higher layer parameter (e.g., InvalidSymbolPattern) may provide a symbol-level bitmap spanning one or two slots to configure the invalid symbol. In the bitmap, ‘1’ represents the invalid symbol. Further, the periodicity and pattern of the bitmap may be configured through a higher layer parameter (e.g., periodicityAndPattern). If a certain higher layer parameter (e.g., InvalidSymbolPattern) is configured and the InvalidSymbolPatternIndicator-ForDCIFormat0_1 or InvalidSymbolPatternIndicator-ForDCIFormat0_2 parameter indicates ‘1’, the UE applies an invalid symbol pattern, and if the above parameter indicates ‘0’, the UE does not apply the invalid symbol pattern. If a certain higher layer parameter (e.g., InvalidSymbolPattern) is configured and the InvalidSymbolPatternIndicator-ForDCIFormat0_1 or InvalidSymbolPatternIndicator-ForDCIFormat0_2 parameter is not configured, the UE applies the invalid symbol pattern.

After the invalid symbol is determined, for each nominal repetition, the UE may consider symbols other than the invalid symbol as valid symbols. If one or more valid symbols are included in each nominal repetition, the nominal repetition may contain one or more actual repetitions. Here, each actual repetition contains a set of consecutive valid symbols that can be used for the PUSCH repetition type B within one slot. If the OFDM symbol length of the nominal repetition is not 1, and the length of the actual repetition becomes 1, the UE may ignore transmission for the actual repetition.

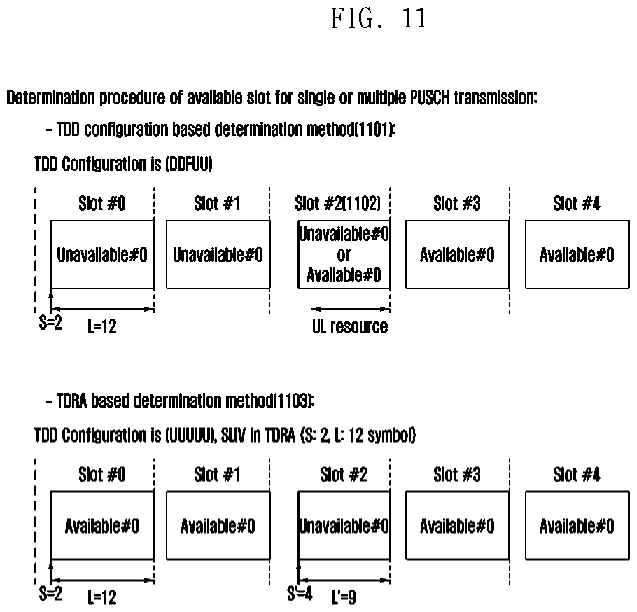

FIG. 11 illustrates a method for determining an available slot in a wireless communication system according to an embodiment of the disclosure.

When the base station configures uplink resources through higher layer signaling (e.g., tdd-UL-DL-ConfigurationCommon or tdd-UL-DL-ConfigurationDedicated) or L1 signaling (e.g., dynamic slot format indicator), the base station and the UE may determine, for the configured uplink resources, the available slot through 1) an available slot determination method based on TDD configuration or 2) an available slot determination method considering TDD configuration and time domain resource allocation (TDRA), configured grant (CG) configuration or activation DCI.

With reference to FIG. 11, in an example 1101 of the method for determining available slots based on TDD configuration, if the TDD configuration is configured as ‘DDFUU’ through higher layer signaling, the base station and the UE may determine slot #3 and slot #4 configured to be uplink ‘U’ in the TDD configuration as available slots. In this case, slot #2 (1102), which is configured to be flexible slot ‘F’ in the TDD configuration, may be determined as an unavailable slot or an available slot, which may be predefined through base station's configuration, for example.

With reference to FIG. 11, in an example 1103 of the method for determining available slots considering TDD configuration and TDRA, CG configuration or activation DCI, if the TDD configuration is configured as ‘UUUUU’ through higher layer signaling, and the start and length indicator value (SLIV) of PUSCH transmission is configured as {S: 2, L: 12 symbol} through L1 signaling, the base station and the UE may determine, for the configured uplink slots ‘U’, slot #0, slot #1, slot #3, and slot #4 that satisfy the SLIV of PUSCH as available slots. In this case, the base station and the UE may determine slot #2 (′L=9′≤SLIV ‘L=12’) failing to satisfy the SLIV, which is the TDRA condition for PUSCH transmission, as an unavailable slot. This is exemplary only and is not limited to PUSCH transmission. It may also be applied to PUCCH transmission, PUSCH/PUCCH repetition, nominal repetition of PUSCH repetition type B, and TBoMS.

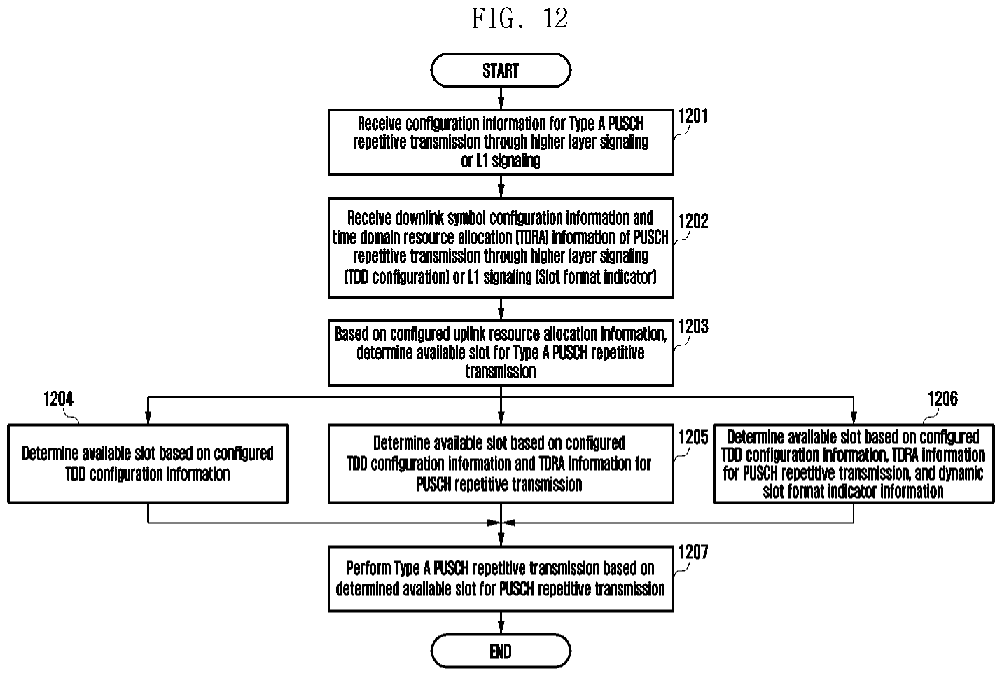

FIG. 12 is a flowchart illustrating the operation of a terminal for transmission of PUSCH repetition type A in a wireless communication system according to an embodiment of the disclosure.

With reference to FIG. 12, at 1201, the UE may receive configuration information for transmission of PUSCH repetition type A from the base station through higher layer signaling or L1 signaling.

At 1202, the UE may receive downlink symbol configuration information and time domain resource allocation (TDRA) information of PUSCH repetition through higher layer signaling (e.g., TDD configuration; tdd-UL-DL-ConfigurationCommon or tdd-UL-DL-ConfigurationDedicated) or L1 signaling (e.g., Slot format indicator).

Then, at 1203, based on the uplink resource allocation information configured from the base station, the UE may determine an available slot for transmission of PUSCH repetition type A. At this time, the UE may determine the available slot by using any one or a combination of three methods 1204, 1205, and 1206. In the first method 1204, the UE may determine only a slot configured to be uplink as the available slot based on the configured TDD configuration information. In the second method 1205, the UE may determine the available slot by considering the configured TDD configuration information, TDRA information for PUSCH transmission, CG-configuration, and activation DCI. In the third method 1206, the UE may determine the available slot based on the configured TDD configuration information, TDRA information for PUSCH transmission, CG-configuration, activation DCI information, and dynamic slot format indicator (SFI). The method used to determine the available slot may be predefined/promised between the base station and the UE or may be configured and indicated semi-statically or dynamically through signaling between the base station and the UE.

Thereafter, at 1207, the UE may perform transmission of PUSCH repetition type A to the base station through the determined available slot.

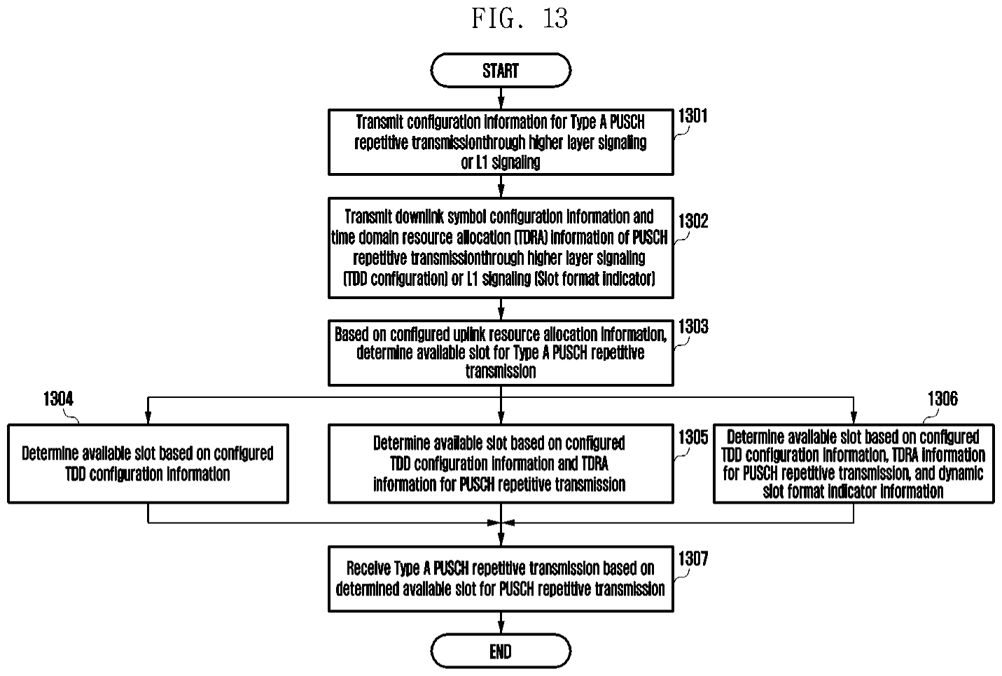

FIG. 13 is a flowchart illustrating the operation of a base station for transmission of PUSCH repetition type A in a wireless communication system according to an embodiment of the disclosure.

With reference to FIG. 13, at 1301, the base station may transmit configuration information for transmission of PUSCH repetition type A to the UE through higher layer signaling or L1 signaling.

At 1302, the base station may configure and transmit downlink symbol configuration information and time domain resource allocation (TDRA) information of PUSCH repetition through higher layer signaling (e.g., TDD configuration; tdd-UL-DL-ConfigurationCommon or tdd-UL-DL-ConfigurationDedicated) or L1 signaling (e.g., Slot format indicator).

Then, at 1303, based on the uplink resource allocation information configured to the UE, the base station may determine an available slot for transmission of PUSCH repetition type A. At this time, the base station may determine the available slot by using any one or a combination of three methods 1304, 1305, and 1306. In the first method 1304, the base station may determine only a slot configured to be uplink as the available slot based on the configured TDD configuration information. In the second method 1305, the base station may determine the available slot by considering the configured TDD configuration information, TDRA information for PUSCH transmission, CG-configuration, and activation DCI. In the third method 1306, the base station may determine the available slot based on the configured TDD configuration information, TDRA information for PUSCH transmission, CG-configuration, activation DCI information, and dynamic slot format indicator (SFI). The method used to determine the available slot may be predefined/promised between the base station and the UE or may be configured and indicated semi-statically or dynamically through signaling between the base station and the UE.

Thereafter, at 1307, the base station may receive transmission of PUSCH repetition type A from the UE through the determined available slot.

FIGS. 12 and 13 are exemplary only, are not limited to PUSCH transmission, and can also be applied to PUCCH transmission, PUSCH/PUCCH repetition, nominal repetition of PUSCH repetition type B, and TBoMS.

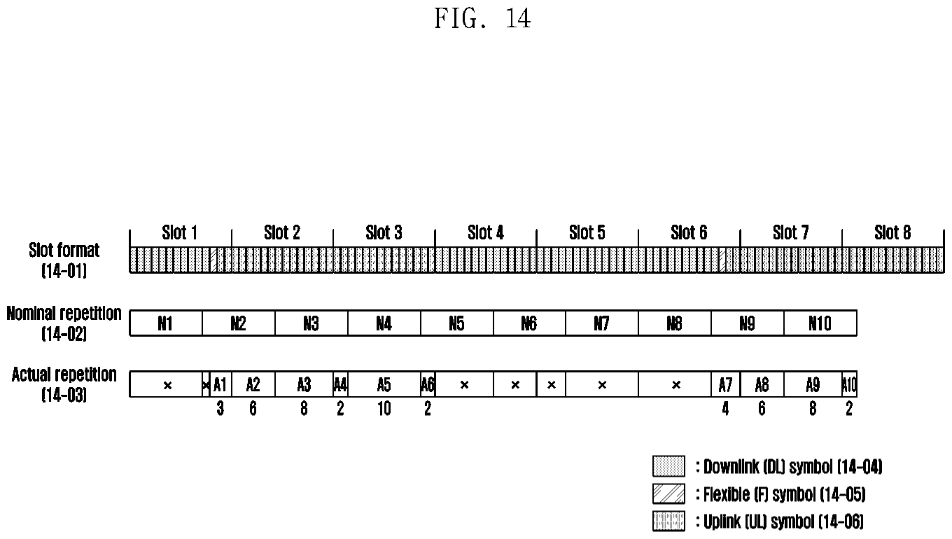

FIG. 14 illustrates an example of PUSCH repetition type B according to an embodiment of the disclosure.

With reference to FIG. 14, the slot may include a downlink symbol 14-04, a flexible symbol 14-05, or an uplink symbol 14-06.

FIG. 14 shows an example in which for nominal repetition 14-02, the UE is configured with a transmission start symbol S as 0, a transmission symbol length L as 10, and the number of repetitions as 10, which are expressed as N1 to N10. In this case, the UE may determine an invalid symbol in consideration of a slot format 14-01 to determine actual repetition 14-03, which can be expressed as A1 to A10 in FIG. 14. According to the above-described method for determining the invalid symbol and the actual repetition, PUSCH repetition type B is not transmitted in symbols determined to be downlink (DL) in the slot format, and if a slot boundary exists within the nominal repetition, the actual repetition is divided into two based on the slot boundary. For example, A1 that means the first actual repetition may consist of 3 OFDM symbols, and A2 transmitted next may consist of 6 OFDM symbols.

In addition, for PUSCH repetition, NR Release 16 may define the following additional methods for UL grant-based PUSCH transmission and configured grant-based PUSCH transmission across slot boundaries.
Method 1 (mini-slot level repetition): Through one UL grant, two or more PUSCH repetitions may be scheduled within one slot or across the boundaries of consecutive slots. Additionally, in Method 1, the time domain resource allocation information in DCI may indicate the resource of the first repetition. Also, based on the time domain resource information for the first repetition and the uplink or downlink direction determined for each symbol of each slot, the time domain resource information for the remaining repetitions may be determined. Each repetition may occupy consecutive symbols.
Method 2 (multi-segment transmission): Through one UL grant, two or more PUSCH repetitions may be scheduled in consecutive slots. In this case, one transmission is designated for each slot, and the respective transmissions may be different in a starting point or a repetition length. Additionally, in Method 2, time domain resource allocation information in DCI may indicate the starting point and repetition length of all repetitions. In the case where repetition is performed within a single slot through Method 2, if there are multiple bundles of consecutive uplink symbols within the slot, each repetition may be performed for each bundle of uplink symbols. If there is a unique (i.e., one) bundle of consecutive uplink symbols in the slot, one PUSCH repetition may be performed according to the method of NR Release 15.
Method 3: Through two or more UL grants, two or more PUSCH repetitions may be scheduled in consecutive slots. In this case, one transmission is designated for each slot, and the n^{th} UL grant may be received before the PUSCH transmission scheduled by the (n−1)^{th} UL grant ends.
Method 4: Through one UL grant or one configured grant, one or multiple PUSCH repetitions within a single slot, or two or more PUSCH repetitions across the boundaries of consecutive slots may be supported. The base station may indicate the number of repetitions to the UE, but the number of PUSCH repetitions actually performed by the UE may be greater than the number of repetitions indicated by the base station to the UE. The time domain resource allocation information within DCI or configured grant may refer to the resource of the first repetition indicated by the base station. The time domain resource information of the remaining repetitions may be determined by referring to at least the resource information of the first repetition and the uplink or downlink direction of the symbols. If the time domain resource information of the repetition indicated by the base station spans a slot boundary or includes an uplink/downlink switching point, the corresponding repetition may be divided into a plurality of repetitions. In this case, one repetition may be included for each uplink interval within one slot.

Meanwhile, in Rel-17, in order to enhance the coverage of PUSCH transmission, the number of repetitions of PUSCH repetition type A may be possible up to 32. In addition, the function has been improved such that, if the PUSCH is not transmitted in a slot configured or indicated as downlink via higher layer signaling, etc. using the above-mentioned concept of the available slot, or if the PUSCH is not transmitted based on the priority between uplink transmission channels, the number of repetitions is not counted and the PUSCH repetitions can be attempted until the indicated number of repetitions is reached. Therefore, the coverage of PUSCH transmission can be enhanced because the PUSCH transmission is performed as many times as the configured or indicated number of repetitions without counting the number of transmissions in resources where PUSCH repetition is not possible. However, because it is required to consistently apply the TPMI notified to the UE at the base station's scheduling point to all PUSCH repetitions regardless of whether a channel changes over time from the base station's scheduling point for the PUSCH repetitions, and also fill the number of PUSCH repetitions, the performance of the corresponding TPMI may deteriorate as time passes from the base station's scheduling point.

To overcome this problem, the disclosure proposes a method that allows the UE to use a plurality of uplink precoders during PUSCH transmission or repetition. Specifically, the UE may perform the PUSCH transmission or repetition by using one precoder notified from the base station, and may further use another uplink precoder additionally notified from the base station under certain conditions (e.g., the case where a certain time has passed from the base station's scheduling point, etc.) and/or according to certain higher layer signaling, or determine and further use another uplink precoder without explicit notification from the base station. Related various methods will be described in detail.

Hereinafter, higher layer signaling may be signaling corresponding to at least one or any combination of the following signalings.
MIB (Master Information Block)
SIB (System Information Block) or SIB X (X=1, 2, . . . )
RRC (Radio Resource Control)
MAC (Medium Access Control) CE (Control Element)
UE Capability Reporting
UE assistance information or message

In addition, L1 signaling may be signaling corresponding to at least one or any combination of the following physical layer channels or signaling methods.
PDCCH (Physical Downlink Control Channel)
DCI (Downlink Control Information)
UE-specific DCI
Group common DCI
Common DCI
Scheduling DCI (e.g., DCI used for the purpose of scheduling downlink or uplink data)
Non-scheduled DCI (e.g., DCI not for the purpose of scheduling downlink or uplink data)
PUCCH (Physical Uplink Control Channel)
UCI (Uplink Control Information)

### First Embodiment: Method for Performing Simultaneous Channel Estimation in PUSCH Transmission

As an embodiment of the disclosure, a method for performing simultaneous channel estimation during PUSCH transmission is described.

The UE may be configured with a time interval for simultaneous channel estimation from the base station. For example, the configured time interval for simultaneous channel estimation may be called a configured time domain window (C-TDW). This term is, however, exemplary only and does not limit the technical scope of the disclosure. The UE may be configured with the length of the C-TDW (e.g., a specific number of consecutive slots) in the time domain from the base station as a higher layer parameter related to the C-TDW. Here, the length of the C-TDW in the time domain may be configured per bandwidth part, cell, or numerology.

Based on the length of the C-TDW in the time domain configured from the base station, the UE may determine the time at which one or more C-TDWs are applied for simultaneous channel estimation for PUSCH repetitive transmission scheduled from the base station through the following criteria.

The start time of the first C-TDW may be determined as follows.

In one example, the UE may determine the start time of the slot for performing the first PUSCH repetitive transmission among scheduled PUSCH repetitive transmissions as the start time of the first C-TDW.

In another example, the UE may determine the start time of the first available slot determined to perform scheduled PUSCH repetitive transmission as the start time of the first C-TDW. As described above, even if a certain slot is determined to be an available slot, PUSCH repetitive transmission may not be performed in that slot.

From the start time of the first C-TDW, the UE may expect that the first C-TDW will be defined as long as the time domain length of the C-TDW configured via higher layer signaling.

The start time for at least one C-TDW that may appear after the first C-TDW may be determined as follows.

The start time for at least one C-TDW that may appear after the first C-TDW may be implicitly determined in advance before the first PUSCH repetitive transmission.

In one example, in paired spectrum (FDD) or SUL (supplementaryUplink), at least one C-TDW may be defined consecutively after the first C-TDW, and the start time of each C-TDW may be the same as the end time of the C-TDW defined immediately before.

In another example, in unpaired spectrum (TDD), after the first C-TDW, the UE may determine the start time of the next C-TDW by considering the DL/UL configuration information configured via higher layer signaling. For example, if the duplex direction of a slot that appears immediately after the end of the first C-TDW is configured to DL through higher layer signaling, and the next slot is configured to UL, the UE may skip the DL slot and determine the start time of the next UL slot as the start time of the second C-TDW. That is, the UE may determine the start time of a slot, configured to the first UL slot after the end of the first C-TDW, as the start time of the second C-TDW.

The end time of the last C-TDW may be determined as follows.

In one example, the end time of the last C-TDW may be determined as the end point of a slot in which the last PUSCH repetitive transmissionis performed.

In another example, the UE may determine the end point of the available slot determined to perform the last scheduled PUSCH repetitive transmission as the start time of the last C-TDW. As described above, even if a certain slot is determined to be an available slot, PUSCH repetitive transmission may not be performed in that slot.

Once the starting point and section of at least one C-TDW for a certain PUSCH repetitive transmission are determined as described above, the UE may determine at least one actual time domain window (A-TDW) within each C-TDW. The UE may expect that the base station will perform simultaneous channel estimation for PUSCH repetitive transmission in A-TDW units. That is, the UE may expect that the base station will simultaneously estimate a channel by bundling the DMRS contained in one or more PUSCH repetitive transmissions in the A-TDW. The following criteria may be considered for determining the A-TDW.

The start time of the first A-TDW may be determined as follows.

In one example, the UE may determine the start time of the slot for performing the first PUSCH repetitive transmission among PUSCH repetitive transmissions in a specific C-TDW as the start time of the first A-TDW.

In another example, the UE may determine the start time of the first available slot determined to perform PUSCH repetitive transmission within a specific C-TDW as the start time of the first A-TDW. As described above, even if a certain slot is determined to be an available slot, PUSCH repetitive transmission may not be performed in that slot.

After the first A-TDW starts, the UE may expect that transmission power consistency and phase continuity will be maintained until at least one of the following conditions is satisfied. When at least one of the following conditions is satisfied, it may be understood that the A-TDW is terminated.
In one example, when the A-TDW reaches the slot in which the last PUSCH repetitive transmission within the C-TDW is performed,
In another example, when the A-TDW reaches the last available slot within the C-TDW, or
In yet another example, when a situation occurs in which transmission power consistency and phase continuity are not maintained (This situation may include a situation where a DL slot exists based on DL/UL slot format configuration in an unpaired spectrum, a situation where the maximum length of A-TDW is reached, a high priority transmission situation, or a situation where frequency hopping is performed, etc.)

After the first A-TDW starts within a certain C-TDW as described above, a situation may occur in which transmission power consistency and phase continuity are not maintained, and thus the A-TDW may be terminated. Whether the UE can create a new A-TDW after the termination of the first A-TDW may be determined through UE capability reporting.

If the UE can create the new A-TDW, the starting point of the new A-TDW may be based on the first available slot after a situation occurs in which transmission power consistency and phase continuity are not maintained, or based on the slot in which the first PUSCH repetitive transmission is performed.

If the UE cannot create the new A-TDW, the UE may expect that no new A-TDW will exist until the point where the C-TDW ends. Also, the UE may expect that the base station will not perform simultaneous channel estimation for decoding of each PUSCH repetitive transmission transmitted up to the point where the corresponding C-TDW ends.

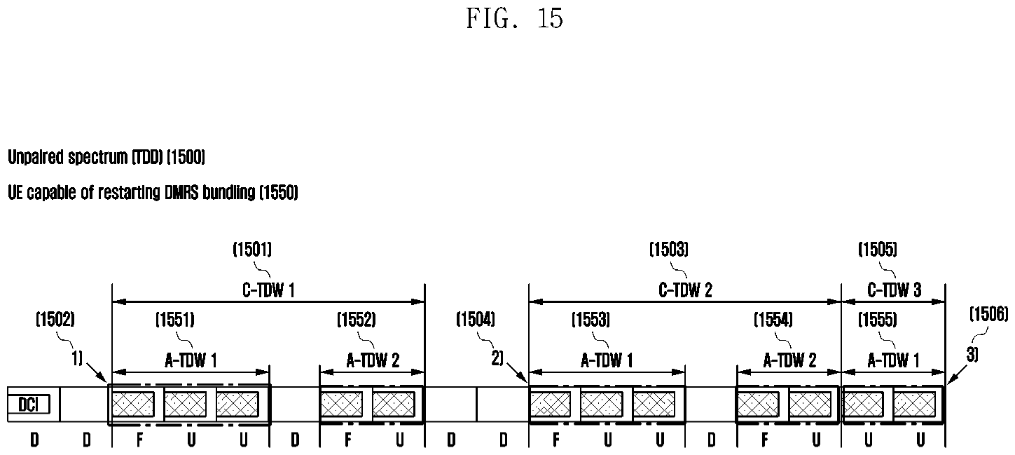

FIG. 15 is a diagram illustrating a method for determining C-TDW and A-TDW for performing simultaneous channel estimation when transmitting a PUSCH in a wireless communication system according to an embodiment of the disclosure.

In FIG. 15, it can be assumed that the UE has been configured with 6 slots as the length of C-TDW from the base station. With reference to FIG. 15, in the case of unpaired spectrum (TDD) 1500, the starting point of the first C-TDW may be determined as the position 1502 of 1) where the PUSCH repetitive transmission scheduled via DCI is first transmitted, and the time duration of 6 slots from here may be regarded as the first C-TDW 1501. After the point where the first C-TDW ends, DL slots are skipped, and the position of 2) where the PUSCH repetitive transmission appears first after the first C-TDW may be determined as the starting point 1504 of the second C-TDW, and the time duration of 6 slots from here may be regarded as the second C-TDW 1503. Similarly, the starting point of the third C-TDW 1505 may also be determined in the same way, and if the number of PUSCH repetitive transmissions is indicated as 12, the third C-TDW may end at the position 1506 of 3) where the last PUSCH repetitive transmission ends. As a result, the length of the third C-TDW may be determined to be 2 slots rather than the configured value of 6 slots.

Within each C-TDW determined as above, one or multiple A-TDWs may be defined according to the above-described criteria. In FIG. 15, it can be assumed that the UE has reported the UE capability 1550 to create a new A-TDW to the base station. Within the first C-TDW 1501, the UE may maintain the A-TDW using the first transmitted PUSCH repetitive transmission as a starting point until a situation occurs in which the transmission power consistency and phase continuity are not maintained. Since the fourth slot in the first C-TDW is configured to DL, the UE may define first three consecutive slots in the first C-TDW as the first A-TDW 1551. After skipping the DL slot, the UE may define the second A-TDW 1552 since the UE has reported the UE capability to create the new A-TDW. Similarly, the UE may define two A-TDWs 1553 and 1554 and one A-TDW 1555 within the second and third C-TDWs, respectively. If the UE did not report the UE capability to create the new A-TDW, the UE may not be able to define the second A-TDWs 1552 and 1554 within the first and second C-TDWs.

Within the A-TDW defined as above, the UE may expect that the base station will perform simultaneous channel estimation for one or multiple PUSCH repetitive transmissions within the A-TDW.

Regarding the simultaneous channel estimation related operation in the PUSCH transmission and the configuration of related parameters, the UE may inform the base station whether or not to support the corresponding function through a UE capability report. The UE capability information that can be reported may include at least one of the information below.
Whether simultaneous channel estimation in PUSCH repetitive transmission is supported or not
Whether at least one C-TDW for simultaneous channel estimation in PUSCH repetitive transmission can be defined or not
At least one of methods for defining the starting point of the first C-TDW
At least one of methods for determining the end time of the last C-TDW
Whether one A-TDW for simultaneous channel estimation in PUSCH repetitive transmission can be defined or not
Whether restart of A-TDW or multiple A-TDWs within a certain C-TDW for simultaneous channel estimation in PUSCH repetitive transmission can be defined or not
Conditions for maintaining transmission power consistency and phase continuity
Minimum symbol interval between two PUSCH repetitive transmissions
Whether a DL symbol/slot between two PUSCH repetitive transmissions can be maintained or not if it exists
Whether DL between two PUSCH repetitive transmissions can be maintained or not if it is received

The above-described UE capabilities may be optional with capability signaling, and signaling differentiated according to FR1/FR2 may be supported. Some or all of the above-described UE capabilities may be included in one feature group, and each UE capability may support individual feature group signaling. For the above-described UE capabilities, signaling per UE, band combination, band, or CC may be supported.

### Second Embodiment: Precoding Method in PUSCH Transmission

As described above, in the PUSCH repetitive transmission considering the available slot, as time passes from the time the UE receives scheduling from the base station, the performance of the indicated precoder is likely to deteriorate due to channel variations. In this case, as a precoding method upon PUSCH repetitive transmission, a precoder cycling or precoder random selection method in which the UE further uses another precoder in addition to the precoder indicated by the base station may be considered. This precoding method may be expressed in various terms such as precoder cycling, precoder random selection, or precoder adaptive use method. In the disclosure, it will be expressed as a “precoding method” for convenience of description. That is, the “precoding method” described in the second embodiment below can be interpreted as a method in which the UE selects/uses an additional TPMI in addition to the TPMI indicated by the base station in consideration of the performance degradation of the precoder.

In the second-first embodiment, an implicit precoding method that can be considered in PUSCH transmission will be described. In the second-second embodiment, an explicit precoding method that can be considered in PUSCH transmission will be described. In the second-third embodiment, the timing of applying the precoding methods that can be considered in PUSCH transmission will be described.

In the embodiments, the precoder or precoding may refer to a TPMI in the codebook-based PUSCH transmission, and the following descriptions will be mainly based on the TPMI. However, this is not a limitation. Alternatively, the precoder or precoding may mean a precoder calculated by the UE based on the associated CSI-RS in non-codebook-based PUSCH transmission, and using this may be applicable similarly to the methods using the TPMI in the codebook-based PUSCH transmission.

### Second-First Embodiment: Implicit Precoding Method

In an embodiment of the disclosure, a precoding method that can be considered in PUSCH transmission may be implicitly configured/indicated. The UE can use the precoding method without additional higher layer signaling and dynamic indication from the base station or using only additional higher layer signaling. The UE can use the precoding method only when a certain condition is met. At least one of the conditions described below may be possible.
Condition 2-1-1: If the number of PUSCH repetitive transmissions indicated by the base station is greater than a predetermined value, the possibility that a lot of time will be needed to transmit PUSCH by the number of repetitive transmissions in consideration of the available slot may increase, and thus in this case the precoding method may be used.

For example, the predetermined value of the number of PUSCH repetitive transmissions may be defined in the standard or may be configured to the UE through higher layer signaling.
Condition 2-1-2: The UE may use the precoding method after a certain amount of time has passed from the first PUSCH repetitive transmission (e.g., after a certain number of slots/symbols/A-TDWs/C-TDWs has passed or after a certain amount of time in msec units has passed).

For example, the value of a certain number of slots/symbols/A-TDWs/C-TDWs or the value of a certain amount of time in msec units may be defined in the standard, may be configured via higher layer signaling, or may have a specific relationship with the number of repetitive transmissions (e.g., in the case where slots twice or more than the number of repetitive transmissions have passed from the first PUSCH repetitive transmission).
Condition 2-1-3: In the case of unpaired spectrum (TDD), the UE can use the precoding method when a certain number of DL slots have passed from the first PUSCH repetitive transmission.

For example, the certain number of DL slots may be defined in the standard, may be configured via higher layer signaling, or may have a specific relationship with the number of repetitive transmissions (e.g., in the case where DL slots that are half or more than the number of repetitive transmissions have passed from the first PUSCH repetitive transmission).

If at least one of the above conditions is satisfied, the UE may consider the following precoding methods. That is, if at least one of the above conditions is satisfied, the UE may select an additional precoder in addition to the precoder indicated by the base station.

For example, when the number of PUSCH repetitive transmissions is equal to or greater than a certain value, the UE may select an additional precoder in addition to the precoder indicated by the base station. If the number of PUSCH repetitive transmissions is less than a certain value, the UE may transmit the PUSCH by using only the precoder indicated by the base station. For example, the UE may select an additional precoder for PUSCH transmission after a certain time from the first PUSCH repetitive transmission. For example, in the case of unpaired spectrum (TDD), the UE may select an additional precoder for PUSCH transmission after a certain number of DL slots from the first PUSCH repetitive transmission.

Commonly in the methods described below, the UE may use a TPMI indicated by the TPMI field in the DCI received from the base station or configured via higher layer signaling as the first precoder.
Method 2-1-1: The UE may use a precoding method of further selecting a random precoder without any restrictions.

For example, regardless of the TPMI information (e.g., number of ranks, coherency, number of actually transmitted PTRS ports determined by the corresponding TPMI, etc.) indicated by the TPMI field in the DCI or configured via higher layer signaling, the UE may select and apply an arbitrary TPMI. For example, even if the UE is configured or indicated with a non-coherent TPMI of rank 1 as the first TPMI, it may use a full-coherent TPMI of rank 2 as the second TPMI by the precoding method of method 2-1-1.
Method 2-1-2: The UE may apply a precoding method of selecting a precoder in which at least one piece of information is the same as the initially indicated or configured TPMI (e.g., in the case where only the rank information is the same, in the case of the TPMI having the same coherency, or in the case where the number of PTRS ports actually transmitted is the same upon receiving PTRS transmission configuration, etc.).

For example, if the UE considers a precoding method of selecting a TPMI with only the same rank information and is configured or indicated with a non-coherent TPMI with rank 1 from the base station, the UE may use a precoding method of using the TPMI configured/indicated from the base station as the initial precoder and also randomly determining another TPMI of rank 1.

In another example, if the UE considers a precoding method of selecting a TPMI with the same rank information and the same coherency and is configured or indicated with a non-coherent TPMI with rank 1 from the base station, the UE may use a precoding method of using the TPMI configured/indicated from the base station as the initial precoder and also randomly determining a non-coherent TPMI of rank 1.
Method 2-1-3: For each TPMI, when the corresponding TPMI is indicated to be used as the initial TPMI, a set of TPMIs to be considered in the precoding method that UE can apply may be defined. When a specific TPMI is configured or indicated by the base station, the UE may use a precoding method of using the specific TPMI as the initial TPMI and also using TPMIs in a TPMI set corresponding to the specific TPMI in ascending or descending order based on the index of each TPMI.

For example, if TPMI indices 1 to 4 are defined in a TPMI set corresponding to TPMI index 0, the UE may consider a precoding method that uses TPMI index 0 as the initial TPMI, then applies TPMI indices 1 to 4 according to the applying time condition, and after applying up to TPMI index 4, uses again TPMIs in the TPMI set in ascending order starting from TPMI index 0.

The timing of applying the TPMIs selected through the above methods will be described later.

Regarding the implicit precoding method related operation in the PUSCH repetitive transmission and the configuration of related parameters, the UE may inform the base station whether or not to support the corresponding function through a UE capability report. The UE capability information that can be reported may include at least one of the information below:
Whether the implicit precoding method is supported or not in the PUSCH repetitive transmission,
When the implicit precoding method is supported, a default implicit precoding method (e.g., the above method 2-1-1)
When the implicit precoding method is supported, a default condition to be considered (e.g., the above condition 2-1-1)
When the implicit precoding method is supported, the number of precoders (e.g., one) to be selected in addition to the first precoder in the default implicit precoding method
When the implicit precoding method is supported, a default PUSCH repetitive transmission scheme (e.g., PUSCH repetitive transmission type A)
At least one of the above conditions to be considered for the implicit precoding method for the PUSCH repetitive transmission,
At least one of the implicit precoding methods 2-1-1 to 2-1-3 supportable for the PUSCH repetitive transmission, or
The maximum number of ranks (default value: 1) supportable when the implicit precoding method is supported for the PUSCH repetitive transmission.

The above-described UE capabilities may be optional with capability signaling, and signaling differentiated according to FR1/FR2 may be supported. Some or all of the above-described UE capabilities may be included in one feature group, and each UE capability may support individual feature group signaling. For the above-described UE capabilities, signaling per UE, band combination, band, or CC may be supported.

### Second-Second Embodiment: Explicit Precoding Method

In an embodiment of the disclosure, a precoding method that can be considered in PUSCH transmission may be explicitly configured/indicated. The UE can be configured/indicated with the precoding method from the base station through additional higher layer signaling, L1 signaling, or a combination thereof. The explicit precoding methods described below may be possible.
Method 2-2-1: Higher layer signaling indicating whether the precoding method is usable or not

The UE may receive, from the base station, higher layer signaling indicating whether the precoding method is usable, and then the UE may use the precoding method without indication through explicit L1 signaling from the base station.

For example, if at least one of the above conditions 2-1-1 to 2-1-3 considered in the implicit precoding method is satisfied, the UE may use a precoding method that applies the same precoder in units of A-TDW or C-TDW.

In another example, regardless of the above conditions 2-1-1 to 2-1-3 considered in the implicit precoding method, the UE may use a precoding method that applies the same precoder in units of one A-TDW or one C-TDW from the first PUSCH repetitive transmission.

When using the method 2-2-1, the UE may use, in the precoding method, only TPMI containing the same information (e.g., same number of ranks, same coherency, TPMI with the same number of PTRSs actually transmitted) as the initial TPMI configured and indicated as considered in the above-described method 2-1-2.
Method 2-2-2: Based on TPMI field in DCI

The UE may use the explicit precoding method based on the TPMI field in the DCI. For example, a specific precoding method may be defined for each of a plurality of reserved codepoints that exist in the TPMI field, and the base station may indicate this so that the UE can use the specific precoding method.

For example, if one reserved codepoint is used for the purpose of indicating a precoding method, the base station and the UE may promise each other to regard the one reserved codepoint as indicating a set of specific TPMIs. The UE indicated by the corresponding reserved codepoint may consider a precoding method that applies the TPMI index to each of a plurality of TPMIs in the TPMI set in ascending order according to the applying time conditions and, when the largest index is reached, uses again the TPMIs in the TPMI set in ascending order starting from the first index. The timing of applying the TPMIs selected through the above methods will be described later. In addition, one reserved codepoint may use one of the methods 2-1-1 to 2-1-3 of the implicit precoding method described above while including the initial TPMI.

In another example, if a plurality of reserved codepoints are used for the purpose of indicating a precoding method, the base station and the UE may promise each other to regard each reserved codepoint as being able to indicate a set of respective TPMIs. The UE indicated by a specific reserved codepoint may use a precoding method that applies the TPMI index to each of a plurality of TPMIs in the TPMI set in ascending order according to the applying time conditions similar to the above and, when the largest index is reached, applies again the TPMIs in the TPMI set in ascending order starting from the first index. In addition, similar to the above, each of the plurality of reserved codepoints may use one of the methods 2-1-1 to 2-1-3 of the implicit precoding method described above while including the initial TPMI.

If the base station does not indicate a reserved codepoint to the UE, but indicates a codepoint denoting a single TPMI indication, the UE does not use a precoding method and may apply the single TPMI indicated from the base station equally to the entire PUSCH repetitive transmission.
Method 2-2-3: Based on TDRA field in DCI

The UE may receive the configuration of whether to apply the precoding method for each TDRA entry in the TDRA field in the DCI from the base station through higher layer signaling. For example, if it is configured through higher layer signaling so that the precoding method can be applied to two entries out of sixteen TDRA entries, and if the UE is indicated with that TDRA entries through the DCI from the base station, the UE can know that a specific precoding method can be applied to PUSCH repetitive transmission scheduled through that TDRA entries.

For example, there may be one precoding method that can be indicated by each TDRA entry, and information configured via higher layer signaling in the TDRA entry as to whether the one method is applicable may be enabled or disabled. The one precoding method may be one of the above-described implicit precoding methods 2-1-1 to 2-1-3, or one of the above-described methods 2-2-1 and 2-2-2.

In another example, the information configured via higher layer signaling in the TDRA entry may indicate one of a plurality of precoding methods. For example, it is possible that precoding method 1 is configured in TDRA entry 1, precoding method 2 is configured in TDRA entries 2 to 4, and no precoding method is configured in the remaining TDRA entries 5 to 16. In this example, each of the precoding methods 1 and 2 may be a certain method among the above-described implicit precoding methods 2-1-1 to 2-1-3 or the above-described methods 2-2-1 and 2-2-2. If “method 2-1-1” is configured as the precoding method in TDRA entry 1 and the initial TPMI is indicated through the TPMI field, the UE use the precoding method at specific applying timing by selecting additional TPMI based on the method 2-1-1 without any restriction while using the initial TPMI. The timing of applying the TPMIs selected through the above methods will be described later.

As described above, if whether to apply a specific precoding method is configured in the TDRA entry, the UE may regard the TDRA entry as implicitly meaning repetitive transmission configuration of a specific value even if the TDRA entry does not contain configuration about the number of PUSCH repetitive transmissions. Additionally, such specific repetitive transmission configuration value implicitly determined may be different for each specific precoding method. For example, if whether to apply “method 2-1-2” is configured in a certain TDRA entry and the number of PUSCH repetitive transmissions is not configured, the UE may assume the number of PUSCH repetitive transmissions to be 16 when that TDRA entry is indicated. If whether to apply “method 2-1-3” is configured in another TDRA entry and the number of PUSCH repetitive transmissions is not configured, the UE may assume the number of PUSCH repetitive transmissions to be 32 when that TDRA entry is indicated.
Method 2-2-4: Based on SRS resource indicator (SRI) field in DCI

The UE may receive the configuration of whether to apply the precoding method for each SRS resource indicated by the SRI field in the DCI from the base station through higher layer signaling. For example, in the case of codebook-based PUSCH transmission, if it is configured via higher layer signaling so that the precoding method can be applied to one of two SRS resources, and if the corresponding SRS resource is indicated to the UE through the SRI field in DCI from the base station, the UE can know that a specific precoding method can be applied to PUSCH repetitive transmission scheduled based on the corresponding SRI. To this end, three or more SRS resources may be configured within the SRS resource set for codebook-based PUSCH transmission.

For example, there may be one precoding method that can be indicated with each SRI (e.g., one corresponding precoding method may be predefined for each SRS resource), and information configured via higher layer signaling in the SRS resource as to whether the one method is applicable may be enabled or disabled. The one precoding method may be one of the above-described implicit precoding methods 2-1-1 to 2-1-3, or one of the above-described methods 2-2-1 and 2-2-2.

In another example, the information configured via higher layer signaling in the SRS resource may indicate one of a plurality of precoding methods. For example, it is possible that precoding method 1 is configured in SRS resource 1, and precoding method 2 is configured in SRS resource 2. In this example, each of the precoding methods 1 and 2 may be a certain method among the above-described implicit precoding methods 2-1-1 to 2-1-3 or the above-described methods 2-2-1 and 2-2-2. If “method 2-1-1” is configured as the precoding method in SRI and the initial TPMI is indicated through the TPMI field, the UE use the precoding method at specific applying timing by selecting additional TPMI based on the method 2-1-1 without any restriction while using the initial TPMI. The timing of applying the TPMIs selected through the above methods will be described later.

As described above, if whether to apply a specific precoding method is configured in the SRS resource, that SRS resource may be indicated to the UE through the SRI field. Also, if the TDRA entry indicated through the TDRA field does not contain configuration about the number of PUSCH repetitive transmissions, that is, when a single PUSCH transmission is scheduled, the UE may perform PUSCH transmission in consideration of a single TPMI even though the corresponding SRS resource indicates applying a specific precoding method.
Method 2-2-5: Based on new field in DCI

A new field in DCI may be defined to indicate a precoding method, and the base station may dynamically indicate to the UE whether or not to apply the precoding method for each codepoint in the new field.

For example, if the new field is 1 bit, there may be one precoding method that can be indicated by the new field, and information indicated by two codepoints that can be indicated through 1 bit of the new field as to whether the one method is applicable may be enabled or disabled. The one precoding method may be one of the above-described implicit precoding methods 2-1-1 to 2-1-3, or one of the above-described methods 2-2-1 and 2-2-2.

For example, if the new field is greater than 1 bit, the precoding method that can be indicated by the new field may represent one of a plurality of precoding methods. For example, if the new field is 2 bits, three of four codepoints may indicate different precoding methods, and the remaining one codepoint may mean that no precoding method is used.

Regarding the explicit precoding method related operation in the PUSCH repetitive transmission and the configuration of related parameters, the UE may inform the base station whether or not to support the corresponding function through a UE capability report. The UE capability information that can be reported may include at least one of the information below:
Whether the implicit precoding method is supported or not in the PUSCH repetitive transmission,
When the explicit precoding method is supported, a default explicit precoding method (e.g., the above method 2-2-1)
When the explicit precoding method is supported, the number of precoders (e.g., one) to be selected in addition to the first precoder in the default explicit precoding method
When the explicit precoding method is supported, a default PUSCH repetitive transmission scheme (e.g., PUSCH repetitive transmission type A)
At least one of the explicit precoding methods 2-2-1 to 2-2-5 supportable for the PUSCH repetitive transmission, or
When the above method 2-2-5 is supported, the size of a new field or the number of supportable methods
The maximum number of ranks (default value: 1) supportable when the explicit precoding method is supported for the PUSCH repetitive transmission.

The above-described UE capabilities may be optional with capability signaling, and signaling differentiated according to FR1/FR2 may be supported. Some or all of the above-described UE capabilities may be included in one feature group, and each UE capability may support individual feature group signaling. For the above-described UE capabilities, signaling per UE, band combination, band, or CC may be supported.

### Second-Third Embodiment: Timing of Applying Precoding

In an embodiment of the disclosure, the precoding applying timing that can be commonly applied to the above-described implicit or explicit precoding method considered in PUSCH transmission will be described. The UE may consider the following methods when applying precoders selected in addition to the initially configured or indicated TPMI through the various implicit or explicit precoding methods described above.
Method 2-3-1: Applying one precoder selected through the precoding method once after a specific time

The UE may further select one TPMI other than the initially configured or indicated TPMI through the above-described implicit or explicit precoding method. In addition, the UE may use a method of applying the initial TPMI to all PUSCH repetitive transmissions before the specific time, and applying the further selected one TPMI to all PUSCH repetitive transmissions after the specific time.

In the case of defining the specific time in the method 2-3-1, the specific time may be defined as after a specific number of slots/symbols/A-TDWs/C-TDWs has passed, after a specific time in units of msec has passed, or the like.

In the case of the implicit precoding method, the defined specific time may be determined by standards or configured via higher layer signaling. In addition, it may be determined differently depending on the configured or indicated number of PUSCH repetitive transmissions.

In the case of the explicit precoding method, the defined specific time may be determined by standards, configured via higher layer signaling, indicated via L1 signaling, or configured and indicated via a combination of higher layer signaling and L1 signaling. In addition, it may be determined differently depending on the configured or indicated number of PUSCH repetitive transmissions.
Method 2-3-2: Applying each precoder selected through the precoding method in a specific period after a specific time

The UE may further select one or more TPMIs other than the initially configured or indicated TPMI through the above-described implicit or explicit precoding method. In addition, the UE may use a method of applying the initial TPMI to all PUSCH repetitive transmissions before the specific time, and applying according to the specific period the further selected one or more TPMIs to all PUSCH repetitive transmissions after the specific time.

In the case of defining the specific time in the method 2-3-2, the specific time may be defined as after a specific number of slots/symbols/A-TDWs/C-TDWs has passed, after a specific time in units of msec has passed, or the like.

In the case of the implicit precoding method, the defined specific time may be determined by standards or configured via higher layer signaling. In addition, the specific time may be determined differently depending on the configured or indicated number of PUSCH repetitive transmissions (For example, if the number of repetitive transmissions is 8, the specific time is 8 slots, if the number of repetitive transmissions is 16, the specific time is 14 slots, if the number of repetitive transmissions is 32, the specific time is 20 slots, etc.).

In the case of the explicit precoding method, the defined specific time may be determined by standards, configured via higher layer signaling, indicated via L1 signaling, or configured and indicated via a combination of higher layer signaling and L1 signaling. In addition, the specific time may be determined differently depending on the configured or indicated number of PUSCH repetitive transmissions.

In the case of defining the specific period in the method 2-3-2, the specific period may be defined as within a specific number of slots/symbols/A-TDWs/C-TDWs, within a specific time in units of msec, or the like.

In the case of the implicit precoding method, the defined specific period may be determined by standards or configured via higher layer signaling. In addition, the specific period may be determined differently depending on the configured or indicated number of PUSCH repetitive transmissions (For example, if the number of repetitive transmissions is 8, the specific period is 2 slots, if the number of repetitive transmissions is 16, the specific period is 4 slots, if the number of repetitive transmissions is 32, the specific period is 6 slots, etc.).

In the case of the explicit precoding method, the defined specific period may be determined by standards, configured via higher layer signaling, indicated via L1 signaling, or configured and indicated via a combination of higher layer signaling and L1 signaling. In addition, the specific period may be determined differently depending on the configured or indicated number of PUSCH repetitive transmissions.
Method 2-3-3: Applying each precoder selected through the precoding method in a specific period from the first PUSCH repetitive transmission

The UE may further select one or more TPMIs other than the initially configured or indicated TPMI through the above-described implicit or explicit precoding method. In addition, the UE may use a method of applying the initial TPMI and the further selected TPMIs in a specific period from the first PUSCH repetitive transmission.

In the case of defining the specific period in the method 2-3-3, the specific period may be defined as within a specific number of slots/symbols/A-TDWs/C-TDWs, within a specific time in units of msec, or the like.

In the case of the implicit precoding method, the defined specific period may be determined by standards or configured via higher layer signaling. In addition, the specific period may be determined differently depending on the configured or indicated number of PUSCH repetitive transmissions (For example, if the number of repetitive transmissions is 8, the specific period is 2 slots, if the number of repetitive transmissions is 16, the specific period is 4 slots, if the number of repetitive transmissions is 32, the specific period is 6 slots, etc.).

In the case of the explicit precoding method, the defined specific period may be determined by standards, configured via higher layer signaling, indicated via L1 signaling, or configured and indicated via a combination of higher layer signaling and L1 signaling. In addition, the specific period may be determined differently depending on the configured or indicated number of PUSCH repetitive transmissions.
Method 2-3-4: Configuring, indicating, or in-standard determining a specific method from among the above three methods

The UE may determine the timing of applying the precoding method with one of the above-described methods 2-3-1 to 2-3-3. In the case of the implicit precoding method, one of the three methods may be configured via higher layer signaling or determined by standards. In the case of the explicit precoding method, one of the three methods may be configured via higher layer signaling, determined by standards, indicated via L1 signaling, or configured and indicated via a combination of higher layer signaling and L1 signaling.

Regarding the precoding applying timing related operation in the PUSCH repetitive transmission and the configuration of related parameters, the UE may inform the base station whether or not to support the corresponding function through a UE capability report. The UE capability information that can be reported may include at least one of the information below:
At least one of the precoding applying timing methods 2-3-1 to 2-3-3 that can be supported in PUSCH repetitive transmission
Default applying unit for the specific time (e.g., 10 slots) or specific period (e.g., 1 C-TDW) in the supportable precoding applying timing method
Among the supported precoding applying timing methods, method that can be combined with the implicit precoding and the explicit precoding

The above-described UE capabilities may be optional with capability signaling, and signaling differentiated according to FR1/FR2 may be supported. Some or all of the above-described UE capabilities may be included in one feature group, and each UE capability may support individual feature group signaling. For the above-described UE capabilities, signaling per UE, band combination, band, or CC may be supported.

### Third Embodiment: Method for Indicating Multiple Precoders in PUSCH Transmission

In an embodiment of the disclosure, a method in which the base station indicates to the UE a plurality of precoders that can be applied in PUSCH transmission will be described.

While the precoding method described in the second embodiment is a method in which the UE selects an additional precoder, the method for indicating multiple precoders in the third embodiment is a method in which the UE is configured or indicated with multiple precoders from the base station when PUSCH repetitive transmission is scheduled dynamically from the base station through DCI or scheduled semi-statically based on higher layer signaling. That is, the second embodiment relates to a method in which the initial precoder is configured or indicated to the UE and then the UE further selects or determines the precoder to be used according to the detailed methods described above, whereas the third embodiment relates to a method in which the base station explicitly configures or indicates a plurality of precoders to the UE.

The “precoding method” described hereinafter in the third embodiment may be interpreted a method in which the base station indicates/configures additional TPMI to the UE in addition to indicating the initial precoder to the UE in consideration of the performance degradation of the precoder.

For a method of indicating a plurality of precoders in PUSCH repetitive transmission, the UE may receive configuration about the method of indicating a plurality of precoders through higher layer signaling from the base station. In this case, the UE may be configured with only one of the method of indicating a plurality of precoders and the precoding method described in the second embodiment. That is, if the UE is configured with the method of indicating a plurality of precoders via higher layer signaling from the base station, the UE may not be able to use the precoding method described in the second embodiment. The opposite case may be similarly considered.

In connection with the method of indicating a plurality of precoders in PUSCH repetitive transmission, the UE may receive higher layer signaling for the number of precoders indicated by the base station. If there is no signaling for that number, it may be assumed that only one precoder is indicated as a default value. From the base station, the UE may be configured or indicated with a plurality of precoders to be applied in PUSCH repetitive transmission. That is, the base station may configure or indicate to the UE a plurality of precoders to be applied in PUSCH repetitive transmission.

For example, when configured via higher layer signaling, the UE may be configured with multiple different precoders using a plurality of configuration parameters, and when indicated dynamically, the UE may be configured with multiple different precoders using a plurality of TPMI fields in DCI. When semi-static PUSCH repetitive transmission is activated or scheduled based on the above-described higher layer signaling for the number of precoders, there may be higher layer signaling that can notify the precoders as many as the corresponding number, and when PUSCH repetitive transmission is scheduled dynamically through DCI, there may be as many TPMI fields as the corresponding number. In this case, if there are multiple TPMI fields in the DCI, the first TPMI field may be defined as a field with the same size and meaning of the same codepoint as the TPMI field used in the existing standard, and the TPMI indicated by the first TPMI field may be the TPMI applied first in PUSCH repetitive transmission. The remaining TPMI fields may be defined as TPMI fields with one of the following constraints.
Constraint 3-1. Except for the first TPMI field, the remaining TPMI fields may be defined as fields with the same size and meaning of the same codepoint as the TPMI field used in the existing standard like the first TPMI field.
Constraint 3-2. Except for the first TPMI field, the remaining TPMI fields may be defined to have the same rank value as the first TPMI field. Therefore, by identifying the number of candidates for each rank value that the first TPMI field can express, the bit length of the remaining TPMI fields other than the first TPMI field may be determined based on the number of TPMI candidates for the rank value with the largest number of candidates.

For example, if the numbers of TPMI candidates for ranks 1 to 4 are A, B, C, and D, respectively, and it can be assumed that A>B>C>D, the bit length of the remaining TPMI fields other than the first field may be determined based on A, which is the number of candidates for rank 1, which has the largest number of candidates. All the TPMI fields other than the first field may have the same length.
Constraint 3-3. Except for the first TPMI field, the remaining TPMI fields may be defined to have the same rank value and the same coherency as the first TPMI field. Therefore, by identifying the number of candidates for each combination of the rank value and coherency value that the first TPMI field can express, the bit length of the remaining TPMI fields other than the first TPMI field may be determined based on the number of TPMI candidates for the rank value and coherency value having the largest number of candidates.

For example, if the numbers of TPMI candidates for rank 1 non-coherent, rank 1 partial coherent, rank 1 full-coherent, rank 2 non-coherent, rank 2 partial coherent, rank 2 full-coherent, rank 3 non-coherent, rank 3 partial coherent, rank 3 full-coherent, rank 4 non-coherent, rank 4 partial coherent, and rank 4 full-coherent are A₁, A₂, A₃, B₁, B₂, B₃, C₁, C₂, C₃, D₁, D₂ and D₃, respectively, and if A₃ is the largest value, the length of the remaining TPMI fields other than the first field may be determined based on A₃, which is the number of candidates for rank 1 full-coherent with the largest number of candidates. All the TPMI fields other than the first field may have the same length.
Constraints 3-4. Except for the first TPMI field, the remaining TPMI fields may follow the constraint 3-3 if there is no PTRS transmission configuration, and may be defined to have the same rank value, same coherency, and same number of actually transmitted PTRSs as the first TPMI field if there is PTRS transmission configuration and the number of PTRS ports is configured to n2. Therefore, by identifying the number of candidates for which the number of PTRS ports actually transmitted is 1 or 2 among the combinations of each rank value and each coherency value that can be expressed by the first TPMI field, the bit length of the remaining TPMI fields other than the first TPMI field may be determined based on the number of TPMI candidates for the combination of the rank value, coherency value, and number of PTRS ports actually transmitted with the largest number of candidates.

For example, in the case of rank 1, only one PTRS port actually transmitted is possible, so combinations of rank 1 non-coherent 1 actual PTRS port, rank 1 partial coherent 1 actual PTRS port, and rank 1 full-coherent 1 actual PTRS port may be considered. Also, in the case of rank 2, the number of PTRS ports actually transmitted is 1 or 2, so combinations of rank 2 non-coherent 1 actual PTRS port, rank 2 non-coherent 2 actual PTRS ports, rank 2 partial-coherent 1 actual PTRS port, rank 2 partial-coherent 2 actual PTRS ports, rank 2 full-coherent 1 actual PTRS port, and rank 2 full-coherent 2 actual PTRS port may be considered. Rank 3 and 4 may consider combinations similar to rank 2. If it is assumed that the combination with the largest number of candidates among all combinations considered as above is rank 1 full-coherent 1 actual PTRS port, the bit length may be determined based on the corresponding number of candidates. All the TPMI fields other than the first field may have the same length.

The timing of applying a plurality of precoders may follow the second-third embodiment described above.

For example, when the base station indicates multiple (e.g., two) precoders (e.g., TPMI) to the UE, the UE may apply the multiple precoders to PUSCH repetitive transmission based on the above-described method 2-3-1. Specifically, the UE may perform PUSCH repetitive transmission by applying a precoder indicated in the first TPMI field before a specific time and applying a precoder indicated in the second TPMI field after the specific time.

In another example, when the base station indicates multiple (e.g., two) precoders (e.g., TPMI) to the UE, the UE may apply the multiple precoders to PUSCH repetitive transmission based on the above-described method 2-3-2. Specifically, the UE may apply a precoder indicated in the first TPMI field before a specific time. After the certain time, the UE may perform PUSCH repetitive transmission by sequentially applying precoders for each period according to the order of indications in the TPMI field.

In yet another example, when the base station indicates multiple (e.g., two) precoders (e.g., TPMI) to the UE, the UE may apply the multiple precoders to PUSCH repetitive transmission based on the above-described method 2-3-3. If the base station indicates three precoders to the UE, and a specific period is indicated/configured to 2 slots, the UE may apply the first indicated precoder during 2 slot of the first period, apply the second indicated precoder during 2 slots of the second period, and apply the third indicated precoder during 2 slots of the third period. And, if the number of PUSCH repetitive transmissions remains, cycling may be applied to precoders to apply again the first indicated precoder during 2 slots of the fourth period.

It can be assumed that the UE receives both the multiple precoder indication method and the multi-TRP based PUSCH repetitive transmission configuration. For example, if the UE receives both the multiple precoder indication method and the multi-TRP based PUSCH repetitive transmission configuration and is configured to allow three precoders to be indicated through the multiple precoder indication method, two TPMI fields are required for multi-TRP based PUSCH repetitive transmission and three TPMI fields are required for multiple precoder indication method. Thus, a total of six TPMI fields may be defined.

In this case, a plurality of TPMI fields for the multiple precoder indication method may be defined for each TRP. That is, each of the two TPMI fields defined for the multi-TRP based PUSCH repetitive transmission may become the first TPMI field to be applied for transmission to each TRP. In addition, based on the first TPMI field for each TRP, the second and third TPMI fields for each TRP for the multiple precoder indication method may be defined by considering the above constraints. The order of TPMI fields in DCI may be the order of the first to third TPMIs corresponding to TRP1 and the first to third TPMIs corresponding to TRP2, or the order of the first TPMIs corresponding to TRP1 and TRP2, the second TPMIs corresponding to TRP1 and TRP2, and the third TPMIs corresponding to TRP1 and TRP2.

Among the two TPMI fields defined for the multi-TRP based PUSCH repetitive transmission, the second TPMI field is defined to express the same rank as the first TPMI field, so it may be defined similarly to the constraint 3-2 above. Therefore, only the first TPMI field corresponding to TRP1 may be defined as a field with the same size and meaning of the same codepoint as the TPMI field used in the existing standard, and the first TPMI field corresponding to TRP2 may be defined considering the above constraint 3-2 compared to the first TPMI field corresponding to TRP1. The second and third TPMI fields corresponding to TRP1 may be defined considering the above constraints 3-1 to 3-3 based on the first TPMI field corresponding to TRP1, and the second and third TPMI fields corresponding to TRP2 may have the same bit length and the same codepoint meaning as the first TPMI field corresponding to TRP2 or may be defined considering the above constraints 3-1 to 3-3.

Regarding the multiple precoder indication method related operation in the PUSCH repetitive transmission and the configuration of related parameters, the UE may inform the base station whether or not to support the corresponding function through a UE capability report. The UE capability information that can be reported may include at least one of the information below:
Whether the multiple precoder indication method is supported or not in the PUSCH repetitive transmission,
When the multiple precoder indication method is supported, a default constraint (e.g., the above constraint 3-1)
When the multiple precoder indication method is supported, a default PUSCH repetitive transmission scheme (e.g., PUSCH repetitive transmission type A)
At least one of the above constraints 3-1 to 3-4 to be considered when the multiple precoder indication method is supported for the PUSCH repetitive transmission,
Whether the multiple precoder indication method in the PUSCH repetitive transmission and the multi-TRP based PUSCH repetitive transmission can be simultaneously supported or not,
Upon simultaneously supported, the maximum number of TPMI fields, or
The maximum number of ranks (default value: 1) supportable when the multiple precoder indication method is supported for the PUSCH repetitive transmission.

The above-described UE capabilities may be optional with capability signaling, and signaling differentiated according to FR1/FR2 may be supported. Some or all of the above-described UE capabilities may be included in one feature group, and each UE capability may support individual feature group signaling. For the above-described UE capabilities, signaling per UE, band combination, band, or CC may be supported.

The above-described embodiments (e.g., first embodiment, second embodiment, third embodiment, etc.) and/or methods may be performed in combination with each other. Additionally, at least one of the methods described in a certain embodiment may be used in other embodiments.

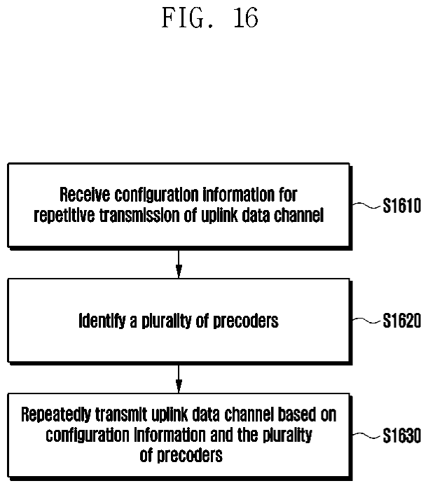

FIG. 16 illustrates an operation flowchart of a terminal according to an embodiment of the disclosure.

The operations of FIG. 16 may be based on the above-described embodiments (e.g., first embodiment, second embodiment, third embodiment, etc.) and/or methods. FIG. 16 is only an example of the disclosure and is not a limitation. The order of the operations in FIG. 16 may be changed, two or more operation steps may be combined and performed as one step, and/or in some cases, at least one step may be omitted.

In step S1610, the UE may receive configuration information for repetitive transmission of an uplink data channel (e.g., PUSCH) from the base station. That is, the base station may transmit the configuration information for repetitive transmission of the uplink data channel to the UE. The configuration information may include information about the number of repetitive transmissions of the uplink data channel.

In step S1620, the UE may identify a plurality of precoders for repetitive transmission of the uplink data channel. The plurality of precoders may include a first precoder and a second precoder.

For example, the UE may determine whether the number of repetitive transmissions of the uplink data channel included in the configuration information is equal to or greater than a specific value, and if so, the UE may identify the plurality of precoders.

For example, the UE may receive information indicating the first precoder through DCI and select the second precoder based on the first precoder. For example, it is possible to select the second precoder in which at least one of associated rank information or coherency information is the same as the first precoder.

Alternatively, the UE may receive information including a plurality of fields indicating the plurality of precoders from the base station, and in this case, each field may correspond to each precoder. That is, the base station may transmit information about a plurality of precoders for repetitive transmission of the uplink data channel to the UE.

In step S1630, the UE may repeatedly transmit the uplink data channel to the base station based on the configuration information and the plurality of precoders. That is, the base station may repeatedly receive the uplink data channel based on the configuration information and the plurality of precoders.

For example, the first precoder among the plurality of precoders may be applied to the first uplink data channel. The second precoder may be applied to the uplink data channel determined based on at least one of the repetitive transmission timing of the uplink data channel or the period associated with applying the second precoder.

For example, the second precoder may be applied to an uplink data channel transmitted after a specific time from the transmission of the first uplink data channel. The specific time may be determined based on the number of slots, symbols, C-TDWs, or A-TDWs. Additionally, the specific time or the period associated with applying the second precoder may be related to the number of the uplink data channel repetitive transmissions included in the configuration information.

For example, when the UE receives information including a plurality of fields indicating a plurality of precoders, it is possible to apply the plurality of precoders to the uplink data channel repetitive transmission in ascending order of the indices of the plurality of precoders.

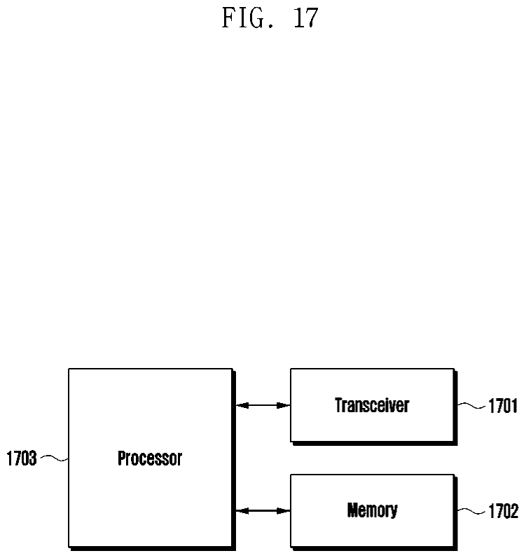

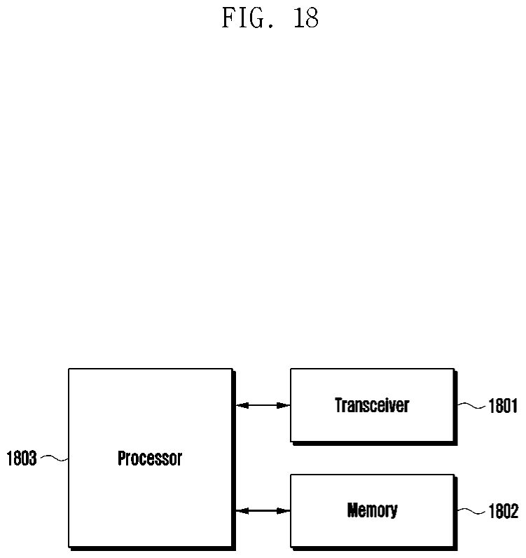

The above-described embodiments (e.g., first embodiment, second embodiment, third embodiment, etc.) and/or methods may be performed by the devices of FIGS. 17 and 18.

FIG. 17 is a block diagram illustrating the structure of a UE according to an embodiment of the disclosure.

With reference to FIG. 17, the UE may include a transceiver 1701, a memory 1702, and a processor 1703. However, the components of the UE are not limited to the above-described example. Alternatively, the UE may include more or fewer components than the aforementioned components. In addition, some or all of the transceiver 1701, the memory 1702, and the processor 1703 may be implemented in the form of a single chip.

In an embodiment, the transceiver 1701 may transmit/receive a signal to/from the base station. Here, the signal may include control information and data. To this end, the transceiver 1701 may include an RF transmitter for up-converting and amplifying a frequency of a transmitted signal, and an RF receiver for low-noise amplifying a received signal and down-converting a frequency of the received signal. In addition, the transceiver 1701 may receive a signal through a wireless channel and output the received signal to the processor 1703, and may transmit a signal output from the processor 1703 through the wireless channel.

In an embodiment, the memory 1702 may store programs and data required for the operation of the UE. In addition, the memory 1702 may store control information or data included in a signal transmitted and received by the UE. The memory 1702 may include a storage medium such as a ROM, a RAM, a hard disk, a CD-ROM, and a DVD, or a combination of storage media. In addition, the memory 1702 may be composed of a plurality of memories. According to an embodiment, the memory 1702 may store a program for executing an operation to save power of the UE.

In an embodiment, the processor 1703 may control a series of processes so that the UE may operate according to the above-described embodiment of the disclosure. In an embodiment, by executing programs stored in the memory 1702, the processor 1703 may receive information such as configuration for PUSCH repetitive transmission, bandwidth part configuration, and PDCCH configuration from the base station, and control PUSCH repetitive transmission operation based on such configuration information.

In an embodiment, the processor 1703 may be configured to receive configuration information for repetitive transmission of an uplink data channel from the base station, identify a plurality of precoders for the repetitive transmission of the uplink data channel, and repeatedly transmit the uplink data channel to the base station based on the configuration information and the plurality of precoders.

FIG. 18 is a block diagram illustrating the structure of a base station according to an embodiment of the disclosure.

With reference to FIG. 18, the base station may include a transceiver 1801, a memory 1802, and a processor 1803. However, the components of the base station are not limited to the above-described example. Alternatively, the base station may include more or fewer components than the aforementioned components. In addition, some or all of the transceiver 1801, the memory 1802, and the processor 1803 may be implemented in the form of a single chip.

In an embodiment, the transceiver 1801 may transmit/receive a signal to/from the UE. Here, the signal may include control information and data. To this end, the transceiver 1801 may include an RF transmitter for up-converting and amplifying a frequency of a transmitted signal, and an RF receiver for low-noise amplifying a received signal and down-converting a frequency of the received signal. In addition, the transceiver 1801 may receive a signal through a wireless channel and output the received signal to the processor 1803, and may transmit a signal output from the processor 1803 through the wireless channel.

In an embodiment, the memory 1802 may store programs and data required for the operation of the base station. In addition, the memory 1802 may store control information or data included in a signal transmitted and received by the base station. The memory 1802 may include a storage medium such as a ROM, a RAM, a hard disk, a CD-ROM, and a DVD, or a combination of storage media. In addition, the memory 1802 may be composed of a plurality of memories. According to an embodiment, the memory 1802 may store a program for executing an operation to save power of the base station.

In an embodiment, the processor 1803 may control a series of processes so that the base station may operate according to the above-described embodiment of the disclosure. In an embodiment, by executing programs stored in the memory 1802, the processor 1803 may transmit information such as configuration for PUSCH repetitive transmission, bandwidth part configuration, and PDCCH configuration to the UE, and control PUSCH repetitive transmission operation of the UE based on such configuration information.

In an embodiment, the processor 1803 may be configured to transmit configuration information for repetitive transmission of an uplink data channel to the UE, transmit information about a plurality of precoders for the repetitive transmission of the uplink data channel to the UE, and repeatedly receive the uplink data channel from the UE based on the configuration information and the plurality of precoders.

The methods according to embodiments described herein may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks such as the Internet, Intranet, Local Area Network (LAN), Wide LAN (WLAN), and Storage Area Network (SAN) or a combination thereof. Such a storage device may access the electronic device via an external port. Further, a separate storage device on the communication network may access a portable electronic device.

In the above-described detailed embodiments, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments described herein are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Further, the above respective embodiments may be employed in combination, as necessary. For example, one embodiment of the disclosure may be partially combined with another embodiment to operate a base station and a terminal. Additionally, the embodiments of the disclosure can be applied to other communication systems, and other modifications based on the technical idea of the embodiments may also be implemented. For example, the embodiments may also be applied to LTE systems, 5G or NR systems, etc.

1. A method performed by a terminal in a wireless communication system, the method comprising:
receiving configuration information for repetitive transmission of an uplink data channel from a base station;
identifying a plurality of precoders for the repetitive transmission of the uplink data channel; and
repeatedly transmitting the uplink data channel to the base station based on the configuration information and the plurality of precoders,
wherein among the plurality of precoders, a first precoder is applied to a first uplink data channel, and a second precoder is applied to an uplink data channel determined based on at least one of a transmitting timing of the repeated uplink data channel or a period associated with applying the second precoder.

2. The method of claim 1, wherein identifying the plurality of precoders includes:
receiving information indicating the first precoder through downlink control information (DCI); and
selecting one or more precoders including the second precoder based on the first precoder.

3. The method of claim 2, wherein at least one of rank information or coherency information associated with the first precoder is same as the second precoder.

4. The method of claim 1,
wherein identifying the plurality of precoders includes:
identifying whether a number of repetitive transmissions of the uplink data channel included in the configuration information is greater than or equal to a specific value, and
wherein in case that the number of repetitive transmissions of the uplink data channel is greater than or equal to the specific value, identifying the plurality of precoders.

5. The method of claim 1,
wherein identifying the plurality of precoders includes:
receiving information including a plurality of fields indicating the plurality of precoders from the base station, and
wherein each field corresponds to each precoder, and the plurality of precoders are applied to the repeated uplink data channel in ascending order of indices of the plurality of precoders.

6. The method of claim 1,
wherein the second precoder is applied to an uplink data channel transmitted after a specific time from transmission of the first uplink data channel, and
wherein the specific time is determined based on a number of configured time domain windows (C-TDWs) or active time domain windows (A-TDWs) for simultaneous channel estimation.

7. The method of claim 6, wherein the specific time or the period associated with applying the second precoder is related to a number of repetitive transmissions of the uplink data channel included in the configuration information.

8. A method performed by a base station in a wireless communication system, the method comprising:
transmitting configuration information for repetitive transmission of an uplink data channel to a terminal;
transmitting information about a plurality of precoders for the repetitive transmission of the uplink data channel to the terminal; and
repeatedly receiving the uplink data channel from the terminal based on the configuration information and the plurality of precoders,
wherein among the plurality of precoders, a first precoder is applied to a first uplink data channel, and a second precoder is applied to an uplink data channel determined based on at least one of a transmitting timing of the uplink data channel or a period associated with applying the second precoder.

9. The method of claim 8,
wherein the configuration information includes information about a number of repetitive transmissions of the uplink data channel, and
wherein at least one of rank information or coherency information associated with the first precoder is same as the second precoder.

10. The method of claim 8,
wherein the second precoder is applied to an uplink data channel transmitted after a specific time from transmission of the first uplink data channel,
wherein the specific time is determined based on a number of configured time domain windows (C-TDWs) or active time domain windows (A-TDWs) for simultaneous channel estimation, and
wherein the specific time or the period associated with applying the second precoder is related to a number of repetitive transmissions of the uplink data channel included in the configuration information.

11. A terminal in a wireless communication system, comprising:
a transceiver; and
a controller configured to:
receive configuration information for repetitive transmission of an uplink data channel from a base station,
identify a plurality of precoders for the repetitive transmission of the uplink data channel, and
repeatedly transmit the uplink data channel to the base station based on the configuration information and the plurality of precoders,
wherein among the plurality of precoders, a first precoder is applied to a first uplink data channel, and a second precoder is applied to an uplink data channel determined based on at least one of a transmitting timing of the uplink data channel or a period associated with applying the second precoder.

12. The terminal of claim 11,
wherein the controller is configured to:
identify whether a number of repetitive transmissions of the uplink data channel included in the configuration information is greater than or equal to a specific value,
receive information indicating the first precoder through downlink control information (DCI), and
in case that the number of repetitive transmissions of the uplink data channel is greater than or equal to the specific value, select one or more precoders including the second precoder based on the first precoder, and
wherein a precoder having the same at least one of rank information or coherency information associated with the first precoder is selected as the second precoder.

13. The terminal of claim 11,
wherein the second precoder is applied to an uplink data channel transmitted after a specific time from transmission of the first uplink data channel,
wherein the specific time is determined based on a number of configured time domain windows (C-TDWs) or active time domain windows (A-TDWs) for simultaneous channel estimation, and
wherein the specific time or the period associated with applying the second precoder is related to a number of repetitive transmissions of the uplink data channel included in the configuration information.

14. A base station in a wireless communication system, comprising:
a transceiver; and
a controller configured to:
transmit configuration information for repetitive transmission of an uplink data channel to a terminal,
transmit information about a plurality of precoders for the repetitive transmission of the uplink data channel to the terminal, and
repeatedly receive the uplink data channel from the terminal based on the configuration information and the plurality of precoders,
wherein among the plurality of precoders, a first precoder is applied to a first uplink data channel, and a second precoder is applied to an uplink data channel determined based on at least one of a transmitting timing of the uplink data channel or a period associated with applying the second precoder.

15. The base station of claim 14,
wherein the configuration information includes information about a number of repetitive transmissions of the uplink data channel, and
wherein at least one of rank information or coherency information associated with the first precoder is same as the second precoder.
